(19) United States
(12) Patent Application Publication
(10) Pub. No.: US 2006/0078998 A1
(43) Pub. Date: Apr. 13, 2006

(54) System and methods for sample analysis

(75) Inventors: Robert Puskas, Manchester, MO (US); Richard A. Livingston, Webster Groves, MO (US); Douglas D. Held, Ballwin, MO (US); Barbara Klein, St. Louis, MO (US); Noelle Fukushima, St. Louis, MO (US); Robert Freese, Waterloo, IL (US); Philippe J. Goix, Oakland, CA (US); Peter R. David, Palo Alto, CA (US); Mickey Urdea, Alamo, CA (US)

Correspondence Address: WILSON SONSINI GOODRICH & ROSATI, 650 PAGE MILL ROAD, PALO ALTO, CA, 94304-1050, US

(73) Assignee: Singulex, Inc.

(21) Appl. No.: 11/048,660

(22) Filed: Jan. 28, 2005

Related U.S. Application Data
(60) Provisional application No. 60/613,881, filed on Sep. 28, 2004.
(60) Provisional application No. 60/624,785, filed on Oct. 29, 2004.
(60) Provisional application No. 60/636,158, filed on Dec. 16, 2004.

(51) Int. Cl. G01N 24/00

(52) U.S. Cl. 436/64

(57) ABSTRACT

The invention encompasses analyzers and analyzer systems that include a single particle analyzer, methods of using the analyzers and analyzers systems to analyze samples, either for single particles or for multiple particles (multiplexing), methods of doing business based on the use of the analyzers or analyzer systems of the system, and electronic media for storing parameters useful in the analyzers and analyzer systems of the invention.

### CROSS-REFERENCE

This application claims the benefit of U.S. Provisional Application No. 60/613,881, entitled “Continuous Wave Single Particle Detector,” filed Sep. 28, 2004, U.S. Provisional Application No. 60/624,785, entitled “Sandwich Assay for Detection of Individual Molecules,” filed Oct. 27, 2004, and U.S. Provisional Application No. 60/636,158, entitled “Methods for Detecting Individual Molecules, Particles, or Cells,” filed Dec. 13, 2004, all of which are incorporated herein by reference in their entirety.

### BACKGROUND OF THE INVENTION

Advances in biomedical research, medical diagnosis, prognosis, monitoring and treatment selection, bioterrorism detection, and other fields involving the analysis of multiple samples of low volume and concentration of analytes have led to development of sample analysis systems capable of sensitively detecting particles in a sample at ever-decreasing concentrations. U.S. Pat. Nos. 4,793,705 and 5,209,834 describe previous systems in which extremely sensitive detection has been achieved. The present invention provides further development in this field.

### SUMMARY OF THE INVENTION

In one aspect, the invention provides a single particle analyzer system. In some embodiments, the system includes a sampling system capable of automatically sampling a plurality of samples and providing a fluid communication between a sample container and a first interrogation space, and an analyzer capable of detecting a single particle, where the analyzer includes an electromagnetic radiation source for emitting electromagnetic radiation; the first interrogation space positioned to receive electromagnetic radiation emitted from the electromagnetic radiation source; a second interrogation space positioned to receive electromagnetic radiation emitted from the electromagnetic radiation source; where the second interrogation space is in fluid communication with the first interrogation space and where a motive force exists between the first interrogation space and the second interrogation space such that a particle can be moved between the first interrogation space and the second interrogation space; a first electromagnetic radiation detector operably connected to the first interrogation space to measure a first electromagnetic characteristic of the particle; a second electromagnetic radiation detector operably connected to the second interrogation space to measure at least one of a second electromagnetic characteristic of the particle and the first electromagnetic characteristic of the particle. In some embodiments, the electromagnetic radiation source is a continuous wave electromagnetic radiation source, such as a light-emitting diode or a continuous wave laser. In further embodiments, the analyzer system includes a sampling system where the sample carryover of the sampling system is less than about 0.02%.

In some embodiments, the first and second interrogation spaces each have a volume between about 0.02 pL and about 300 pL, or between about 0.05 pL and about 50 pL, or between about 0.1 pL and about 25 pL. In some embodiments, the volume of at least one of the first and second interrogation spaces is adjustable.

In some embodiments, analyzer systems of the invention further include a third electromagnetic radiation detector operably connected to at least one of the first interrogation space and the second interrogation space to measure at least one of the first electromagnetic characteristic of the particle and the second electromagnetic characteristic of the particle. In some embodiments, the motive force of the analyzer is pressure, provided by, for example, a pump, a vacuum source, a centrifuge, or combinations thereof.

In some of the analyzer systems of the invention, the fluid communication includes tubing or channels within a microfluidic device, and the pressure is supplied by a pump or pumps.

In some embodiments, analyzer systems of the invention further include a sample recovery system in fluid communication with the second interrogation space that is capable of recovering substantially all of the sample, and/or a sample preparation system, and/or a data analysis system that analyzes the first and second electromagnetic characteristics and reports the results of the analysis. In embodiments that include a sample preparation system, the sample preparation system can performs sample preparation by centrifugation, filtration, chromatography; cell lysis, alteration of pH, addition of buffer, addition of reagents, heating or cooling, illumination, addition of label, binding of label, separation of unbound label, or combinations thereof. In embodiments that include a data analysis system, the analysis may include determining the presence, absence, and, optionally, concentration of a particle and determining a possible diagnosis, prognosis, state of treatment, or suggested treatment based on the presence, absence, and/or concentration.

In one embodiment, the invention provides an analyzer system that includes a sampling system providing a fluid communication between a sample container and a first interrogation space; a single particle analyzer including the first interrogation space and a second interrogation space, where the second interrogation space is in fluid communication with the first interrogation space and wherein a motive force exists between the first interrogation space and the second interrogation space such that a particle can be moved between the first interrogation space and the second interrogation space; a detector operably connected to the first and/or said second interrogation spaces for detecting a detectable characteristic of the particle, if present; a sample recovery system whereby the sample can move from the sample container to the interrogation volumes and back to the sample container without contacting other components of the analyzer and with no substantial contact with clean buffer within the analyzer; and a data analyzer that receives input from the detector, analyzes the presence or absence of the particle, and reports a result based on said presence or absence. The system may further include a sample preparation system

In another embodiment, the invention provides a single particle analyzer system that includes a sampling system capable of automatically sampling a plurality of samples and providing a fluid communication between a sample container and a first interrogation space; an analyzer capable of detecting a single molecule that includes an electromagnetic radiation source for emitting electromagnetic radiation; and the first interrogation space positioned to receive electromagnetic radiation emitted from the electromagnetic radiation source; and a first electromagnetic radiation detector operably connected to the first interrogation space to measure a first electromagnetic characteristic of the particle.

In another embodiment, the invention, provides an analyzer system that includes an analyzer capable of detecting a difference of less than 20% in concentration of an analyte between a first sample and a second sample that are introduced into the analyzer, where the volume of the first sample and said second sample introduced into the analyzer is less than 5 ul, and wherein the analyte is present at a concentration of less than 5 femtomolar. In some embodiments the system further includes a sampling system capable of automatically sampling a plurality of samples and providing a fluid communication between a sample container and the analyzer.

In another aspect, the invention provides single particle analyzers. In some embodiments, the invention provides a single particle analyzer that includes at least one continuous wave electromagnetic radiation source for emitting electromagnetic radiation; a first interrogation space positioned to receive electromagnetic radiation emitted from the electromagnetic radiation source, the first interrogation space having a volume between about 0.02 pL and about 300 pL; a second interrogation space positioned to receive electromagnetic radiation emitted from the electromagnetic radiation source, the second interrogation space having a volume between about 0.02 pL and about 300 pL, wherein the second interrogation space is in fluid communication with the first interrogation space and, wherein an electric potential exists between the first interrogation space and the second interrogation space such that a particle can be moved between the first interrogation space and the second interrogation space at least in part using electro-kinetic force; a first electromagnetic radiation detector operably connected to the first interrogation space to measure a first electromagnetic characteristic of the particle; and a second electromagnetic radiation detector operably connected to the second interrogation space to measure at least one of a second electromagnetic characteristic of the particle and the first electromagnetic characteristic of the particle. In some embodiments, the continuous wave electromagnetic radiation source is selected from the group consisting of a light-emitting diode and a continuous wave laser. In some embodiments, at least one of the first interrogation space and the second interrogation space has a volume between about 0.1 pL and about 25 pL. In some embodiments, the volume of at least one of the first and second interrogation spaces is adjustable. In some embodiments, at least one of the first interrogation space and the second interrogation space is defined by at least one of a cross sectional area of a beam of electromagnetic radiation received from the electromagnetic radiation source and a range of detection of at least one of the first electromagnetic radiation detector and the second electromagnetic radiation detector. In some of the latter embodiments, the range of detection is determined by a width of a slit in a spatial filter positioned adjacent to at least one of the first electromagnetic radiation detector and the second electromagnetic radiation detector. In some embodiments, at least one of the first and the second interrogation spaces is at least partially defined by a housing comprising a solid material selected from the group consisting of glass, quartz, fused silica, plastic, or any combination thereof. In some embodiment, at least one of the first interrogation space and the second interrogation space is at least partially defined by a fluid boundary.

In some embodiments, the analyzer further includes a third electromagnetic radiation detector operably connected to at least one of the first interrogation space and the second interrogation space to measure at least one of the first electromagnetic characteristic of the particle and the second electromagnetic characteristic of the particle.

In some embodiments of the analyzers of the invention, at least one of the first electromagnetic radiation detector and the second electromagnetic radiation detector is selected from a group consisting of a CCD camera, a video input module camera, a streak camera, a bolometer, a photodiode, a photodiode array, an avalanche photodiode detector, a photomultiplier detector, and any combination thereof.

In some embodiments, the analyzer further includes at least one of a pump, a vacuum source, and a centrifuge for facilitating movement of the particle between the first interrogation space and the second interrogation space.

In another aspect, the invention provides methods of analysis. In one embodiment, the invention provides a method of analysis that includes determining the presence or absence of a particle in a sample obtained from an individual, using a single particle analyzer system that includes (a) a sampling system capable of automatically sampling a plurality of samples and providing a fluid communication between a sample container and a first interrogation space; and (b) an analyzer capable of detecting a single particle that includes: (i) an electromagnetic radiation source for emitting electromagnetic radiation; (ii) said first interrogation space positioned to receive electromagnetic radiation emitted from the electromagnetic radiation source; (iii) a second interrogation space positioned to receive electromagnetic radiation emitted from the electromagnetic radiation source; wherein the second interrogation space is in fluid communication with the first interrogation space and wherein a motive force exists between the first interrogation space and the second interrogation space such that a particle can be moved between the first interrogation space and the second interrogation space; (iv) a first electromagnetic radiation detector operably connected to the first interrogation space to measure a first electromagnetic characteristic of the particle; and (v) a second electromagnetic radiation detector operably connected to the second interrogation space to measure at least one of a second electromagnetic characteristic of the particle and the first electromagnetic characteristic of the particle.

In some embodiments of methods of the invention, the analyzer further comprises a data analysis system that analyzes said first and second electromagnetic characteristics and reports the results of said analysis; in some of these embodiments the analysis further includes determining a diagnosis, prognosis, state of treatment and/or method of treatment based on the results of said analysis.

In some embodiments of the methods of the invention, the analyzer system further comprises a sample recovery system in fluid communication with the second interrogation space that is capable of recovering substantially all of said sample, and/or-a sample preparation system.

In some embodiments of the methods of the invention, the electromagnetic radiation source is a continuous wave electromagnetic radiation source

In some embodiments of the methods of the invention, the first and second interrogation spaces each have a volume between about 0.02 pL and about 300 pL, or between about 0.05 pL and about 50 pL, or between about 0.1 pL and about 25 pL.

In some embodiments of the methods of the invention, the volume of at least one of the first and second interrogation spaces is adjustable.

In some embodiments of the methods of the invention, the motive force comprises pressure. In some of these embodiments, the pressure is provided by a source selected from the group consisting of a pump, a vacuum source, a centrifuge, and a combination thereof.

In some embodiments of the methods of the invention, the individual is an animal or a plant, e.g., an animal, e.g., a mammal, e.g., a human.

In some embodiments, the methods of the invention include performing an analysis on a plurality of particles in the sample. In some of these embodiments, each detected particle of the plurality of particles comprises a label, and wherein each detected particle is distinguished from the others by a characteristic selected from the group consisting of label identity, label intensity, mobility, or a combination thereof.

In some embodiments of the methods of the invention, the sample is selected from the group consisting of blood, serum, plasma, bronchoalveolar lavage fluid, urine, cerebrospinal fluid, pleural fluid, synovial fluid, peritoneal fluid, amniotic fluid, gastric fluid, lymph fluid, interstitial fluid, tissue homogenate, cell extracts, saliva, sputum, stool, physiological secretions, tears, mucus, sweat, milk, semen, seminal fluid, vaginal secretions, fluid from ulcers and other surface eruptions, blisters, and abscesses, and extracts of tissues including biopsies of normal, malignant, and suspect tissues or any other constituents of the body which may contain the particle. In some embodiments, the sample is selected from the group consisting of blood, plasma, or serum. In some of these embodiments, the method further comprises labeling the particle in said sample, wherein analyzing said sample comprises detecting the presence or absence of said labeled particle; optionally also including removing unbound label from said sample, and/or obtaining said sample from said individual, and/or analyzing a particle selected from the group consisting of a protein, a nucleic acid, a nanosphere, a microsphere, a dendrimer, a chromosome, a carbohydrate, a virus, a bacterium, a cell, and any combination thereof, e.g., selecting the particle from the group consisting of a protein, a nucleic acid, a virus, a bacterium, and any combination thereof. In some embodiments, the particle is selected from the group consisting of an amino acid, a nucleotide, a lipid, a sugar, a small particle toxin, a peptide toxin, a venom, a drug, and any combination thereof.

In some embodiments of the methods of the invention, the sample is a serum sample that has been contacted with a fluorescently-labeled antibody specific for a particle of interest; and wherein said analysis comprises detecting the presence, absence, and/or concentration of the labeled particle. In some of these embodiments, the method further includes determining a diagnosis, prognosis, state of treatment, and/or method of treatment, based on said presence, absence, and/or concentration of the labeled particle. The method may further include reporting said diagnosis, prognosis, state of treatment, and/or method of treatment to the individual. In some embodiments, the biomarker is TREM-1. In some embodiments, the method is completed in less than one hour. In some embodiments, determining a diagnosis, prognosis, state of treatment, and/or method of treatment is based on the presence, absence, and/or concentration of a panel of biomarkers. In some embodiments, the method is performed in less than 2 hours.

In one embodiment, the invention encompasses a method of analysis comprising determining a diagnosis, prognosis, state of treatment, and/or method of treatment based on the presence, absence, and/or concentration of a particle in a sample obtained from an individual, wherein said presence, absence, and/or concentration is determined using an analyzer system comprising a analyzer capable of detecting a single molecule, wherein said analyzer comprises at least one interrogation space. In some of these embodiments, the analyzer comprises at least two interrogation spaces. In some embodiments, the analyzer system comprises an analyzer capable of detecting a single molecule comprising at least one continuous wave electromagnetic radiation source for emitting radiation, wherein at least one interrogation space is positioned to receive said radiation.

In another embodiment, the invention provides a method for screening an individual to determine the presence or absence of cancer, comprising analyzing a sample from the individual for one or more markers of cancer using an analyzer capable of detecting a change in concentration of the one or more markers from one sample to another sample of less than about 20% when each marker is present at a concentration of less than 1 picomolar, and when the size of the sample is less than about 5 ul. In some embodiments, the method further includes comparing the result of said analysis with known values for the marker. In some embodiments, the individual is a smoker and the cancer is lung cancer.

In another embodiment, the invention provides a method for detecting a particle comprising: moving the particle by electro-kinetic force into a first interrogation space having a volume between about 0.02 pL and about 300 pL, and into a second interrogation space having a volume between about 0.02 pL and about 300 pL; subjecting the sample to at least one continuous wave electromagnetic radiation source; measuring within the first interrogation space a first electromagnetic characteristic of the particle as the particle interacts with continuous wave electromagnetic radiation within the first interrogation space; and measuring within the second interrogation space at least one of the first electromagnetic characteristic and a second electromagnetic characteristic of the particle as the particle interacts with continuous wave electromagnetic radiation within the second interrogation space. In some embodiments, wherein the particle is a first particle the method further includes: moving a second particle into at least two of the first interrogation space, the second interrogation space, a third interrogation space, and a fourth interrogation space; and measuring at least one of a first electromagnetic characteristic of the second particle and a second electromagnetic characteristic of the second particle as the second particle interacts with continuous wave electromagnetic radiation within at least one of the first interrogation space, the second interrogation space, the third interrogation space, and the fourth interrogation space.

In a further aspect, the invention provides a computer-readable storage medium containing a set of instructions for a general purpose computer having a user interface comprising a display unit, the set of instructions comprising: (a) logic for inputting values from analysis of a sample with a single particle detector with two interrogation spaces; and (b) a display routine for displaying the results of the input values with said display unit. In some embodiments, the instructions further comprises a comparison routine for comparing the inputted values with a database; and wherein the display routine further comprises logic for displaying the results of the comparison routine.

In still a further aspect, the invention provides an electronic signal or carrier wave that is propagated over the Internet between computers comprising a set of instructions for a general purpose computer having a user interface comprising a display unit, the set of instructions comprising a computer-readable storage medium containing a set of instructions for a general purpose computer having a user interface comprising a display unit, the set of instructions comprising: (a) logic for inputting values from analysis of a sample with a single particle detector with two interrogation spaces; and (b) a display routine for displaying the results of the input values with said display unit. In some embodiments, the set of instructions further comprises a comparison routine for comparing the inputted values with a database; and wherein the display routine further comprises logic for displaying the results of the comparison routine.

In still yet a further aspect, the invention provides a method of doing business, comprising use by an entity of a detector with two interrogation spaces that is capable of detecting single particles to obtain a result for an assay of a sample, reporting said result, and payment to the entity for the reporting of the result. In some embodiments, the entity is a Clinical Laboratory Improvement Amendments (CLIA) laboratory. In some embodiments, the entity is not a CLIA laboratory.

In a still yet further aspect, the invention provides a device that combines a continuous wave illumination source, two or more distinct, pL size interrogation spaces and electrokinetic transport of particles, including single particles, to be detected.

In one aspect, this invention provides a single particle analyzer comprising at least one continuous wave electromagnetic radiation source for emitting electromagnetic radiation; a first interrogation space positioned to receive electromagnetic radiation emitted from the electromagnetic radiation source, the first interrogation space having a volume between about 0.02 pL and about 300 pL; a second interrogation space positioned to receive electromagnetic radiation emitted from the electromagnetic radiation source, the second interrogation space having a volume between about 0.02 pL and about 300 pL, wherein the second interrogation space is in fluid communication with the first interrogation space and, wherein an electric potential exists between the first interrogation space and the second interrogation space such that a particle can be moved between the first interrogation space and the second interrogation space at least in part using electro-kinetic force; a first electromagnetic radiation detector operably connected to the first interrogation space to measure a first electromagnetic characteristic of the particle; and a second electromagnetic radiation detector operably connected to the second interrogation space to measure at least one of a second electromagnetic characteristic of the particle and the first electromagnetic characteristic of the particle.

In accordance with a another aspect of the invention, the analyzer further comprises a third electromagnetic radiation detector operably connected to at least one of the first interrogation space and the second interrogation space to measure at least one of the first electromagnetic characteristic of the particle and the second electromagnetic characteristic of the particle. In one aspect, the continuous wave electromagnetic radiation source is selected from a group consisting of a light-emitting diode and a continuous wave laser.

In accordance with yet another aspect of the invention, at least one of the first electromagnetic characteristic and second electromagnetic characteristic is selected from a group consisting of emission wavelength, emission intensity, burst size, burst duration, fluorescence polarization, and any combination thereof.

In another aspect of the invention, at least one of the first interrogation space and the second interrogation space has a volume between about 0.05 pL and about 50 pL, preferably, between about 0.10 pL and about 25 pL. In one aspect, the volume of at least one of the first and second interrogation spaces is adjustable. In one alternative, at least one of the first interrogation space and the second interrogation space is defined by at least one of a cross-sectional area of a beam of electromagnetic radiation received from the electromagnetic radiation source and a range of detection of at least one of the first electromagnetic radiation detector and the second electromagnetic radiation detector. In one aspect, the range of detection is determined by a width of a slit in a spatial filter positioned adjacent to at least one of the first electromagnetic radiation detector and the second electromagnetic radiation detector.

In another alternative, at least one of the first and the second interrogation spaces is defined by a solid housing comprising a material selected from the group consisting of glass, quartz, fused silica, plastic, or any combination thereof. In yet another alternative, at least one of the first interrogation space and the second interrogation space is defined by a fluid boundary.

In another aspect of the present invention, at least one of the first electromagnetic radiation detector and the second electromagnetic radiation detector is selected from a group consisting of a charge-coupled device (CCD) camera, a video input module camera, a streak camera, a bolometer, a photodiode, a photodiode array, an avalanche photodiode detector, a photomultiplier detector, and any combination thereof. In yet another aspect, the analyzer further comprises at least one of a pump, a vacuum source, and a centrifuge for facilitating movement of the particle between the first interrogation space and the second interrogation space.

In yet another aspect, this invention provides a method for detecting a particle comprising moving the particle by electro-kinetic force into a first interrogation space having a volume between about 0.02 pL and about 300 pL, and into a second interrogation space having a volume between about 0.02 pL and about 300 pL; subjecting the sample to at least one continuous wave electromagnetic radiation source; measuring within the first interrogation space a first electromagnetic characteristic of the particle as the particle interacts with continuous wave electromagnetic radiation within the first interrogation space; and measuring within the second interrogation space at least one of the first electromagnetic characteristic and a second electromagnetic characteristic of the particle as the particle interacts with continuous wave electromagnetic radiation within the second interrogation space.

In accordance with a further aspect of the invention, the second interrogation space comprises a plurality of interrogation spaces. In accordance with yet another aspect of the invention, the particle is a first particle and the method further comprises moving a second particle into at least two of the first interrogation space, the second interrogation space, a third interrogation space, and a fourth interrogation space; and measuring at least one of a first electromagnetic characteristic of the second particle and a second electromagnetic characteristic of the second particle as the second particle interacts with continuous wave electromagnetic radiation within at least one of the first interrogation space, the second interrogation space, the third interrogation space, and the fourth interrogation space.

In accordance with yet another aspect of the invention, the method further comprises connecting the first interrogation space to the second interrogation space and introducing a fluid prior to moving the particle. In another aspect of the invention, the method further comprises selecting the particle from a group consisting of a protein, a nucleic acid, a nanosphere, a microsphere, a dendrimer, a chromosome, a carbohydrate, a virus, a bacterium, a cell, and any combination thereof. In one aspect, a combination of particles is selected from a group consisting of a protein, nucleic acid, virus, and bacterium. Alternatively, the method further comprises selecting the particle from a group consisting of an amino acid, a nucleotide, a lipid, a sugar, a small particle toxin, a peptide toxin, a venom, a drug, and any combination thereof.

In yet another aspect of the present invention, at least one of the first electromagnetic characteristic and the second electromagnetic characteristic is produced by one of an intrinsic parameter of the particle and an extrinsic parameter of the particle. In one aspect, the method further comprises marking the particle with at least one label to provide the extrinsic parameter. In a further aspect, the label emits electromagnetic radiation and is selected from a group consisting of a dye tag, a light-scattering tag, and any combination thereof.

In a further aspect of the present invention, in which the particle is a first particle, the label is a first label, and the first particle and the first label are contained in a mixture of a plurality of particles and a plurality of labels, the method further comprises (a) separating at least one unbound label of the plurality of labels from the first particle of the plurality of particles or rendering at least one unbound label of the plurality of labels undetectable; (b) interacting the first particle of the plurality of particles with an agent to cause the first particle to release the first label bound thereto; and (c) detecting the first label after the first label has been released from the first particle to thereby indirectly detect the first particle.

In one aspect of the invention, the first label released from the first particle is a particle. In another aspect, the particle is marked with at least two distinguishable labels. In one alternative, the particle is labeled directly by means of at least one of a specific and a nonspecific interaction selected from a group consisting of covalent binding, ionic binding, hydrophobic binding, affinity binding, hydrogen bonding, van der Waals attraction, coordination complex formation, and any combination thereof. In another alternative, the particle is labeled indirectly by means of incubation with at least one binding partner to form a specific complex, and wherein the binding partner comprises at least one label.

In one aspect, the step of labeling the particle indirectly by means of incubation with at least one binding partner comprises at least one of a specific and a nonspecific interaction selected from a group consisting of covalent binding, ionic binding, hydrophobic binding, affinity binding, hydrogen bonding, van der Waals attraction, coordination complex formation, and any combination thereof. In one alternative, the particle is incubated with the binding partner within at least one of the first interrogation space and the second interrogation space. In another alternative, the particle is incubated with the binding partner prior to moving the particle.

In yet another aspect, the binding partner is selected from a group consisting of polynucleotide/polynucleotide interactions, polynucleotide/polypeptide interactions and polypeptide/polypeptide interactions, and any combination thereof. In one aspect, said incubation with at least one binding partner comprises incubating the particle with a first binding partner; and incubating the particle with a second binding partner, wherein at least one of the first binding partner and the second binding partner comprises at least one label.

In yet another aspect of the present invention, moving the particle into the first interrogation space and the second interrogation space comprises subjecting the particle to a separation mechanism selected from a group consisting of capillary gel electrophoresis, micellar electro-kinetic chromatography, isotachophoresis, magnetic fields, and any combination thereof. In one alternative, the method further comprises moving a second particle in a direction generally opposite to a direction of the first particle. In one aspect, moving the particle into the first interrogation space and the second interrogation space comprises moving the particle by a combination of electro-kinetic force and at least one additional force selected from a group consisting of a pressure gradient, gravity, surface tension, centrifugal force, and any combination thereof.

In another aspect of the present invention, a mobility of the particle is determined by interaction of the electro-kinetic force with physical parameters of the particle including at least one of an intrinsic and an extrinsic parameter. In one aspect, the method further comprises marking the particle with at least one label to provide the extrinsic parameter. In one aspect, the label is capable of affecting the particle mobility and is selected from a group consisting of a charge tag, a mass tag, a charge/mass tag, a magnetic tag, and any combination thereof. In a further aspect, the particle is marked with at least two distinguishable labels.

In one alternative, the particle is labeled directly by means of at least one of a specific and a nonspecific interaction selected from a group consisting of covalent binding, ionic binding, hydrophobic binding, affinity binding, hydrogen bonding, van der Waals attraction, coordination complex formation, and any combination thereof. In another alternative, the particle is labeled indirectly by means of incubation with at least one binding partner to form a specific complex, and wherein the binding partner comprises at least one label.

In one aspect, labeling the particle indirectly by means of incubation with at least one binding partner comprises at least one of a specific and a nonspecific interaction selected from a group consisting of covalent binding, ionic binding, hydrophobic binding, affinity binding, hydrogen bonding, van der Waals attraction, coordination complex formation, and any combination thereof. In one alternative, the particle is incubated with the binding partner within at least one of the first interrogation space and the second interrogation space. In another alternative, the particle is incubated with the binding partner prior to moving the particle.

In yet another aspect, the binding partner is selected from the group consisting of polynucleotide/polynucleotide interactions, polynucleotide/polypeptide interactions and polypeptide/polypeptide interactions, and any combination thereof. In one aspect, said incubation with at least one binding partner comprises incubating the particle with a first binding partner, and incubating the particle with a second binding partner, wherein at least one of the first binding partner and the second binding partner comprises at least one label.

In a further aspect of the present invention, a mixture of different binding partners is incubated with the particle. In yet another aspect, the particle is a first particle within a mixture of a plurality of particles and a plurality of labels and the first particle is labeled with a first label of the plurality of labels, and wherein the first particle labeled with the first label is distinguished from unlabeled particles of the plurality of particles and unbound labels of the plurality of labels.

In yet another aspect, the first particle is labeled with a second label of the plurality of labels, and wherein the first particle is distinguished from unlabeled particles of the plurality of particles and unbound labels of the plurality of labels by measuring a ratio between an electromagnetic characteristic of the first label and an electromagnetic characteristic of the second label. In another aspect of the present invention, at least the first and the second particles are detected, and the method further comprises counting at least the first and the second particles. In one alternative, the step of counting at least the first and the second particles comprises determining a concentration of particles within a sample by comparing the concentration of the sample with an external particle standard having known concentration. In another alternative, the step of counting at least the first and the second particles comprises determining a concentration of particles within a sample by comparing the concentration of the sample with an internal particle standard having known concentration. In yet another alternative, the step of counting at least the first and the second particles comprises determining a concentration of particles without using an external standard and without using an internal standard.

In another aspect of the present invention, the first and second particles are first and second particles within a mixture of a plurality of particles and a plurality of labels, the first particle has a first label of the plurality of labels attached thereto, the second particle has a second label of the plurality of labels attached thereto, and the first and second labels each have a different predetermined range, and further wherein the first particle is distinguished from unbound labels of the plurality of labels by a characteristic signal produced by the unbound label and the first particle is distinguished from the second particle by the different ranges of the first and second labels.

In another aspect of the present invention, the first and second particles are first and second particles within a mixture of a plurality of particles and a plurality of labels, the first particle is labeled with a first label and a second label distinguishable from the first label, and the second particle is labeled with a third label substantially similar to the first label, and wherein the first particle is distinguished from the second particle, from particles of the plurality of particles labeled only with a label of the plurality of labels substantially similar to the second label, from unlabeled particles of the plurality of particles, and from unbound labels of the plurality of labels. In one alternative, the first and third labels emit electromagnetic radiation and the second and fourth labels affect mobility, and wherein the first particle is distinguished from the second particle, from particles of the plurality of particles only labeled with a label that affects mobility, from unlabeled particles of the plurality of particles, and from unbound labels of the plurality of labels. In another alternative, the second particle is labeled with a fourth label substantially similar to the second label, wherein the ratio between an electromagnetic characteristic of the first label and an electromagnetic radiation characteristic of the second label is different from the ratio of an electromagnetic radiation characteristic of the third label and an electromagnetic radiation characteristic of the fourth label, and wherein the first particle is distinguished from the second particle by measuring the differences between the label ratios of the first particle and second particle.

In another aspect, the electromagnetic characteristics of the first label, the second label, the third label, and the fourth label are wavelengths. In yet another alternative, the second particle is labeled with a fourth label substantially similar to the second label, wherein a summation of electromagnetic intensities emitted by the first label and the second label is different from a summation of electromagnetic intensities emitted by the third label and the fourth label, and wherein the first particle is distinguished from the second particle by measuring the difference between the summation of the intensities of the first and second labels and the summation of the intensities of the third and fourth labels.

In yet another aspect, the first particle is labeled with a first label and the second particle is labeled a second label, and wherein the first particle and the second particle are distinguished by measuring the difference between an electromagnetic characteristic of the first particle and an electromagnetic characteristic of the second particle. In one aspect, the electromagnetic characteristics of the first particle and the second particle are wavelengths.

In one alternative, the particle is a first particle having an intrinsically detectable characteristic, the label is a first label affecting mobility, and a second particle having an intrinsically detectable characteristic is labeled with a second label affecting mobility, and wherein the first and second particles are distinguished by measuring the difference in mobility between the first and second particles. In another alternative, the particle is a first particle having an intrinsically detectable characteristic, the label is a first label affecting mobility, and a second particle having an intrinsically detectable characteristic is not labeled, and wherein the first and second particles are distinguished by measuring the difference in mobility between the first and second particles.

In another aspect of the present invention, the method further comprises comparing the electromagnetic characteristic of the particle measured within the first interrogation space and the electromagnetic characteristic of the particle measured within the second interrogation space. In one aspect, the step of comparing comprises distinguishing by statistical analysis between at least one measured electromagnetic characteristics of the particle and the background electromagnetic emission. In a further aspect, the step of comparing comprises cross-correlating the measured electromagnetic characteristics of the particle to determine the velocity of the particles.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

FIG. 1. Schematic diagram of one embodiment of a sample analysis system of the invention.

FIG. 2. Schematic view of one embodiment of methods of the invention.

FIG. 3. Schematic diagram of a single particle analyzer of one embodiment of the present invention.

FIG. 4. Schematic diagram of a capillary flow cell for a single particle analyzer of one embodiment of the present invention.

FIG. 5. Schematic diagram of a single particle analyzer of one embodiment of the present invention having a confocal arrangement.

FIG. 6. A. Electrophoresis of 7.2 kb DNA fragment and dilution curve. A) Cross-correlation analysis of particles in a buffer blank. B) Cross-correlation analysis of particles in a 0.1 fM sample. C) Linear relationship of particles detected by cross-correlation and concentration of the samples.

FIG. 7. Standard curve of TREM-1 measured in a sandwich molecule immunoassay developed for the single particle analyzer system. The linear range of the assay is 100-1500 fM.

FIG. 8. Standard curve for IL-6. A) IL-6 standards, diluted according to the R&D Systems kit, gave a linear response between 0.1 and 10 pg/ml. B) IL-6 standard curve below 1 pg/ml. C) Standard curve for IL-6 from R&D Systems product literature for an assay that uses two signal amplification steps.

FIG. 9. Standard curve of TSH detection in a bead-based molecule immunoassay. The target molecule was captured on beads and bound to detection antibody. The beads were used to immobilize the target while unbound material was removed. The entire bead/target complex was detected by the single particle analyzer system.

FIG. 10. TSH was added to samples that contain 10% human serum. The samples were used in a sandwich capture assay for TSH and run on the single particle analyzer system. In this assay the recovery was calculated at 108%.

FIG. 11. Electrophoresis of dendrimer, and dilution curve. A) Cross-correlation analysis of particles in a buffer blank. B) Cross-correlation analysis of particles in 0.03 fM sample. C) Linear relationship of particles detected by cross-correlation and concentration of the samples.

FIG. 12. Electrophoresis of dendrimer dilution curve. A) Cross-correlation analysis of photons in a buffer blank. B) Cross-correlation analysis of photons in 0.03 fM sample.

FIG. 13. Electrophoresis of bovine serum albumin (“BSA”) and dilution curve in the presence of sodium dodecyl sulfate (“SDS”). A) Raw data of particles detected by cross-correlation in a buffer blank. B) Particles detected by cross-correlation in 10 fM sample. C) Linear relationship of particles detected by cross-correlation and concentration of the samples.

FIG. 14. Mobility of virus particle increases with increasing current.

FIG. 15. Detection of microorganisms. A) E. coli cells were incubated with labeled antibody to allow for specific binding. After removing unbound antibody the bound antibody was released from the cells and measured. B) Viral particles were bound to a plate, incubated with labeled antibody, washed, and the bound label released and measured.

FIG. 16. Mass tag. Electrophoretic mobility of organelle (PBXL-3) shifts when bound to nucleic acid. A) PBXL-3 alone migrates as a peak at 368 ms. B) PBXL-3 bound to nucleic acid migrates as a peak at 294 ms. C) PBXL-3 in the presence of, but not bound to nucleic acid migrates at 409 ms.

FIG. 17. Discrimination of a virus and nucleic acid, both labeled with Alexa Fluor®647 (“A647”; Invitrogen, Carlsbad, Calif.). A) Two peaks resolved in a mixture of virus, labeled with an antibody to a coat protein and labeled nucleic acid. B) Labeled nucleic acid alone. C) Antibody labeled-virus alone.

FIG. 18. SDS electrophoresis. Discrimination of a protein and nucleic acid, both labeled with A647. A) Protein bound to Ab alone. B) Labeled nucleic acid alone. C) Two peaks resolved in a mixture of protein bound to labeled Ab, and labeled nucleic acid.

FIG. 19. Discrimination of labels released from protein target and nucleic acid targets. A) Detection of label released from a protein target. Thyroid stimulating hormone (TSH) was immobilized on a 96 well plate and labeled with A647 labeled anti-TSH. Unbound reagents were removed by washing. The A647 labeled antibody was dissociated from the TSH and measured in the SMD. A linear relationship was observed between the net particles of A647 measured and the original TSH concentration. B) Prophetic representation of discrimination of released labels based on their electrophoretic mobility. C) Prophetic representation of discrimination of released labels based on their fluorescence intensity.

FIG. 20. Discrimination of particles based on fluorescence intensity. A) and B) Brightness is plotted against the elapsed time for detection of each particle at both detectors. Each dot shown on the plot represents measurements taken on a single molecule. The scale of the x-axis (elapsed time) was restricted to emphasize the individual molecules within a peak. A cut-off value of 500 photons was used to divide the “bright” molecule window from the “dim' molecule window. PBXL-3 molecules emit at a higher average intensity than the pUC19 molecules. C). The concentrations of PBXL-3 and pUC19 as determined by molecule counting are compared to the predicted values as determined by spectroscopy of the undiluted sample.

FIG. 21. Detection and discrimination of particles using a sandwich assay. A) Target proteins (P) are bound to a bead (B) and also to a label to render them detectable. In the heterogeneous assay representation in panel A, the unbound label is removed from the sample and the bead-label-target complex is subjected to electrophoresis. B) In the homogeneous assay representation in panel B, the unseparated sample is subjected to electrophoresis and the bead-label-target is distinguished from unbound label.

FIG. 22. Schemes for detection and discrimination of particles using a two-color assay. Target particles (T) are bound to two labels (L). The each label emits electromagnetic radiation at a distinct detectable wavelength. A) The sample is subjected to electrophoresis and the target particle is distinguished from particle labeled with only one colored label, from unbound target and unbound label. B) The target particles are labeled with each of two different labels, and an agonist or antagonist for binding of one of the labeled particles to the target is added. The sample is subjected to electrophoresis, and particles with two labels are distinguished from particles with one label bound to a competitor, and from unbound label. C) An inactive tetramer of catalytic (C) subunits, labeled with a FRET acceptor (A), and regulatory (R) subunits, labeled with a FRET donor (D) of cyclic AMP-dependent kinase A emits at wavelength 2 (λ2). In the presence of cAMP, the tetramer dissociates and the single subunit will emit at wavelength 1 (λ1). D) Receptor (R) and ligand (L) are labeled with a FRET acceptor (A) and donor (D) respectively and emit at λ2 when bound to each other. Displacing the labeled ligand with unlabeled ligand will cause the unbound labeled ligand to emit at λ1. E) Receptor (R) and ligand (L) are labeled with a FRET acceptor (A) and donor (D) respectively and emit at λ2 when bound to each other. Displacing the labeled ligand with a competitor, disrupts the receptor/ligand binding and will cause the unbound labeled ligand to emit at λ1. F) An intact substrate particle is labeled with an acceptor (A) and quencher (Q) and no emission occurs. Cleaving the substrate with an enzyme separates the pair and the fragment labeled with the acceptor will emit.

FIG. 23. Representations of labeling for single particle detection. A) A target particle is labeled with at least one particle of a single dye. B) A target particle is labeled with at least one particle each of two different dyes.

FIG. 24. Representations of labeling for detection and discrimination of at least two particles. A) Particles labeled with different multiples of a single dye. B) Particles labeled with two different dyes, or one of each of the two dyes. C) and D) Particles labeled with two dyes where at least one is present in multiple copies. E) Particles labeled with at least one each of two dyes that have different fluorescent intensities. F) Particles labeled with either a dye or a label that affects electrophoretic velocity. G) and H) Particle labeled with one dye each.

FIG. 25. Representations of labeling for detection and discrimination based on electrophoretic velocity. A) Target particles that are intrinsically detectable are labeled with distinct labels that affect electrophoretic velocity. B) Target particles are labeled with a detectable dye tag or a labels that affects electrophoretic velocity.

FIG. 26. Representations of discrimination of two particles by their characteristic intensity of fluorescence emission. A) Target particles are labeled with one or multiple copies of one dye and are distinguished by the intensity of the fluorescent emission which is proportional to the number of dye particles bound per particle. B) Target particles are labeled with one or multiple copies of two dyes and are distinguished by the total intensity of the fluorescent emission or the ratio of the intensity of the two different dyes.

FIG. 27. Representations of fluorescent polarization assay. A target particle labeled with a dye has a distinct fluorescence polarization that is determined by its rate of rotation. Binding the labeled particle to a receptor alters the rate of rotation, and subsequently the fluorescence polarization of the detected particle

FIG. 28. A) and B): Markers of use in various conditions, and their present limits of detection

FIG. 29. A graphical representation showing the number of fluorescent product molecules counted at each concentration of alkaline phosphatase reacted with substrate and run on a two-interrogation space analyzer.

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

### DETAILED DESCRIPTION OF THE INVENTION

The present invention provides analyzers and analyzer systems, and methods of using the analyzers and analyzer system, for ultra-sensitive detection, quantitation and discrimination of particles at very low concentrations.

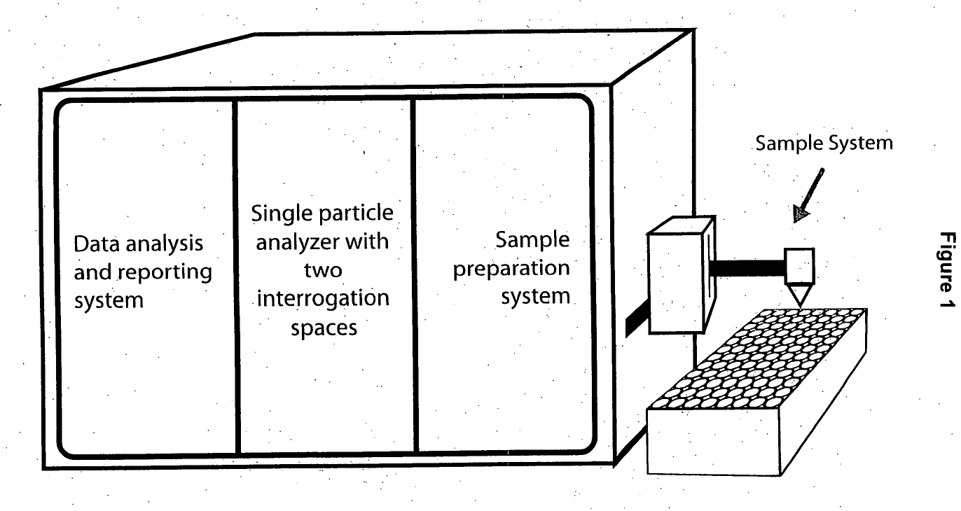

One embodiment of an analyzer system of the present invention is illustrated in FIG. 1. The illustrated system includes a sampling system capable of automatically sampling a plurality of samples and providing a fluid communication between a sample container and a first interrogation space; optionally, a sample preparation system; an analyzer capable of detecting a single particle, where the analyzer contains the first interrogation space and a second interrogation space through which the sample passes, and which are positioned to receive electromagnetic (EM) radiation from an EM radiation source, and which are operably connected to separate electromagnetic radiation detectors; and a data analysis and reporting system.

The analyzer is small, durable and accurate for the detection of single particles, interactions between individual particles and events involving single particles or particle complexes. The analyzer, analyzer system, and related methods may be used to generate and determine characteristic velocities, e.g., electrophoretic velocities for single particles, such as using data cross-correlation to determine single particle velocities, to minimize analytical noise, and to discriminate between particles based on their velocities, e.g., electrophoretic velocities and/or electromagnetic emissions. The analyzer, analyzer system, and related methods provide the capability to distinguish at least one particle in a sample comprising multiple particles. In addition, the analyzer, analyzer system, and related methods provide for the improved detection of multiple target particles or multiple identifiable characteristics of one or more target particles in a single sample.

The embodiments described below use, by way of example, electromagnetic radiation as a means of particle detection. Within the field of single particle detection, optical-based detection systems (i.e., laser-induced fluorescence) are generally available and well-known to those of skill in the art. However, it is understood that other methods of particle detection, e.g., the use of chemiluminescent or radioactive tags and the like, where electromagnetic radiation is not required to be provided to the sample, but only detected, are also within the scope of the invention.

I. Apparatus/System

In one aspect, the invention provides an analyzer capable of detecting individual particles in a sample, where the particles are moved through the analyzer by a motive force. In some embodiments the analyzer comprises a single particle detection instrument that uses continuous wavelength (CW) lasers as a source of EM radiation, and that contains two fluidly-connected interrogation spaces, where pressure is used to move the sample through the interrogation spaces. In some embodiments the analyzer comprises a single particle detection instrument that uses continuous wavelength (CW) lasers as a source of EM radiation, and that contains two fluidly-connected interrogation spaces, where electrokinetic force is used to move the sample through the interrogation spaces.

In another aspect, the invention provides an analyzer system. In some embodiments, the system includes an analyzer capable of detecting a single particle (e.g., a single molecule), where the detection instrument contains one interrogation space fluidly connected to a sampling system for introducing samples into the analyzer, an electromagnetic radiation source for emitting electromagnetic radiation, where the interrogation space is positioned to receive EM radiation emitted from the radiation source, and a first radiation detector operably connected to the first interrogation space to measure a first electromagnetic characteristic of the particle (e.g., molecule). In some embodiments the system includes an analyzer capable of detecting a single particle (e.g., a single molecule), where the detection instrument contains two fluidly connected interrogation spaces and a sampling system for introducing samples into the analyzer. In preferred embodiments the sampling system is an automated sampling system capable of sampling a plurality of samples without intervention from a human operator. In some embodiments the system further includes a sample recovery mechanism whereby a portion, or substantially all, of the sample may be recovered after analysis. In some embodiments the system further provides a sample preparation mechanism where a sample may be partially or completely prepared for analysis by the single particle analyzer. In some embodiments, the system further provides a computer for controlling the analysis and/or analyzing raw data and, in further embodiments, a reporting device for reporting the results of this analysis.

A. Samples and Particles

The invention provides analyzers and analyzer systems for highly sensitive, robust, and reproducible analysis of a wide variety of samples and the particles that may be contained within the samples. The invention provides methods of the detection of the presence, absence, and/or concentration of the particles.

1. Samples

Any sample that is capable of being moved through the interrogation spaces of the system, with or without processing, and that contains or may contain particles capable of detection by the detectors of the system, may be analyzed by the single particle analyzer or analyzer system of the invention. These include but are not limited to samples from industrial applications, environmental samples, agricultural samples, bioterrorism samples, samples for medical screening, diagnosis, prognosis or treatment, and samples from biomedical or other research, such as clinical or preclinical trials. Samples may be from in vitro or in vivo sources, or a combination thereof. The system is especially useful for the analysis of clinical samples for biomedical research, diagnosis or treatment.

Assays, for example as described in the Examples below, may be carried out using methods of the invention in a biological sample, e.g., a biological fluid. Such fluids include, without limitation, bronchoalveolar lavage fluid (BAL), blood, serum, plasma, urine, cerebrospinal fluid, pleural fluid, synovial fluid, peritoneal fluid, amniotic fluid, gastric fluid, lymph fluid, interstitial fluid, tissue homogenate, cell extracts, saliva, sputum, stool, physiological secretions, tears, mucus, sweat, milk, semen, seminal fluid, vaginal secretions, fluid from ulcers and other surface eruptions, blisters, and abscesses, and extracts of tissues including biopsies of normal, malignant, and suspect tissues or any other constituents of the body which may contain the target particle of interest. Other similar specimens such as cell or tissue culture or culture broth are also of interest.

In some embodiments, the sample is a blood sample. In some embodiments the sample is a serum or plasma sample. In some embodiments, the sample is a bronchoalveolar lavage (BAL) sample. In some embodiments, the sample, e.g., a blood, serum or plasma sample is used in the methods of the invention without further treatment. In other embodiments, the sample is treated, e.g. to label one or more particles of interest, as described herein. The treatment may occur before introduction of the sample into the analyzer system of the invention, or it may occur after the sample is introduced into the system.

2. Particles for Analysis

Methods for detecting at least one single particle using the analyzers and analysis systems of the invention are also provided. A particular feature of this single particle analyzer is the ability to detect a wide range of particles. Particles which can be detected by the analyzer include, but are not limited to, molecules, supramolecular complexes, organelles, beads, associations of molecules, associations of supramolecular complexes, and organisms. Examples of molecular particles which can be detected using the analyzer and related methods of the present invention include: biopolymers such as proteins, nucleic acids, carbohydrates, and small particle chemical entities, both organic and inorganic. Examples of the latter include, but are not limited to anti-autoimmune deficiency syndrome substances, antibodies, anti-cancer substances, antibiotics, anti-viral substances, enzymes, enzyme inhibitors, neurotoxins, opioids, hypnotics, antihistamines, tranquilizers, anti-convulsants, muscle relaxants and anti-Parkinson substances, anti-spasmodic and muscle contractants, miotics and anti-cholinergics, immunosuppressants (e.g., cyclosporine) anti-glaucoma solutes, anti-parasite and/or anti-protozoal solutes, anti-hypertensives, analgesics, anti-pyretics and anti-inflammatory agents (such as Non-Steroidal Antiinflammatory Drugs), local anesthetics, ophthalmics, prostaglandins, anti-depressants, anti-psychotic substances, anti-emetics, imaging agents, specific targeting agents, neurotransmitters, proteins and cell response modifiers.

Similarly, detectable chemical entities encompass small particles such as amino acids, nucleotides, lipids, sugars, drugs, toxins, venoms, substrates, pharmacophores, and any combination thereof. Proteins are also of interest in a wide variety of therapeutics and diagnostics, such as detecting cell populations, blood type, pathogens, immune responses to pathogens, immune complexes, saccharides, lectins, naturally occurring receptors, and the like. Other examples of detectable particles include nanospheres, microspheres, dendrimers, chromosomes, organelles, micelles and carrier particles. Examples of organelles include subcellular particles such as nuclei, mitochondria, ribosomes, and endosomes. Examples of organisms include viruses, bacteria, fungal cells, animal cells, plant cells, eukaryotic cells, prokaryotic cells, archeobacter cells, and any combination thereof.

Also included are particles composed of complexes of particles, organisms with labels bound, complexes of two or more nucleic acids, and complexes of target particles bound to one or more antibodies or antibody fragments. Complexes where two or more types of single particles are detected include particles selected from a protein, a receptor, a DNA, a RNA, a PNA, a LNA, a carbohydrate, an organelle, a virus, cell, a bacterium, a fungus, fragments thereof, and combinations thereof. Those of skill in the art will recognize how to adapt the analyzer and related methods of the present invention, in light of the numerous Examples provided herein, to detect these and other particles.

In one embodiment, chemical entities that may be detected by the analyzer and related methods include synthetic or naturally occurring hormones, naturally occurring drugs, synthetic drugs, pollutants, allergens, affecter particles, growth factors, chemokines, cytokines, lymphokines, amino acids, oligopeptides, chemical intermediates, nucleotides, and oligonucleotides.

Of particular interest is detection of microorganisms and cells, including viruses, prokaryotic and eukaryotic cells, unicellular and polycellular organism cells, e.g., fungi, animal, mammal, etc., and fragments thereof. The methods of the invention may also be used for detecting pathogens. Pathogens of interest may be, but are not limited to, viruses such as Herpes viruses, Poxviruses, Togaviruses, Flaviviruses, Picornaviruses, Orthomyxoviruses, Paramyxoviruses, Rhabdoviruses, Corona viruses, Arenaviruses, and Retroviruses. They may also include bacteria including but not limited to Escherichia coli, Pseudomonas aeruginosa, Enterobacter cloacae, Staphylococcus aureus, Enterococcus faecalis, Klebsiella pneumoniae, Salmonella typhimurium, Staphylococcus epidermidis, Serratia marcescens, Mycobacterium bovis, methicillin resistant Staphylococcus aureus and Proteus vulgaris. The examples of such pathogens are not limited to above pathogens and one skilled in the art will know which specific species of microorganisms and parasites are of particular importance in a given setting or application of the invention. Further examples are provided herein. In additions, a non-exhaustive list of these organisms and associated diseases can be found for example in U.S. Pat. No. 5,795,158 issued to Warinner, which is incorporated herein by reference in its entirety. Other particles of clinical interest may be biomarkers for inflammation (see, e.g., Lucey et al. (1996) Clin Microbiol. Rev. 9:532-62), cancer (see, e.g., Sidransky (2002) Nat. Rev. Cancer 2: 210-219; Etzioni et al. (2003) Nat. Rev. Cancer 3:243-52) or Alzheimers Disease(see, e.g., Golde (2003) J. Clin. Invest. 111: 11-18).

In one embodiment, several types of particles may be detected and discriminated in the same sample. Examples of combinations of particles that are of special interest for the applications of the invention include an infectious agent/antibody to the agent, an infectious agent/nucleic acid/toxin, cancer cell/dysregulated protein, mRNA /corresponding protein transcript, gene(DNA)/message(RNA), gene(DNA)/protein, virus/toxin, bacterium/toxin, enzyme/substrate, and enzyme/product. In some embodiments, panels of particles, whose presence, absence, and/or concentration is associated with a condition or a constellation of conditions, may be analyzed by the system of the invention.

The methods described herein enable at least one particle to be distinguished singly in a sample comprising multiple particles. Amplification of the particle is not required. Multiple particles includes small particles, nucleic acids (e.g., single-stranded, double-stranded, DNA, RNA, and hybrids thereof), proteins (e.g., peptides, polypeptides and proteins), organic and inorganic molecules (e.g., metabolites, cytokines, hormones, neurotransmitters, and the like), and organisms (e.g., viruses and cells). In this regard, a sample comprising multiple particles can comprise multiple small particles, multiple particles of nucleic acids, multiple particles of proteins, multiple organic and/or inorganic molecules, and multiple cells and/or viruses or various combinations of the foregoing. Thus, any particle in a sample comprising (i) nucleic acids, small particles, organic/inorganic molecules, or proteins, (ii) nucleic acids and small particles, (iii) nucleic acids and proteins, (iv) proteins and small particles, (v) proteins and organic/inorganic molecules, (vi) nucleic acids and organic/inorganic molecules, or (vi) nucleic acids, small particles and proteins and combinations of the above with cells/viruses can be distinguished.

In addition to the particles described above, are particles comprising complexes such as nucleic acids hybridized to labels, antibody-antigen complexes, ligand-receptor complexes, enzyme-substrate complexes, and protein-nucleic acid complexes which can be discriminated using these methods.

B. Single Particle Analyzer

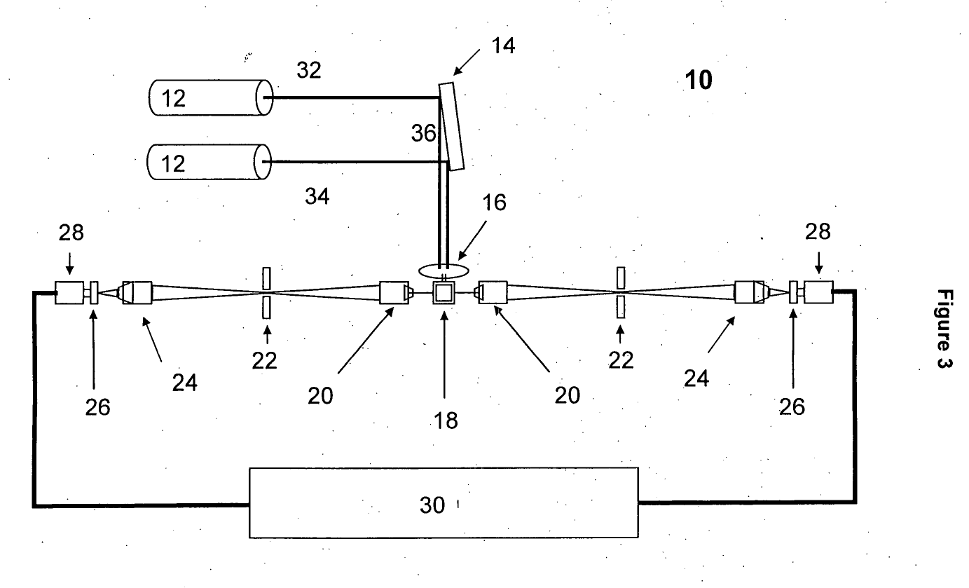

As shown in FIG. 3, an analyzer of one embodiment of the present invention is designated in its entirety by the reference numeral 10. The analyzer 10 includes two continuous wave electromagnetic radiation sources 12, a mirror 14, a lens 16, a capillary flow cell 18, two microscope objective lenses 20, two apertures 22, two detector lenses 24, two detector filters 26, two single photon detectors 28, and a processor 30 operatively connected to the detectors.

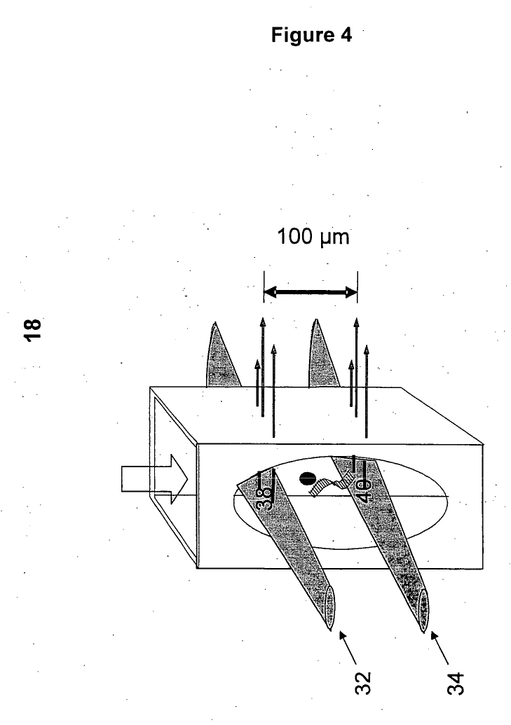

In operation, the radiation sources 12 are aligned so their beams 32, 34 are reflected off a front surface 36 of mirror 14. The lens 16 focuses the beams 32, 34 into two separate interrogation spaces (e.g., interrogation spaces 38, 40 shown in FIG. 4) in the capillary flow cell 18. The microscope objective lenses 20 collect light from sample particles and form images of the beams 32, 34 onto the apertures 22. The apertures 22 block out scattering from walls of the capillary flow cell 18. The detector lenses 24 collect the light passing through the apertures 22 and focus the light onto an active area of the detectors 28 after it passes through the detector filters 26. The detector filters 26 facilitate minimizing noise signals (e.g., scattered light, ambient light) and maximizing the light signal from the particle. The processor 30 processes the light signal from the particle according to the methods described herein. In one embodiment, the microscope objective lenses 20 are high-numerical aperture microscope objectives.

One embodiment of a capillary flow cell 18 of the analyzer of the present invention is shown in FIG. 4. As shown in FIG. 4, two beams 32, 34 from the continuous wave electromagnetic radiation sources 12 (FIG. 3) are optically focused on targets that are spaced apart by a predetermined distance (e.g., about 100 μm). The beams 32, 34 are perpendicular to a length of the sample-filled capillary flow cell 18. The beams 32, 34 are operated at predetermined wavelengths selected to excite a particular detection label. A plurality of interrogation spaces 38, 40 of the analyzer 10 (FIG. 3) are each determined by a diameter of the respective beam 32, 34 and/or by a segment of the respective beam 32, 34 selected. The interrogation spaces 38, 40 are each set such that, with an appropriate sample concentration, only one particle is present in each interrogation space during each time interval over which observations are made. Although the beams 32, 34 may have other diameters without departing from the scope of the present invention, in one embodiment each beam has a diameter of about 5 μm.

A motive force is applied to the sample. In one embodiment the motive force is pressure. In some embodiments the motive force is an electric field that is applied to the sample to move particles electrophoretically. In some embodiments a combination of motive forces, such as pressure and electric field, are used. Under electrophoretic conditions, particles of similar charge and mass move through the cell 18 at nearly the same speed. As particles pass through the beams 32, 34, each fluorescent particle is excited via one-photon excitation. Within a fraction of a second, the excited particle relaxes, emitting a detectable burst of light. The excitation-emission cycle is repeated many times by each particle in the length of time it takes for it to pass through the beam allowing the analyzer 10 (FIG. 3) to be able to detect tens to thousands of photons for each particle as it passes through an interrogation space 38 or 40. Photons emitted by fluorescent particles are registered in both detectors 26 (FIG. 3) with a time delay indicative of the time for the particle (or molecular complex) to pass from the interrogation space of one detector to the interrogation space of the second detector. The photon intensity is recorded by the detectors 26. The signals detected in the detectors 26 are divided into uniform, arbitrary, time segments with freely selectable time channel widths. The number of signals contained in each segment is established. One or a combination of several statistical analyses is evaluated for the presence of particles. In this way, a particle is discriminated from stochastic and background noise.

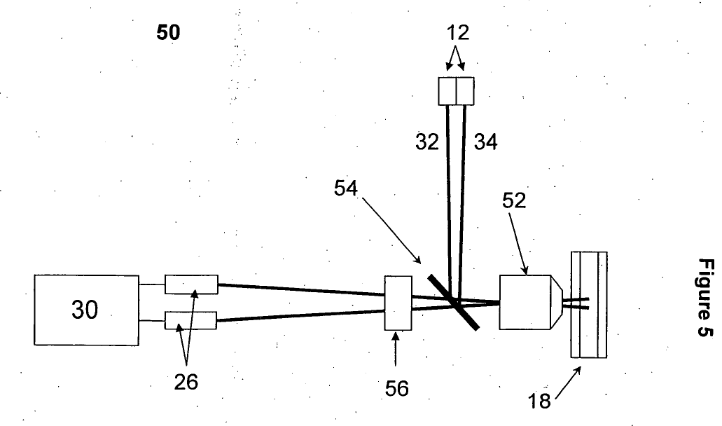

A confocal arrangement of an analyzer 50 of the present invention is shown in FIG. 5. The beams 32, 34 from two continuous wave electromagnetic radiation sources 12 are combined by a single microscope objective 52 to form two interrogation spaces (e.g., interrogation spaces 38, 40 shown in FIG. 4) within the capillary flow cell 18. A dichroic mirror 54, which reflects laser light but passes fluorescence light, is used to separate the fluorescence light from the laser light. A further filter 56 in front of the detectors 26 eliminates any non-fluorescence light at the detectors.

1. Motive Force

The particles are moved through the interrogation spaces by a motive force. In some embodiments, the motive force for moving particles is pressure. In some embodiments, the pressure is supplied by a pump, an air pressure source, a vacuum source, a centrifuge, or a combination thereof. In some embodiments, the pressure is supplied by a pump. In some embodiments the motive force is electrokinetic force. Magnetic force (e.g., for controlling the movement of magnetic particles) or optical force may also be used. Combinations of forces may also be used.

a. Pressure

When pressure, e.g., pumping, is used to move particles, the time delay between observation of a particle at the two interrogation spaces is uniform and predictable, i.e., the time offset may be determined in advance, which can help to distinguish particles from noise. With other motive forces, e.g., electrophoresis, it is more difficult to predict the offset, as multiple species in a sample are likely to move at multiple speeds, determined by their electrophoretic mobility.

In some embodiments, pressure is supplied to move the sample by means of a pump. Suitable pumps are known in the art, e.g., those made by manufacturers such as Scivex, Inc., for applications such as HPLC. For pumping smaller volumes (e.g., when sample concentration is not limiting), microfluidics pumps may be useful, such as those described in U.S. Pat. Nos. 5,094,594, 5,730,187; 6,033,628; and 6,533,553, which disclose devices which can pump fluid volumes in the nanoliter or picoliter range. Preferably all materials within the pump that come into contact with sample are made of highly inert materials, e.g., polyetheretherketone (PEEK), fused silica, or sapphire.

Standard pumps come in a variety of sizes, and the proper size may be chosen to suit the anticipated sample size and flow requirements. In some embodiments, separate pumps are used for sample analysis and for flushing of the system. The analysis pump may have a capacity of, e.g. about 0.000001 mL to about 10 mL, or about 0.001 mL to about 1 mL, or about 0.01 mL to about 0.2 mL, or about 0.005, 0.01, 0.05, 0.1, or 0.5 mL. Flush pumps may be of larger capacity than analysis pumps, e.g. about 0.01 mL to about 20 mL, or about 0.1 mL to about 10 mL, or about 0.1 mL to about 2 mL, or about or about 0.05, 0.1, 0.5, 1, 5, or 10 mL. These pump sizes are illustrative only, and those of skill in the art will appreciate that the pump size may be chosen according to the application, sample size, viscosity of fluid to be pumped, tubing dimensions, rate of flow, temperature, and other factors well known in the art. In some embodiments, pumps of the system are driven by stepper motors, which are easy to control very accurately with a microprocessor.

In preferred embodiments, the flush and analysis pumps are used in series, with special check valves to control the direction of flow. The plumbing is designed so that when the analysis pump draws up the maximum sample, the sample does not reach the pump itself. This is accomplished by choosing the ID and length of the tubing between the analysis pump and the analysis capillary such that the tubing volume is greater than the stroke volume of the analysis pump.

In some embodiments, air pressure is used to move the particles and sample. Sources of air pressure and their control are known in the art.

b. Electrokinetic Force and Others

To generate an electric field for electrokinetic movement of particles, a high voltage power supply (not shown) is connected to the sample by means of electrodes, e.g. platinum electrodes, for example one electrode can be placed at each end of a sample capillary. Voltages in the range of about 10 to about 1,000 V/cm may be appropriate.

Electrokinetic force can also be combined with other motive forces. In some cases, the additional forces can be used to alter the velocity of all the particles-within a sample to the same extent. In some embodiments, the additional forces provide a way of distinguishing between different types of particles or between a label bound to a particle and an unbound label. One example of a way by which the addition forces may be applied to the sample is pressure (and vacuum) using pumps, as described above. In one embodiment, a syringe pump is used; however, pressure can be applied to the sample using any controllable fluid delivery system, such as gravity feed, a positive displacement pump, or a roller-type pump, without departing from the scope of the present invention. Centrifuigal force for fluid flow involves components (not shown) that are operably connected to the interrogation spaces 38, 40, such as rotating disks (not shown). These components can be fabricated either integral to the disk or as modules attached to, placed upon, in contact with or embedded in the disk.

In one embodiment, magnetic separation is used by selectively retaining magnetic materials in a magnetic field. This technique can also be applied to non-magnetic targets labeled with magnetic particles. In one application of this technique, a particle is labeled by attaching the target material to a magnetic particle. The attachment is generally through association of the particle with a specific binding partner which is conjugated to a coating on the particle which provides a functional group for the conjugation. Those of skill in the art will recognize that such magnetic particle conjugation is well known in the art, such as described in the Examples below, and in kits available from New England Biolabs of Beverly, Mass. and Qiagen of Valencia, Calif. The material of interest, or target, thus coupled to a magnetic tag is suspended in a fluid which is then supplied to a chamber (not shown) for introduction to the interrogation space 38, 40. In the presence of a magnetic gradient supplied across the chamber, the magnetically labeled target is retained in the chamber; if the chamber contains a matrix, it becomes associated with the matrix. Materials which do not have magnetic labels pass through the chamber. The retained materials can then be eluted by changing the strength of, or by eliminating, the magnetic field. The magnetic field can be supplied either by a permanent magnet or by an electromagnet. The selectivity for a desired target material is supplied by the specific binding-partner conjugated to the magnetic particle. The chamber across which the magnetic field is applied is often provided with a matrix of a material of suitable magnetic susceptibility to induce a high magnetic field gradient locally in the chamber in volumes close to the surface of the matrix.

In another embodiment, the sample is subjected to electrophoresis, such as by placing the sample in an electrophoretic sample channel. Mobility of particles within the sample fluid varies with the properties of the particle. The velocity of movement produced by electrokinetic force is determined by the relative charge and mass of the single particle. Movement of a particle can be altered by the type of label that has been attached to the particle, such as a charge/mass tag. In another embodiment, when two or more particles are present, at least one particle may move through at least two interrogation spaces 38, 40 in a direction opposite that of the other particle. Therefore, the electrophoretic mobility of each detectably labeled particle is determined. Based on the determination of the electrophoretic velocity of each detectably labeled particle, single particles in a sample comprising multiple particles can be distinguished. Almost any electrophoretic separation technique combined with an immunoassay or nucleic acid hybridization labeling technique can be adapted for use in the context of the present invention.

Electrokinetic force can be combined with other motive forces such as pressure, vacuum, surface tension, gravity, and centrifugal to discriminate between particles. In one embodiment, these forces can be chosen for their differential effects on different particles within a sample when two or more particles are present, resulting in at least one particle moving through at least two interrogation spaces 38, 40 with a velocity that differs from the other particle(s). The velocities of the particles can be aligned with the fluid flow or at least one particle can move antiparallel to the fluid flow. In another embodiment, at least one particle has an antiparallel velocity exceeding the velocity of the fluid flow. In another embodiment, at least one particle is in motion perpendicular to the fluid flow. In another embodiment, at least one particle is in motion with a combination of motions that are antiparallel and perpendicular to the fluid flow.

2. EM Radiation Source

In embodiments of the invention where the extrinsic label or intrinsic characteristic of the particle is a light-interacting label or characteristic, such as a fluorescent label or a light-scattering label, a source of EM radiation is used to illuminate the label and/or the particle. In other embodiments in which, e.g., a chemiluminescent label is used, it may not be necessary to utilize an EM source for detection of the particle. EM radiation sources for excitation of fluorescent labels are preferred.

Although two continuous wave electromagnetic radiation sources 12 are shown in FIGS. 3 and 5, it should be understood that only one continuous wave electromagnetic radiation source may be used without departing from the scope of the present invention. Furthermore, if only one continuous wave electromagnetic radiation source 12 is used, the source may be split into any number of beams to direct electromagnetic radiation to any number of distinct interrogation spaces.

In the embodiment shown in FIG. 3, each of the interrogation spaces 38, 40 has a separate continuous wave electromagnetic radiation source 12. Although only two sources 12 are shown in FIGS. 3 and 5, any number of sources may be used without departing from the scope of the present invention. In some cases, all of the continuous wave electromagnetic sources emit electromagnetic radiation at the same wavelengths. In other embodiments, different sources emit different wavelengths of electromagnetic radiation. Different configurations of sources and interrogation spaces can be designed. For example, in one embodiment two or more continuous wave electromagnetic radiation sources with different emission wavelengths can be used to illuminate the same interrogation space and this configuration can be extended to multiple interrogation spaces. In another embodiment, each interrogation space is illuminated with electromagnetic radiation of a different wavelength. It should be understood by one skilled in the art that many different combinations of illumination wavelengths and interrogation spaces can be used with the analyzer of the present invention.

Although other sources may be used without departing from the scope of the present invention, in one embodiment the sources 12 are continuous wave lasers producing wavelengths of between about 200 and about 1,000 nm. Such sources 12 have the advantage of being small, durable and relatively inexpensive. In addition, they generally have the capacity to generate larger fluorescent signals than other light sources. Specific examples of suitable continuous wave electromagnetic radiation sources include, but are not limited to: lasers of the argon, krypton, helium-neon, helium-cadmium types, as well as, tunable diode lasers (red to infrared regions), each with the possibility of frequency doubling. The lasers provide continuous illumination with no accessory electronic or mechanical devices such as shutters, to interrupt their illumination. LEDs are another low-cost, high reliability illumination source. Recent advances in ultra-bright LEDs and dyes with high absorption cross-section and quantum yield, support the applicability of LEDs to single particle detection. Such lasers could be used alone or in combination with other light sources such as mercury arc lamps, elemental arc lamps, halogen lamps, arc discharges, plasma discharges, light-emitting diodes, or combination of these.

The optimal laser intensity depends on the photo bleaching characteristics of the single dyes and the length of time required to traverse the interrogation space (including the speed of the particle, the distance between interrogation spaces and the size of the interrogation spaces). To obtain a maximal signal, it is desirable to illuminate the sample at the highest intensity which will not result in photo bleaching a high percentage of the dyes. The preferred intensity is one such that no more that 5% of the dyes are bleached by the time the particle has traversed the final interrogation space.

In one embodiment, the interrogation spaces 38, 40 are determined by the cross sectional area of the corresponding beams 32, 34 and by a segment of the beam within the field of view of the detector. In one embodiment of the invention, the interrogation spaces 38, 40 are between 0.02 pL and 300 pL. In one embodiment of the invention, the interrogation spaces 38, 40 are between 0.02 pL and 50 pL. In another embodiment, the interrogation spaces 38, 40 are in the range of about 0.1 to about 25 pL. Preferably the interrogation spaces are about 1 pL. It should be understood by one skilled in the art that the interrogation spaces 38, 40 can be selected for maximum performance of the analyzer. Although very small interrogation spaces have been shown to minimize the background noise, large interrogation spaces have the advantage that low concentration samples can be analyzed in a reasonable amount of time. In one embodiment of the present invention, the interrogation spaces are large enough to allow for detection of particles at concentrations ranging from about 1000 fM to about 1 zeptomolar (zM). In one embodiment of the present invention, the interrogation spaces are large enough to allow for detection of particles at concentrations ranging from about 1000 fM to about 1 attomolar (aM). In one embodiment of the present invention, the interrogation spaces are large enough to allow for detection of particles at concentrations ranging from about 10 fM to about 1 attomolar (aM). In many cases, the large interrogation spaces allow for the detection of particles at concentrations of less than about 1 fM without additional pre-concentration devices or techniques. One skilled in the art will recognize that the most appropriate interrogation space size depends on the brightness of the particles to be detected, the level of background signal, and the concentration of the sample to be analyzed.

The size of the interrogation spaces 38, 40 can be limited by adjusting the optics of the analyzer. In one embodiment, the diameter of the beams 32, 34 can be adjusted to vary the volume of interrogation spaces 38, 40. In another embodiment, the field of view of the detector 26 can be varied. Thus, the sources 12 and the detectors 26 can be adjusted so that single particles will be illuminated and detected within the interrogation spaces 38, 40. In another embodiment, the width of slits 22 (FIG. 3) that determine the field of view of the detectors 26 are variable. This configuration allows for altering the interrogation space, in near real time, to compensate for more or less concentrated samples, ensuring a low probability of two or more particles simultaneously being within in an interrogation space.

Physical constraints to the interrogation spaces can also be provided by a solid wall. In one embodiment, the wall is one or more of the cell 18 walls, when the sample fluid is contained within a capillary. In one embodiment, the cell 18 is made of glass, but other substances transparent to light in the range of about 200 to about 1,000 nm or higher, such as quartz, fused silica, and organic materials such as Teflon, nylon, plastics, e.g., polyvinylchloride, polystyrene and polyethylene, or any combination thereof, may be used without departing from the scope of the present invention. Although other cross-sectional shapes (e.g., rectangular, cylindrical) may be used without departing from the scope of the present invention, in one embodiment the capillary flow cell 18 has a square cross section. In another embodiment, the interrogation spaces may be defined at least in part by a channel (not shown) etched into a chip (not shown).

The interrogation spaces 38, 40 are connected by fluid. In one embodiment, the fluid is aqueous. In other embodiments, the fluid is non-aqueous or a combination of aqueous and non-aqueous fluids. In addition the fluid may contain agents to adjust pH, ionic composition, or sieving agents, such as soluble macroparticles or polymers or gels. It is contemplated that valves or other devices may be present between the interrogation spaces to temporarily disrupt the fluid connection. Interrogation spaces temporarily disrupted are considered to be connected by fluid.

In another embodiment of the invention, an interrogation space 38, 40 is constrained by the size of a laminar flow of the sample material within a diluent volume, also called sheath flow. The interrogation space 38, 40 can be defined by sheath flow alone or in combination with the dimensions of the illumination source or the field of view of the detector.

Sheath flow can be configured in numerous ways, including those listed below:
1. The sample material is the interior material in a concentric laminar flow, with the diluent volume in the exterior.
2. The diluent volume is on one side of the sample volume.
3. The diluent volume is on two sides of the sample material.
4. The diluent volume is on multiple sides of the sample material, but not enclosing the sample material completely.
5. The diluent volume completely surrounds the sample material.
6. The diluent volume completely surrounds the sample material concentrically.
7. The sample material is the interior material in a discontinuous series of drops and the diluent volume completely surrounds each drop of sample material.
   One skilled in the art will recognize that in some cases the analyzer will contain 3, 4, 5, 6 or more distinct interrogation spaces.

3. Detectors

In one embodiment, light (e.g., light in the ultra-violet, visible or infrared range) is the electromagnetic radiation detected. The detectors 26 are capable of capturing the amplitude and duration of photon bursts from, e.g., fluorescent particles and converting them to electronic signals. Detection devices such as CCD cameras, video input module cameras, and Streak cameras can be used to produce images with contiguous signals. In another embodiment, devices such as a bolometer, a photodiode, a photodiode array, avalanche photodiodes, and photomultipliers which produce sequential signals may be used. Any combination of the aforementioned detectors may also be used. In one embodiment, avalanche photodiodes are used for detecting photons.

Using specific optics between an interrogation space 38, 40 and its corresponding detector 26, several distinct characteristics of the emitted electromagnetic radiation can be detected including: emission wavelength, emission intensity, burst size, burst duration, and fluorescence polarization.

It should be understood by one skilled in the art that one or more detectors 26 can be configured at each interrogation space 38, 40 and that the single detectors 26 may be configured to detect any of the characteristics of the emitted electromagnetic radiation listed above.

Once a particle is labeled to render it detectable (or if the particle possesses an intrinsic characteristic rendering it detectable), any suitable detection mechanism known in the art may be used without departing from the scope of the present invention, for example a CCD camera, a video input module camera, a Streak camera, a bolometer, a photodiode, a photodiode array, avalanche photodiodes, and photomultipliers producing sequential signals, and combinations thereof. In one embodiment, avalanche photodiodes are used for detecting photons. Different characteristics of the electromagnetic radiation may be detected including: emission wavelength, emission intensity, burst size, burst duration, fluorescence polarization, and any combination thereof.

4. Counting and Discrimination

The methods described herein allow particles to be enumerated as they pass through the interrogation spaces one at a time. The concentration of the sample can be determined from the number of particles counted and the volume of sample passing though the interrogation space in a set length of time. In the case where an interrogation space encompasses the entire cross-section of the sample stream, only the number of particles counted and the volume passing through a cross-section of the sample stream in a set length of time are needed to calculate the concentration the sample. When an interrogation space is smaller than the sample stream, the concentration of the particle can be determined by interpolating from a standard curve generated with a control sample of standard concentration. In another embodiment, the concentration of the particle can be determined by comparing the measured particles to an internal particle standard. Knowing the sample dilution, one can calculate the concentration of particles in the starting sample.

The analysis of data from detected particles includes cross-correlation. In one embodiment, photon signals are cross-correlated directly. In this case the fluorescent signals (photons) emitted by the sample which come from at least two interrogation spaces are detected by at least two detectors. The signals respectively detected in the detectors are divided into arbitrary time segments (bins) each having a pre-selected length of time (bin width). Although other bin widths may be used without departing from the scope of the present invention, in one embodiment the bin widths are selected in the range of about 10 μs to about 5 ms. The preferred bin width is 1 ms. The number of signals contained in each segment is established. For each time segment from the first detection unit, a cross-correlation analysis at a selected range of segments of the second detection unit is performed. At least one statistical analysis of the results of the cross-correlation analysis is performed, and/or the results are subjected to a threshold analysis. Said statistical analysis or at least one combination of several statistical analyses is evaluated for the presence of particles. In this way, a particle is discriminated from stochastic and background noise based on the presence of correlated signal(s) in at least two detector channels.

In one embodiment, the detected signal is first analyzed to determine the noise level and signals are selected above a threshold prior to cross-correlating the data. In one embodiment, the noise level is determined by averaging the signal over a large number of bins. In other embodiments, the background level is determined from the mean noise level, or the root-mean-square noise. In other cases, a typical noise value is chosen or a statistical value. In most cases, the noise is expected to follow a Poisson distribution.

A threshold value is determined to discriminate true signals (peaks, bumps, particles) from noise. Care must be taken in choosing a threshold value such that the number of false positive signals from random noise is minimized while the number of true signals which are rejected is minimized. Methods for choosing a threshold value include determining a fixed value above the noise level and calculating a threshold value based on the distribution of the noise signal. In one embodiment, the threshold is set at a fixed number of standard deviations above the background level. Assuming a Poisson distribution of the noise, using this method one can estimate the number of false positive signals over the time course of the experiment. Then cross-correlation analysis is performed on the signals identified from the two detectors.

The time-offset of the cross-correlated signals provides the transit time between the corresponding detectors and therefore based on the distance between the detectors, the velocity, e.g., electrophoretic velocity, of the particle is determined. In some cases, a particle is detected by the fact that the time off-set corresponds to a known time offset. In other cases, a particle is detected via unknown offset which is determined via population distribution.

In another embodiment, the cross-correlation analysis can be performed on data from more than two detectors, such as 3, 4, 5, 6, or more than 6 detectors that are distinct either in relative location of the interrogation space or in the wavelength detected. In this case, the cross-correlation analysis can be performed on data from any combination of detectors that are distinct. For example, in a case where three detectors, each detecting a distinct wavelength emission (R, G & B) are at each of two interrogation spaces, R1 is correlated with R2, G1 is correlated with G2 and B1 is correlated with B2, resulting in time offsets for particles with wavelength emission detected by the single detectors. Other combinations of cross-correlation analysis can also be performed, such as overlapping sets where R1 is correlated with G1; R1 is correlated with B1 and G1 is correlated with B1. Results of these cross-correlation analyses would indicate the frequency of double-labeled particles. Different combinations of cross-correlation analyses can be used with one another to distinguish particles based on velocity and labeling (color). In addition, using multiple pairs of cross-correlation analysis will result in more accurate determination of the properties of the single particles with in the mixture.

In another embodiment, analysis methods are employed wherein cross-correlation analysis is performed on data from detectors in any combinations of locations and/or wavelengths that are distinct. Thus, it will be recognized by one skilled in the art that multiple particles can be distinguished in a mixture by employing a combination of labels which can either alter the electromagnetic emission from the particles (such as dye tags) or the mobility of the particle (such as charge/mass or magnetic tags).

The methods described herein enable at least one particle to be distinguished singly in a sample comprising multiple particles. Multiple particles includes small particles, nucleic acids (e.g., single-stranded, double-stranded, DNA, RNA, and hybrids thereof), proteins (e.g., peptides, polypeptides and proteins), organic and inorganic molecules (e.g., metabolites, cytokines, hormones, neurotransmitters, products of chemical or biological reactions, and the like), and organisms (e.g., viruses and cells). In this regard, a sample comprising multiple particles can comprise multiple small particles, multiple particles of nucleic acids, multiple particles of proteins, multiple organic and/or inorganic molecules, and multiple cells and/or viruses or various combinations of the foregoing. Thus, any particle in a sample comprising (i) nucleic acids, small particles, organic/inorganic molecules, or proteins, (ii) nucleic acids and small particles, (iii) nucleic acids and proteins, (iv) proteins and small particles, (v) proteins and organic/inorganic molecules, (vi) nucleic acids and organic/inorganic molecules, or (vi) nucleic acids, small particles and proteins and combinations of the above with cells/viruses can be distinguished. The methods obviate the need to amplify the target particles in the sample.

In addition to the particles described above, are particles comprising complexes such as nucleic acids hybridized to labels, antibody-antigen complexes, ligand-receptor complexes, enzyme-substrate complexes, and protein-nucleic acid complexes which can be discriminated using these methods.

In some embodiments, an analyzer or analyzer systemt of the invention is capable of detecting an analyte, e.g., a biomarker at a level of less than 1 nanomolar, or 1 picomolar, or 1 femtomolar, or 1 attomolar, or 1 zeptomolar. In some embodiments, the analyzer or analyzer system is capable of detecting a change in concentration of the analyte, or of multiple analytes, e.g., a biomarker or biomarkers, from one sample to another sample of less than about 0.1, 1, 2, 5, 10, 20, 30, 40, 50, 60, or 80% when the biomarker is present at a concentration of less than 1 nanomolar, or 1 picomolar, or 1 femtomolar, or 1 attomolar, or 1 zeptomolar, in the samples, and when the size of each of the sample is less than about 100, 50, 40, 30, 20, 10, 5, 2, 1, 0.1, 0.01, 0.001, or 0.0001 ul. In some embodiments, the analyzer or analyzer system is capable of detecting a change in concentration of the analyte from a first sample to a second sample of less than about 20%, when the analyte is present at a concentration of less than about 1 picomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 100 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 50 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 5 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 5 femtomolar, and when the size of each of the samples is less than about 5 ul. In some embodiments, the analyzer or analyzer system is capable of detecting a change in concentration of the analyte from a first sample to a second sample of less than about 20%, when the analyte is present at a concentration of less than about 1 femtomolar, and when the size of each of the samples is less than about 5 ul.

C. Analyzer Systems

In addition to the single particle analyzers described herein, the invention also provides analyzer systems, which may include, in addition to a single particle analyzer, a sampling system, sample recovery system, sample preparation system, a computer for controlling parameters of analysis such as flow rates, etc., and/or a data analysis and reporting system that includes a computer and/or analyzing raw data and a reporting device for reporting the results of this analysis.

In some embodiments, the analyzer system includes a sampling system capable of automatically sampling a plurality of samples and providing a fluid communication between a sample container and a first interrogation space; and an analyzer capable of detecting a single molecule, where the analyzer includes (i) an electromagnetic radiation source for emitting electromagnetic radiation; (ii) said first interrogation space positioned to receive electromagnetic radiation emitted from the electromagnetic radiation source; and (iv) a first electromagnetic radiation detector operably connected to the first interrogation space to measure a first electromagnetic characteristic of the particle. In some embodiments, the analyzer further includes a second interrogation window, with the capability of detecting single particles, as described above.

1. Sampling System

In some embodiments, the analyzer system of the invention includes a sampling system for introducing an aliquot of a sample into the single particle analyzer for analysis. Any mechanism that can introduce a sample may be used. Samples can be drawn up using either vacuum from the pump or pressure applied to the sample that would push liquid into the tube, or by any other mechanism that serves to introduce the sample into the sampling tube. Generally, but not necessarily, the sampling system introduces a sample of known sample volume into the single particle analyzer; in some embodiments where the presence or absence of a particle or particles is detected, precise knowledge of sample size is not critical. In preferred embodiments the sampling system provides automated sampling for a single sample or a plurality of samples. In embodiments where a sample of known volume is introduced into the system, the sampling system provides a sample for analysis of more than about 0.0001, 0.001, 0.01, 0.1, 1, 2, 5, 10, 20, 30, 40, 50, 60, 70, 80, 90, 100, 150, 200, 500, 1000, 1500, or 2000 ul. In some embodiments the sampling system provides a sample for analysis of less than about 2000, 1000, 500, 200, 100, 90, 80, 70, 60, 50, 40, 30, 20, 10, 5, 2, 1, 0.1, 0.01, or 0.001 ul. In some embodiments the sampling system provides a sample for analysis of between about 0.01 and 1500 ul, or about 0.1 and 1000 ul, or about 1 and 500 ul, or about 1 and 100 ul, or about 1 and 50 ul, or about 1 and 20 ul. In some embodiments, the sampling system provides a sample for analysis between about 5 ul and 200 ul, or about 5 ul and about 100 ul, or about 5 ul and 50 ul. In some embodiments, the sampling system provides a sample for analysis between about 10 ul and 200 ul, or between about 10 ul and 100 ul, or between about 10 ul and 50 ul. In some embodiments, the sampling system provides a sample for analysis between about 0.5 ul and about 50 ul. In some embodiments, the sampling system provides a sample for analysis of about 1, 2, 3, 4, 5, 6, 7, 8, 9, 10, 15, 20, 25, 30, 35, 40, 45, 50, 60, 70, 80, 90,100, 150, 200, 500, 1000, or 2000 ul. In some embodiments, the sampling system provides a sample for analysis of about 50 ul. In some embodiments, the sampling system provides a sample for analysis of about 25 ul. In some embodiments, the sampling system provides a sample for analysis of about 10 ul. The sampling system may provide a sample size larger than that actually analyzed. For example, the sampling system may draw up about 25 ul, or about 20 ul, or about 15 ul, or about 10 ul, of sample, of which only about 1 to about 5 ul is analyzed.

In some embodiments, the sampling system provides a sample size that can be varied from sample to sample. In these embodiments, the sample size may be any one of the sample sizes described herein, and may be changed with every sample, or with sets of samples, as desired.

Sample volume accuracy, and sample to sample volume precision of the sampling system, are as required for the analysis at hand. In some embodiments, the precision of the sampling volume is determined by the pumps used, typically represented by a CV of less than about 50, 40, 30, 20, 10, 5, 4, 3, 2, 1, 0.5, 0.1, 0.05, or 0.01% of sample volume. In some embodiments, the sample to sample precision of the sampling system is represented by a CV of less than about 50, 40, 30, 20, 10, 5, 4, 3, 2, 1, 0.5, 0.1, 0.05, or 0.01%. In some embodiments, the intra-assay precision of the sampling system is represented by a CV of less than about 10, 5, 1, 0.5, or 0.1%. In some embodiments, the intra-assay precision of the sampling system shows a CV of less than about 5%. In some embodiments, the interassay precision of the sampling system is represented by a CV of less than about 10, 5, or 1%. In some embodiments, the interassay precision of the sampling system shows a CV of less than about 5%.

In some embodiments, the sampling system provides low sample carryover, advantageous in that an additional wash step is not required between samples. Thus, in some embodiments, sample carryover is less than about 1, 0.5, 0.1, 0.05, 0.04, 0.03, 0.02, 0.01, 0.005, or 0.001%. In some embodiments, sample carryover is less than about 0.02%. In some embodiments, sample carryover is less than about 0.01%.

In some embodiments the sampler provides a sample loop. In these embodiments, multiple samples are drawn into tubing sequentially and each is separated from the others by a “plug” of buffer. The samples typically are read one after the other with no flushing in between. Flushing is done once at the end of the loop. It is possible to recover each plug in, e.g., a separate well of a microtiter plate.

The sampling system may be adapted for use with standard assay equipment, for example, a 96-well microtiter plate, or, preferably, a 384-well plate. In some embodiments the system includes a 96 well plate positioner and a mechanism to dip the sample tube into and out of the wells, e.g., a mechanism providing movement along the X, Y, and Z axes. In some embodiments, the sampling system provides multiple sampling tubes; e.g., multiple tubes that “sip” from a row of 8 wells on a microtiter plate. In some embodiments, all samples from the multiple tubes are analyzed on one detector; in other embodiments, multiple single molecule detectors may be connected to the sample tubes. Samples may be prepared by steps that include operations performed on sample in the wells of the plate prior to sampling by the sampling system, or sample may be prepared within the analyzer system, or some combination of both.

2. Sample Recovery

One highly useful feature of embodiments of the analyzers and analysis systems of the invention is that the sample can be analyzed without consuming it. This can be especially important when sample materials are limited. Recovering the sample also allows one to do other analyses or reanalyze it. The advantages of this feature for applications where sample size is limited and/or where the ability to reanalyze the sample is desirable, e.g., forensic, drug screening, and clinical diagnostic applications, will be apparent to those of skill in the art.

Thus, in some embodiments, the analyzer system of the invention further provides a sample recovery system for sample recovery after analysis. In these embodiments, the system includes mechanisms and methods by which the sample is drawn into the analyzer, analyzed and then returned, e.g., by the same path, to the sample holder, e.g., the sample tube. Because no sample is destroyed and because it does not enter any of the valves or other tubing, it remains uncontaminated. In addition, because all the materials in the sample path are highly inert, e.g., PEEK, fused silica, or sapphire, there is little contamination from the sample path. The use of the stepper motor controlled pumps (particularly the analysis pump) allows precise control of the volumes drawn up and pushed back out. This allows complete or nearly complete recovery of the sample with little if any dilution by the flush buffer. Thus, in some embodiments, more than about 50%, 60%, 70%, 80%, 85%, 90%, 95%, 96%, 97%, 98%, 99%, 99.5%, or 99.9% of the sample is recovered after analysis. In some embodiments, the recovered sample is undiluted. In some embodiments, the recovered sample is diluted less than about 1.5-fold, 1.4-fold, 1.3-fold, 1.2-fold, 1.1-fold, 1.05-fold, 1.01-fold, 1.005-fold, or 1.001-fold.

For sampling and/or sample recovery, any mechanism for transporting a liquid sample from a sample vessel to the analyzer may be used. In some embodiments the inlet end of the analysis capillary has attached a short length of tubing, e.g., PEEK tubing that can be dipped into a sample container, e.g. a test tube or sample well, or can be held above a waste container. When flushing, to clean the previous sample from the apparatus, this tube is positioned above the waste container to catch the flush waste. When drawing a sample in, the tube is put into the sample well or test tube. Typically the sample is drawn in quickly, and then pushed out slowly while observing particles within the sample. Alternatively, in some embodiments, the sample is drawn in slowly during at least part of the draw-in cycle; the sample may be analyzed while being slowly drawn in. This can be followed by a quick return of the sample and a quick flush. In some embodiments, the sample may be analyzed both on the inward (draw-in) and outward (pull out) cycle, which improves counting statistics, e.g., of small and dilute samples, as well as confirming results, and the like. If it is desired to save the sample, it can be pushed back out into the same sample well it came from, or to another. If saving the sample is not desired, the tubing is positioned over the waste container.

3. Sample Preparation System

Sample preparation includes the steps necessary to prepare a raw sample for analysis. These steps can involve, by way of example, one or more of: separation steps such as centrifugation, filtration, distillation, chromatography; concentration, cell lysis, alteration of pH, addition of buffer, addition of diluents, addition of reagents, heating or cooling, addition of label, binding of label, cross-linking with illumination, separation of unbound label, inactivation and/or removal of interfering compounds and any other steps necessary for the sample to be prepared for analysis by the single particle analyzer. In some embodiments, blood is treated to separate plasma or serum. Additional labeling, removal of unbound label, and/or dilution steps may also be performed on the serum or plasma sample.

As is known in the art, sample preparation in which, e.g., a label is added to one or more particles may be performed in a homogeneous or heterogeneous format. In homogeneous systems, unbound label is not removed from the sample. In some embodiments, the particle or particles of interest are labeled by addition of labeled antibody or antibodies that binds to the particle or particles of interest. In heterogeneous systems, one or more steps are added for the removal of unbound label. In some embodiments, a separation step using, e.g., a capture antibody for immobilizing the particle of interest, is also used. Thus, in some embodiments, homogeneous preparation includes the following steps: 1) add sample suspected of containing particle of interest; 2) add detection (e.g., labeled) antibody. In some embodiments, heterogeneous preparation involves the following steps: 1) add capture antibody; 2) wash; 3) block; 4) add sample suspected of containing particle of interest; 5) wash; 6) add detection (e.g., labeled) antibody; 7) wash; 8) release bound molecules (may require neutralizing, depending on the method).

In some embodiments, the analyzer system includes a sample preparation system that performs some or all of the processes needed to provide a sample ready for analysis by the single particle analyzer. This system may perform any or all of the steps listed above for sample preparation. In some embodiments samples are partially processed by the sample preparation system of the analyzer system; thus, in some embodiments, a sample may be partially processed outside the analyzer system, e.g., by centrifugation, and partially processed inside the analyzer by a sample preparation system, e.g. for labeling the sample, mixing with buffer, and the like. In some embodiments, a blood sample is processed outside the analyzer system to provide a serum or plasma sample, which is introduced into the analyzer system and further processed by a sample preparation system to label the particle or particles of interest and, optionally, to remove unbound label.

In some embodiments the analyzer system provides a sample preparation system that provides complete preparation of the sample to be analyzed on the system, such as complete preparation of a blood sample, a saliva sample, a urine sample, a cerebrospinal fluid sample, a lymph sample, a BAL sample, a biopsy sample, a forensic sample, a bioterrorism sample, and the like. In some embodiments the analyzer system provides a sample preparation system that provides some or all of the sample preparation. In some embodiments, the initial sample is a blood sample that is further processed by the analyzer system. In some embodiments, the sample is a serum or plasma sample that is further processed by the analyzer system. The serum or plasma sample may be further processed by, e.g., contacting with a label that binds to a particle or particles of interest; the sample may then be used with or without removal of unbound label.

In some embodiments, sample preparation is performed, either outside the analysis system or in the sample preparation component of the analysis system, on one or more microtiter plates, such as a 96-well plate. Reservoirs of reagents, buffers, and the like can be in intermittent fluid communication with the wells of the plate by means of tubing or other appropriate structures, as are well-known in the art. Samples may be prepared separately in 96 well plates or tubes. Sample isolation, label binding and, if necessary, label separation steps may be done on one plate. In some embodiments, prepared particles are then released from the plate and samples are moved into tubes for sampling into the sample analysis system. In some embodiments, all steps of the preparation of the sample are done on one plate and the analysis system acquires sample directly from the plate. Although this embodiment is described in terms of a 96-well plate, it will be appreciated that any vessel for containing one or more samples and suitable for preparation of sample may be used. For example, standard microtiter plates of 384 or 1536 wells may be used. More generally, in some embodiments, the sample preparation system is capable of holding and preparing more than about 5, 10, 20, 30, 40, 50, 60, 70, 80, 90, 100, 200, 300, 500, 1000, 5000, or 10,000 samples. In some embodiments, multiple samples may be sampled for analysis in multiple analyzer systems. Thus, in some embodiments, 2 samples, or more than about 2, 3, 4, 5, 7, 10, 15 20, 50, or 100 samples are sampled from the sample preparation system and run in parallel on multiple sample analyzer systems.

Microfluidics systems may also be used for sample preparation and as sample preparation systems that are part of analyzer systems, especially for samples suspected of containing concentrations of particles high enough that detection requires smaller samples. Principles and techniques of microfluidic manipulation are known in the art. See, e.g., U.S. Pat. Nos. 4,979,824; 5,770,029; 5,755,942; 5,746,901; 5,681,751; 5,658,413; 5,653,939; 5,653,859; 5,645,702; 5,605,662; 5,571,410; 5,543,838; 5,480,614, 5,716,825; 5,603,351; 5,858,195; 5,863,801; 5,955,028; 5,989,402; 6,041,515; 6,071,478; 6355,420; 6,495,104; 6,386,219; 6,606,609; 6,802,342;6, 749,734; 6,623,613; 6,554,744; 6,361,671; 6,143,152; 6,132,580; 5,274,240; 6,689,323; 6,783,992; 6,537,437; 6,599,436; 6,811,668 and published PCT patent application No. WO9955461(A1). Samples may be prepared in series or in parallel, for use in a single or multiple analyzer systems.

Preferably, the sample comprises a buffer. The buffer may be mixed with the sample outside the analyzer system, or it may be provided by the sample preparation mechanism. While any suitable buffer can be used, the preferable buffer has low fluorescence background, is inert to the detectably labeled particle, can maintain the working pH and, in embodiments wherein the motive force is electrokinetic, has suitable ionic strength for electrophoresis. The buffer concentration can be any suitable concentration, such as in the range from about 1 to about 200 mM. Any buffer system may be used as long as it provides for solubility, function, and delectability of the molecules of interest. Preferably, for application using pumping, the buffer is selected from the group consisting of phosphate, glycine, acetate, citrate, acidulate, carbonate/bicarbonate, imidazole, triethanolamine, glycine amide, borate, MES, Bis-Tris, ADA, aces, PIPES, MOPSO, Bis-Tris Propane, BES, MOPS, TES, HEPES, DIPSO, MOBS, TAPSO, Trizma, HEPPSO, POPSO, TEA, EPPS, Tricine, Gly-Gly, Bicine, HEPBS, TAPS, AMPD, TABS, AMPSO, CHES, CAPSO, AMP, CAPS, and CABS. An especially preferred buffer is pH 7.4 phosphate buffered saline with 0.1% Tween 20, but imidazole buffered saline, borate buffered saline, and tris buffered saline are also acceptable. Preferably, the buffer is selected from the group consisting of Gly-Gly, bicine, tricine, 2-morpholine ethanesulfonic acid (MES), 4-morpholine propanesulfonic acid (MOPS) and 2-amino-2-methyl-1-propanol hydrochloride (AMP). An especially preferred buffer is 2 mM Tris/borate at pH 8.1, but Tris/glycine and Tris/HCl are also acceptable.

Preferably, for applications using electrophoresis, the buffer is selected from the group consisting of Gly-Gly, bicine, tricine, 2-morpholine ethanesulfonic acid (MES), 4-morpholine propanesulfonic acid (MOPS) and 2-amino-2-methyl-1-propanol hydrochloride (AMP). An especially preferred buffer is 2 mM Trislborate at pH 8.1, but Tris/glycine and Tris/HCl are also acceptable. Zwitterions may be included in electrophoretic samples at concentrations up to 2M. This does not increase the current of the electrophoretic system, but acts to minimize interactions with the capillary surface.

For some applications, the buffer desirably further comprises a sieving matrix for use in the embodiment of the method. While any suitable sieving matrix can be used, desirably the sieving matrix has low fluorescence background and can specifically provide size-dependent retardation of the detectably labeled particle. The sieving matrix can be present in any suitable concentration (e.g., from about 0.1% to about 10%). Any suitable molecular weight can be used (e.g., from about 100,000 to about 10 million). Examples of sieving matrixes include poly(ethylene oxide) (PEO), poly(vinylpyrrolidine) (PVP), linear polyacrylamide and derivatives (LPA), hydroxymethyl propylcellulose (HPMC) and hydroxyethylcellulose (HEC), all of which are soluble in water and have exceptionally low viscosity in dilute concentration (0.3% wt/vol). In addition, these polymer solutions are above their entanglement threshold and are easy to prepare, filter and fill into, capillaries. Addition of 0.2% LPA (5,000,000-6,000,000 mw) to a Tris/borate buffer enabled discrimination of IgG and a 1.1 kb nucleic acid fragment during a one minute electrophoretic separation (see, e.g., Example 7a below).

In some cases, a measurable electromagnetic characteristic is produced by an intrinsic property of the target particle. In other cases, particles of interest may be labeled with a detectable label prior to detection with the analyzer. The detectable label can be, for example, a luminescent label, or a light scattering label. In one embodiment, the detectable label is a luminescent label. Although other luminescent labels may be used without departing from the scope of the present invention, useful luminescent labels include fluorescent labels, chemiluminescent labels, and bioluminescent labels, among others. In addition, fluorescent quenching can also be monitored. Additionally, other light scattering labels may be used without departing from the scope of the present invention. Useful light scattering labels include metals, such as gold, silver, platinum, selenium and titanium oxide, among others.

In order to be detected, particles must produce, or be made capable of producing electromagnetic radiation. The electromagnetic radiation is either an intrinsic property of the particle or an extrinsic property of the particle. Examples of intrinsic properties can include fluorescence and light scattering, but a particle may possess more than one intrinsic property rendering it detectable. Extrinsic properties are those that are provided by a label when it is attached to the particle. Labels are applied before, after, or simultaneously with positioning the particle into an interrogation space 38, 40.

Preferably, the means of detection is a fluorescent label. Examples of fluorescent labels can be found in the HANDBOOK OF FLUORESCENT PROBES AND RESEARCH PRODUCTS (R. Haugland, 9th Ed., Molecular Probes Pub. (2004)). A detectable label may also be produced by any combination of intrinsic and extrinsic properties of the particle.

Methods for labeling the particle are well known by those of ordinary skill in the art. Attaching labels to particles can employ any known method including attaching directly or using binding partners. In some cases, the method of labeling is non-specific. For example, methods are known that label all nucleic acids regardless of their specific nucleotide sequence. In other cases, the labeling is specific, as in where a labeled oligonucleotide binds specifically to a target nucleic acid sequence.

Labels of the present invention include dye tags, charge tags, mass tags, Quantum Dots, or beads, magnetic tags, light scattering tags, polymeric dyes, and dyes attached to polymers. Dyes include a very large category of compounds that add color to materials or enable generation of luminescent or fluorescent light. A dye may absorb light or emit light at specific wavelengths. A dye may be intercalating, or be noncovalently or covalently bound to a particle. Dyes themselves may constitute probes as in probes that detect minor groove structures, cruciforms, loops or other conformational elements of particles. Dyes may include BODIPY and ALEXA dyes, Cy[n] dyes, SYBR dyes, ethidium bromide and related dyes, acridine orange, dimeric cyanine dyes such as TOTO, YOYO, BOBO, TOPRO POPRO, and POPO and their derivatives, bis-benzimide, OliGreen, PicoGreen and related dyes, cyanine dyes, fluorescein, LDS 751, DAPI, AMCA, Cascade Blue, CL-NERF, Dansyl, Dialkylaminocoumarin, 4′,5′-Dichloro-2′,7′-dimethoxyfluorescein, 2′,7′-Dichlorofluorescein, DM-NERF, Eosin, Erythrosin, Fluoroscein, Hydroxycourmarin, Isosulfan blue, Lissamine rhodamine B, Malachite green, Methoxycoumarin, Naphthofluorescein, NBD, Oregon Green, PyMPO, Pyrene, Rhodamine, Rhodol Green, 2′,4′,5′,7′-Tetrabromosulfonefluorescein, Tetramethylrhodamine, Texas Red, X-rhodamine, Dyomic dye series, Atto-tec dye series, Coumarins, phycobilliproteins (phycoerythrins, phycocyanins, allophycocyanins), green, yellow, red and other fluorescent proteins, up-converting phosphors, and Quantum Dots. Those skilled in the art will recognize other dyes which may be used within the scope of the invention. This is not an exhaustive list, and acceptable dyes include all dyes now known or known in the future which could be used to allow detection of the labeled particle of the invention. By having fluorescent markers, such as fluorescent particles, fluorescent conjugated antibodies, or the like, the sample may be irradiated with light that is absorbed by the fluorescent particles and the emitted light measured by light measuring devices.

Light scattering tags which may be used in the present invention include metals such as gold, silver, selenium and titanium oxide. Those of skill in the art will recognize other microspheres or beads can also be used as light scattering tags. In yet another embodiment of the present invention, the labels affect the electrophoretic velocity and/or separation of target particles of identical or different sizes that cannot be separated electrophoretically. Such labels are referred to as charge/mass tags. The attachment of a charge/mass tag alters the ratio of charge to translational frictional drag of the target particles in a manner and to a degree sufficient to affect their electrophoretic mobility and separation.

In another embodiment, the label alters the charge, or the mass, or a combination of charge and mass. The charge/mass tag bound to a particle can be discriminated from the unbound particle or unbound tag by virtue of spatial differences in their behavior in an electric field or by virtue of velocity differences in their behavior in an electric field.

Polysaccharide coated paramagnetic microspheres or nanospheres may be used to label particles. U.S. Pat. No. 4,452,773 issued to Molday, incorporated herein by reference in its entirety, describes the preparation of magnetic iron-dextran beads and provides a summary describing the various methods of preparing particles suitable for attachment to biological materials. A description of polymeric coatings for magnetic particles used in high gradient magnetic separation methods are found in German Patent No. 3720844 and U.S. Pat. No. 5,385,707 issued to Miltenyi, both incorporated herein by reference in their entireties. Methods to prepare paramagnetic beads are described in U.S. Pat. No. 4,770,183.

The exact method for attaching the bead to the particle is not critical to the practice of the invention, and a number of alternatives are known in the art. The attachment is generally through interaction of the particle with a specific binding partner which is conjugated to the coating on the bead and provides a functional group for the interaction. Antibodies are examples of binding partners. Antibodies may be coupled to one member of a high affinity binding system, e.g., biotin, and the particles attached to the other member, e.g., avidin. Secondary antibodies that recognize species-specific epitopes of the primary antibodies, e.g., anti-mouse Ig, and anti-rat Ig, may also be used in the present invention. Indirect coupling methods allow the use of a single magnetically coupled entity, e.g., antibody, avidin, etc., with a variety of particles.

In one application of this technique, described by Cohen (Cohen et al. (1988) PNAS 85:9660-3), the target particle may be coupled to a magnetic tag and suspended in a fluid within a chamber (not shown). In the presence of a magnetic field supplied across the chamber, the magnetically labeled target is retained in the chamber. Materials which do not have magnetic labels pass through the chamber. The retained materials can then be eluted by changing the strength of, or by eliminating, the magnetic field. The chamber across which the magnetic field is applied is often provided with a matrix of a material of suitable magnetic susceptibility to induce a high magnetic field locally in the chamber in volumes close to the surface of the matrix. This permits the retention of fairly weakly magnetized particles and the approach is referred to as high gradient magnetic separation.

In another embodiment of the invention, the extrinsic properties that render the particle detectable are provided by at least two labels. For example, the target particle is labeled with two or more labels and each label is distinct due to detected emission at one or more wavelengths that is distinguishable from the emission of the other label(s). In this example, the particle is distinguished from free label by the ratio of detected emission at two or more wavelengths. In another example, the particle is labeled with two or more labels and at least two of the labels emit at the same wavelength. In this example, particles are distinguished on the basis of the intensity of the detected fluorescence produced by emission from the two, three, or more labels attached to each particle.

In another embodiment, the dyes have the same or overlapping excitation spectra, but possess distinguishable emission spectra. Preferably dyes are chosen such that they possess substantially different emission spectra, preferably having emission maxima separated by greater than about 10 nm, more preferably having emission maxima separated by greater than about 25 nm, even more preferably separated by greater than about 50 nm. When it is desirable to differentiate between the two dyes using instrumental methods, a variety of filters and diffraction gratings allow the respective emission spectra to be independently detected. Instrumental discrimination can also be enhanced by selecting dyes with narrow bandwidths rather than broad bandwidths; however, such dyes must necessarily possess a high amplitude emission or be present in sufficient concentration that the loss of integrated signal strength is not detrimental to signal detection.

In one example, the second label may quench the fluorescence of the first label, resulting in a loss of fluorescent signal for doubly labeled particles. Examples of suitable fluorescencing/quenching pairs include 5′ 6-FAMTM/3′ Dabcyl, 5′ Oregon Green® 488-X NHS Ester/3′ Dabcyl, 5′ Texas Red®-X NHS Ester/3′ BlackHole QuencherTM-1 (Integrated DNA Technologies, Coralville, Iowa).

In another example, two labels may be used for fluorescence resonance energy transfer (“FRET”), which is a distance-dependent interaction between the excited states of two dye particles. In this case, excitation is transferred from the donor to the acceptor particle without emission of a photon from the donor. The donor and acceptor particles must be in close proximity (e.g., within about to about 100 Å). Suitable donor, acceptor pairs include fluorescein/tetramethylrhodamine, LAEDANS/fluorescein, EDANS/dabcyl, fluorescein/ QSY7, (R. Haugland, “Molecular Probes,” Ninth edition, 2004) and many others known to one skilled in the art.

Particles may be labeled with more than one kind of label, such as a dye tag and a mass tag, to facilitate detection and/or discrimination. For example, a protein may be labeled with two antibodies, one that is unlabeled and acts as a mass or mass/charge tag, and another that has a dye tag. That protein might then be distinguished from another protein of similar size that is bound only to an antibody with a dye tag by its slower velocity when, e.g., electrophoresis is used as the motive force (caused by the increased mass or mass/charge of the additional bound antibody).

To accurately detect a labeled particle, the labeled particle must be distinguished from unbound label. Many ways to accomplish this are familiar to those skilled in the art. For example, in heterogeneous assays, an unbound label is separated from labeled particles prior to analysis. In one embodiment, the assay is a homogenous assay, and the sample, including unbound label, is analyzed by a combination of electrophoresis and single particle fluorescence detection. In this case, electrophoretic conditions are chosen which provide distinct velocities for the labeled particle and the unbound label.

Non-specific labeling of nucleic acids generally labels all nucleic acids regardless of the particular nucleotide sequence. One skilled in the art is familiar with various techniques for general labeling of nucleic acids. Such methods include: intercalating dyes such as TOTO, ethidium bromide, and propidium iodide, ULYSIS kits for formation of coordination complexes, ARES kits for incorporation of a chemically reactive nucleotide analog to which a label can be readily attached, and incorporation of a biotin containing nucleotide analog for attachment of a streptavidin bound label. Enzymatic incorporation of labeled nucleotide analogs is another approach well known to one skilled in the art.

Techniques to non-specifically label proteins are also well known to one skilled in the art. Several chemically reactive amino acids on the surface of proteins can be used, for example, primary amines such a lysine. In addition, labels can be added to carbohydrate moieties on proteins. Isotype specific reagents have also been developed for labeling antibodies, such as Zenon labeling (Haugland, 2004).

In one embodiment, only specific particles within a mixture are labeled. Specific labeling can be accomplished by combining the target particle with a labeled binding partner, where the binding partner interacts specifically with the target particle through complementary binding surfaces. Binding forces between the partners can be covalent interactions or non-covalent interactions such as hydrophobic, hydrophilic, ionic and hydrogen bonding, van der Waals attraction, or coordination complex formation. Examples of binding partners are agonists and antagonists for cell membrane receptors, toxins and venoms, antibodies and viral epitopes, hormones (e.g., opioid peptides, steroids, etc.) and hormone receptors, enzymes and enzyme substrates, cofactors and target sequences, drugs and drug targets, oligonucleotides and nucleic acids, proteins and monoclonal antibodies, antigen and specific antibody, polynucleotide and complementary polynucleotide, polynucleotide and polynucleotide binding protein; biotin and avidin or streptavidin, enzyme and enzyme cofactor; and lectin and specific carbohydrate. Illustrative receptors that can act as a binding partner include naturally occurring receptors, e.g., thyroxine binding globulin, lectins, various proteins found on the surface of cells (cluster of differentiation or CD particles), and the like. CD molecules denote known and unknown proteins on the surface of eukaryotic cells, e.g., CD4 is the molecule that primarily defines helper T lymphocytes.

In one embodiment, a sample is reacted with beads or microspheres that are coated with a binding partner that reacts with the target particle. The beads are separated from any non-bound components of the sample, and the beads containing bound particles are detected by the analyzer of the invention. Fluorescently stained beads are particularly well suited for these methods. For example, fluorescent beads coated with oligomeric sequences will specifically bind to target complementary sequences, and after the appropriate separation steps, allow for detection of the target sequence.

In one embodiment, a method for detecting particles uses a sandwich assay with monoclonal antibodies as binding partners. The primary antibody is linked to a surface to serve as capture antibody. The sample would then be added and particles having the epitope recognized by the antibody would bind to the antibody on the surface. Unbound particles are washed away leaving substantially only specifically bound particles. The bound particle/antibody can then be reacted with a detection antibody containing a detectable label. After incubating to allow reaction between the detection antibodies and particles, non-specifically bound detection antibodies are washed away. The particle and detection antibody can be released from the surface and detected in the analyzer of the invention. Alternatively, only the detection antibody can be released and detected, thereby indirectly detecting the particle. Alternatively, only the label bound to the detection antibody can be released and detected, thereby indirectly detecting the particle.

One variation would be to employ a ligand recognized by a cell receptor. In this embodiment, the ligand is bound to the surface to capture the cells that express the specific receptor, and a labeled ligand is used to label the cells. The receptor could be a surface immunoglobulin. In this way the presence of the specifically bound cells could be determined. Therefore, having the ligand of interest complementary to the receptor bound to the surface, cells having the specific immunoglobulin for such ligand could be detected. In another embodiment, one could have antibodies to the ligand bound to the surface to non-covalently attach the ligand to the surface.

4. Data Collection, Analysis, and Reporting

Data, consisting of signals detected from the particles, are cross-correlated using, for example, a personal computer (not shown in FIG. 1) with standard or custom software to generate, e.g., a histogram of velocities that shows a peak for every fluorescent species present in the sample. In embodiments where an electric field is applied to the sample, the transit time of each particle between the detectors is dependent upon the characteristic charge, size and shape of the particle. A computer may also be used to operate the analyzer, e.g., to control flow rates, operate sampling, sample recovery, sample preparation, and the like.

The system may also include a data reporter for reporting the data and/or results of analysis. Any means known to those of skill in the art may be used for this purpose. The raw data (e.g., number of particles, cross-correlation data, wavelength of fluorescence, intensity of fluorescence, and the like) may be further analyzed by appropriate software before reporting, to indicate probable identity of particles in the sample, concentration, combinations of particles detected, levels of detected particles compared to normal, abnormal, or specific levels associated with specific conditions, possible diagnoses based on the presence, absence, and/or concentration of one or more particles, possible sources of particles detected, and any other analysis that may be performed on the data before reporting. Any mechanism that provides an appropriate report may be used as a data reporter. Non-exclusive examples of data reporters include display on a video monitor, printout, transmission of data for remote display or printout, e.g., over the Internet, voice report, and the like.

II. Methods

In another aspect the invention provides methods of analysis that include performing an analysis on a sample obtained from an individual using a detection system with at least two interrogation spaces capable of detecting single molecules where the analysis includes determining the presence or absence of a particle in the sample. In some embodiments the individual is a plant or animal; in some embodiments the individual is a mammal, and in some embodiments the individual is a human. The detection system may be any of those described herein. In some embodiments, the detection system may utilize a CW laser as a source of electromagnetic radiation. In some embodiments the detection system has two interrogation spaces, e.g., where each has a volume between about 0.02 pL and about 300 pL, or between about 0.02 pL and 50 pL or between about 0.1 to about 25 pL. In some embodiments, more than two interrogation spaces are used. In some embodiments, 3, 4, 5, 6, or more than 6 interrogation spaces are used. Other embodiments of detectors with two interrogation spaces, as described herein, may be used in embodiments of the methods of the invention.

In some embodiments, the sample is analyzed for a plurality of different particles (multiplexing). In some embodiments, a plurality of samples from a plurality of individuals is analyzed. In other embodiments, a sample from a plurality of individuals is analyzed.

The invention also provides a method of analysis that includes determining a diagnosis, prognosis, state of a treatment (e.g., monitoring the progress and/or effect of a treatment), and/or method of treatment based on the presence, absence, and/or concentration of a particle in a sample taken from an individual, where the presence, absence, and/or concentration of the particle is determined using a single particle detector with two interrogation spaces. “Diagnosis,” as used herein, includes use of the results of tests to screen an individual to determine predisposition to a disease or pathology, or the presence and/or severity of a disease or pathology, and includes determination of a lack of predisposition or presence of the disease or pathology. In some embodiments, the analysis includes determining the presence, absence, and/or concentration of a plurality of types of particles in the sample(s). These methods may further include reporting the diagnosis, prognosis, state of a treatment, monitoring and/or determination of treatment to the individual from whom the sample was obtained, and/or their representative (e.g., health care provider). The single particle detector may be any of the embodiments described herein, including analyzers and analyzer systems. The detection system may utilize a CW laser as a source of electromagnetic radiation. In some embodiments the two interrogation spaces each have a volume between about 0.02 pL and about 300 pL, or between about 0.02 pL and 50 pL or between about 0.1 to about 25 pL. In some embodiments, more than two interrogation spaces are used. In some embodiments, 3, 4, 5, 6, or more than 6 interrogation spaces are used.

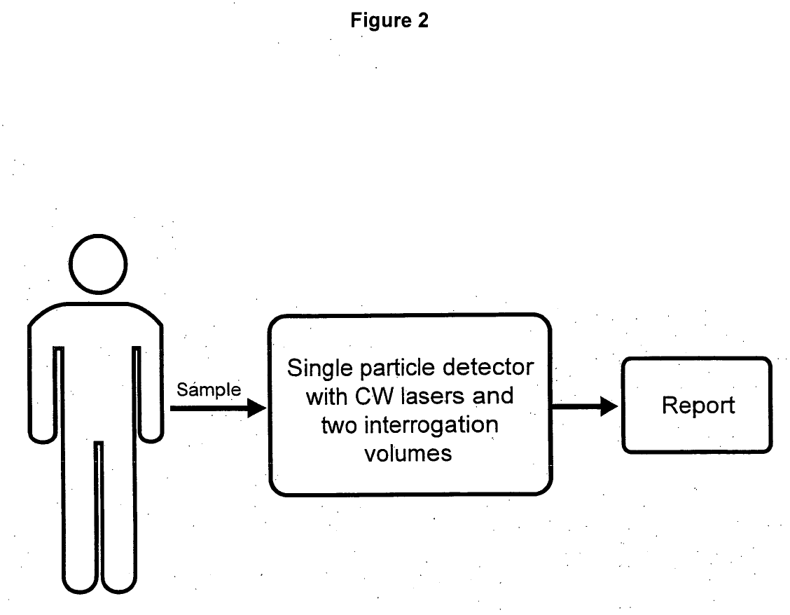

FIG. 2 provides an illustration of one embodiment of the methods of the invention. A sample from an individual (e.g., a human) is analyzed using a detection system with two interrogation spaces capable of detecting single molecules (in some embodiments utilizing CW laser as a source of EM radiation) and results of the analysis are obtained. In some embodiments, the results may be in terms of presence, absence, and/or concentration of a particle or particles of interest; in some embodiments, the results have been further analyzed to provide a diagnosis, prognosis, determination of treatment efficacy, determination of type of treatment, and the like. In some embodiments, the report is communicated to the individual or their representative.

The invention also provides methods of data analysis by computer analysis of a database. The database contains results of analysis of a sample or samples performed using a single particle detector with at least two interrogation spaces where the analysis includes determining the presence, absence, and/or concentration of a particle in the sample. In some embodiments, the analysis includes determining the presence, absence, and/or concentration of a plurality of types of particles in the sample(s). The samples may be obtained from any of the sources described herein. In some embodiments, the samples are obtained in biomedical research, such as in clinical trials or pre-clinical trial research, or basic research. The single particle detector may be any of the embodiments described herein. The detection system may utilize a CW laser as a source of electromagnetic radiation. In some embodiments the two interrogation spaces each have a volume between about 0.02 pL and about 300 pL, or between about 0.02 pL and 50 pL or between about 0.1 to about 25 pL. In some embodiments, more than two interrogation spaces are used. In some embodiments, 3, 4, 5, 6, or more than 6 interrogation spaces are used.

In some aspects, the invention provides a computer-readable storage medium, such as a CD, containing a set of instructions for a general purpose computer having a user interface comprising a display unit, e.g., a video display monitor or a printing unit, where the set of instructions includes logic for inputting values from analysis of a sample with a single particle detector with two interrogation spaces; optionally, a comparison routine for comparing the inputted values with a database; and a display routine for displaying the results of the input values and/or comparison routine with said display unit. In another embodiment of this aspect, the invention provides an electronic signal or carrier wave that is propagated over the Internet between computers containing a set of instructions for a general purpose computer having a user interface comprising a display unit, e.g., a video display monitor or a printing unit, where the set of instructions includes logic for inputting values from analysis of a sample with a detection system capable of detecting single molecules and comprising two interrogation spaces; a comparison routine for comparing the inputted values with a database; and a display routine for displaying the results of the comparison routine with said display unit.

Because of the detection system's sensitivity and robustness, a large number of samples may be analyzed with a high degree of accuracy and precision regarding presence, absence, and/or concentration of one or more particles of interest in a short period. The methods of the invention are useful in, for example, determining the results of research, e.g., biomedical research, including, but not limited to, pre-clinical and clinical trials, in a rapid, robust, and sensitive manner. The methods of the invention are also usefuil in, e.g., clinical diagnosis, prognosis, monitoring, and determination of methods of treatment. In these embodiments the method may further include the step of reporting the results of the analysis, or the diagnosis, prognosis, monitoring or treatment determined from the results of the analysis, to the individual from whom the sample was taken or their representative.

An “individual” may be any source of a sample, typically a biological sample. In embodiments, the individual is an organism, preferably an animal, more preferably a mammal, and most preferably a human. Animals include farm animals, sport animals, pet animals, research animals and humans. In some embodiments, the individual is a human, and in some embodiments the human is a patient who is suspected of having a pathological condition, e.g., infectious or non-infectious disease, or who is subject to screening for one or more conditions. In some embodiments the individual is screened for a genetic predisposition to a condition and/or for expression of proteins or other markers associated with genetic variations or abnormalities. In some embodiments the individual is a human suspected of having a viral or microbial infection. In some embodiments the individual is a plant or other organism. In some embodiments, the individual is a non-living entity.

In some embodiments, the methods of the invention encompass analyzing a sample taken from an individual. In some embodiments, the step of taking the sample from the individual is included in the method. In some cases, e.g., in research applications, an entire individual, e.g., an entire organism or group of organisms (for example, a bacterial colony), may comprise the sample. In other cases, and more typically, the sample is a portion of the individual taken from the individual. Samples may be any of those described previously herein. Thus, for example, the sample may be a biological fluid, e.g., blood, serum, plasma, bronchoalveolar lavage fluid, urine, cerebrospinal fluid, pleural fluid, synovial fluid, peritoneal fluid, amniotic fluid, gastric fluid, lymph fluid, interstitial fluid, tissue homogenate, cell extracts, saliva, sputum, stool, physiological secretions, tears, mucus, sweat, milk, semen, seminal fluid, vaginal secretions, fluid from ulcers and other surface eruptions, blisters, and abscesses, and extracts of tissues including biopsies of normal, malignant, and suspect tissues or any other constituents of the body which may contain the particle of interest. In some embodiments, the sample is a blood sample. In some embodiments, the sample is a plasma sample. In some embodiments, the sample is a serum sample.

Particles within the sample whose presence, absence, and/or concentration are detected are also as described herein. Any type of particle described herein may be detected by methods of the invention, and may be used for the purposes heretofore described as well as purposes described in more detail below. In some embodiments, the particle(s) is/are molecules, supramolecular complexes, organelles, organisms, cells, and any combination thereof. In some embodiments, one or more of the particles is an organism, e.g., viruses, bacteria, fungal cells, animal cells, plant cells, eukaryotic cells, prokaryotic cells, archeobacter cells, and any combination thereof. In some embodiments, the organism is a virus, e.g., Herpes viruses, Poxviruses, Togaviruses, Flaviviruses, Picomaviruses, Orthomyxoviruses, Paramyxoviruses, Rhabdoviruses, Corona viruses, Arenaviruses, and Retroviruses. In some embodiments, the particle is a bacterium, e.g., Escherichia coli, Pseudomonas aeruginosa, Enterobacter cloacae, Staphylococcus aureus, Enterococcusfaecalis, Klebsiella pneumoniae, Salmonella typhimurium, Staphylococcus epidermidis, Serratia marcescens, Mycobacterium bovis, methicillin resistant Staphylococcus aureus and Proteus vulgaris. In some embodiments, one or more of the particles is a molecule selected from the group consisting of amino acids, peptides, proteins, nucleotides, oligonucleotides, nucleic acids, DNA, RNA, monosaccharides, disaccharides, oligosaccharides, carbohydrates, lipids, hormones, cytokines, chemokines, lymphokines, venoms, toxins, naturally occurring drugs, synthetic drugs, pollutants, allergens, affecter particles, growth factors, metabolic intermediates, substrates, pharmacophores, inorganic molecules, organic molecules, and any combination thereof.

In some embodiments, the sample is treated before introduction into the detection system. In some embodiments, the sample is introduced into the detection system without treatment; in these embodiments, the sample may be capable of detection without further treatment, or the sample may be treated within the detection system prior to analysis in the system. Treatment, either before or after introduction, may be as described elsewhere herein.

In some embodiments, sample treatment includes labeling a particle with a fluorescently-labeled antibody that is specific to the particle. In some embodiments, a plurality of particles in a single sample is labeled with a plurality of fluorescently-labeled antibodies, each of which is specific for a specific type of particle of interest. In some embodiments, the particle that is labeled is a biomarker. Biomarkers include, but are not limited to, markers for inflammation, microbial infection, pathological conditions, expression markers, developmental markers, and the like. In some embodiments, the particle whose presence, absence, and/or concentration is to be detected is a marker for microbial infection. An example of a marker for microbial infection can be Triggering Receptor Expressed on Myeloid cells (TREM-1), a marker found in body fluids that indicates infection by bacteria or fungi, and the sample is treated prior to introduction or after introduction with a fluorescently-labeled anti-TREM antibody.

The analyzers and analyzer systems of the invention are particularly well-suited to multiplexing, i.e., detection of more than one type of particle in a sample. A sample can be multiplexed by methods including 1) dividing the sample into multiple samples, each of which is analyzed for one or more types of particles; 2) using different labels for different particles, e.g., different label colors, numbers, intensities, and the like, for different particles; or 3) utilizing different mobility of different particles, e.g., in electrophoresis. In some embodiments, a plurality of types of particles is analyzed in a single sample. The number of types ofparticles in a single sample maybe more than 1, 2, 3, 4, 5,6, 7, 8, 9, 10, 11, 12, 13, 14, 15, 16, 17, 18, 19, 20, 25, 30, 40, 50, 75, or 100. The number of types of particles may be less than 200, 100, 50, 40, 30, 20, 19, 18, 17, 16, 15, 14, 13, 12, 11, 10, 9, 8, 7, 6, 5, 4, or 3. In some embodiments, the number of types of particles is about 2 to about 20, or about 2 to about 5, or about 2 to about 10, or about 10 to about 20.

Methods for distinguishing types of particles from each other are as described herein. In particular, methods may use a combination label signal intensity (e.g., different numbers of label on different particles), label identity (e.g., different labels on different particles), and label mobility (e.g., different mobility for different particles) when motive force is electrokinetic), or combinations thereof.

Methods of the invention include the detection of the presence, absence, and/or concentration of a plurality of types of particles that have a common association, or that provide desired information, i.e., a “panel,” in a sample. A “panel,” as used herein, encompasses a group of particles whose presence may be detected by an assay of the invention. The particles may have intrinsic characteristics that allow their detection by the system of the invention, or may require labeling in order to be detected. Thus, the methods of the invention can include contacting samples with an appropriate plurality of labels for the detection of the presence, absence, and/or concentration of one or more members of a panel of particles. Such panels of particles are useful in, e.g., bioterrorism sample analysis, medical examination, diagnosis, prognosis, monitoring and/or treatment selection; biomedical research, forensics, agricultural analysis, and industrial applications. For example, panels may be associated with a particular type of diagnosis, e.g., panels of infectious organisms, panels of markers for disease such as cardiovascular disease, cancer or specific types of cancer, diabetes, arthritis, Alzheimer's disease, etc., or to assess functioning of various systems, e.g., endocrine panels, panels may be associated with bioterrorism, e.g., panels of likely bioterrorism organisms or toxins; panels may be useful in medical screening, e.g., panels of proteins associated with particular genetic polymorphisms or mutations associated with specific disease or pathological conditions, or associated with. normal or supranormal conditions; panels may be associated with prognosis, e.g., panels of markers associated with particular type of cancer may be used to determine the recurrence and/or progression of a cancer after treatment to eradicate part or all of the cancer. Panels are also useful in screening of blood samples and may include a number of infectious agents and/or antibodies for which the blood is to be screened. Similarly, a single sample may be analyzed in the methods of the invention to detect any of a number of substances of abuse, environmental substances, or substances of veterinary importance. An advantage of the invention is that it allows one to assemble a panel of tests that may be run on an individual suspected of having a syndrome to simultaneously detect a causative agent for the syndrome. Other areas where panels are useful include in research.

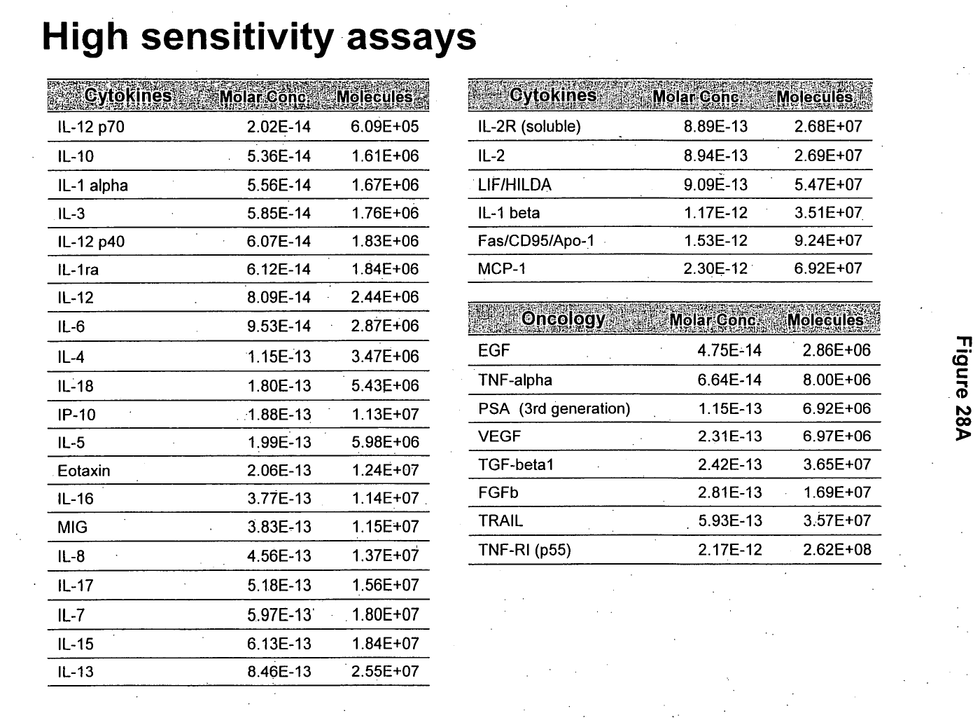

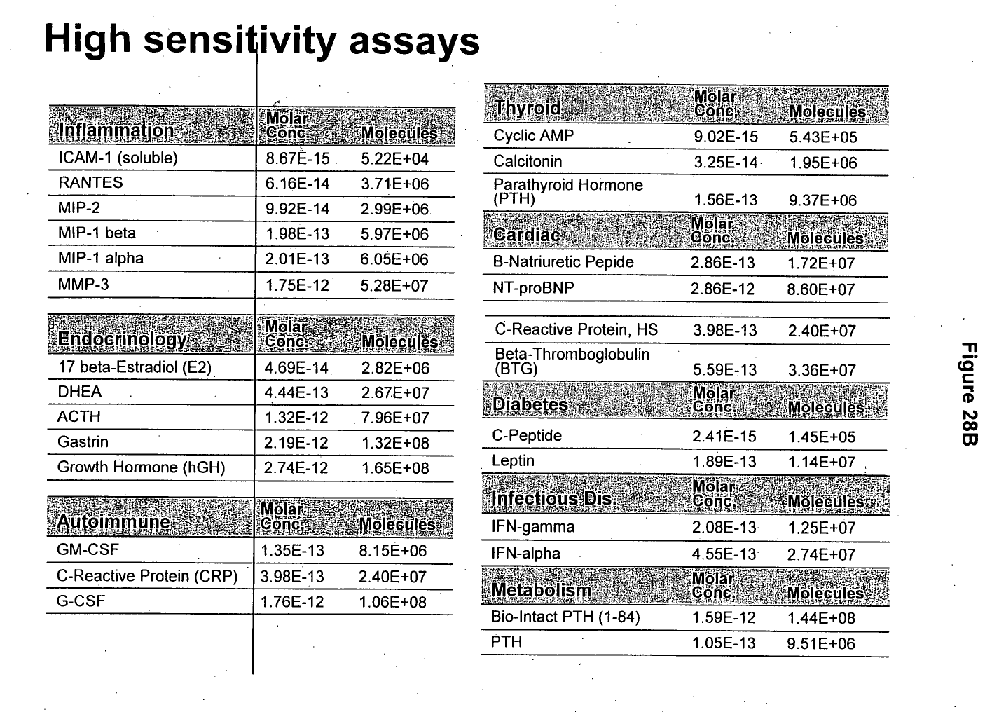

Exemplary groups of markers that may be used in panels for various types of uses are shown in FIG. 28, and described below.

Panels for bioterrorism sample analysis may include one or more of the more than thirty pathogens and toxins on various agency threat lists, as known to those of skill in the art. Public health personnel rarely see most of the pathogens in suspect samples, so they have difficulty identifying them quickly. In addition, many pathogenic infections are not immediately symptomatic in infected subjects, having delayed onset of symptoms as long as several days, limiting options to control the disease and to treat the subjects. The lack of a practical monitoring network capable of rapidly detecting and identifying multiple pathogens or toxins on current threat lists translates into a major deficiency in the ability to counter biological terrorism.

Biothreat agent sensors that operate in “Detect to Protect/Warn” programs are preferably 1) capable of detecting biothreat agents within a 1-2 hour time window, allowing enough time to respond to an event, 2) extremely low cost to maintain, allowing for continuous monitoring when needed, and 3) have sufficient selectivity to virtually eliminate false positives. The U.S. Bio-Watch program involves the Department of Energy, the Environmental Protection Agency (EPA), and the U.S. Department of Health and Human Services' Centers for Disease Control and Prevention. Eventually, this program will have the capability of detecting a biological attack in more than 120 U.S. cities and reporting the attack within twenty-four hours.

The Bio-Watch program utilizes the Autonomous Pathogen Detection System (“APDS”), a file-cabinet-sized machine that samples air, runs tests, and reports the results. APDS integrates a flow cytometer and real-time PCR-amplified detector with sample collection, sample preparation, and fluidics to provide a compact, autonomously operating instrument capable of simultaneously detecting multiple pathogens and/or toxins. The system is designed for fixed locations, where it continuously monitors air samples and automatically reports the presence of specific biological agents. APDS is targeted for subway systems, transportation terminals, large office complexes, and convention centers and provides the ability to measure up to 100 different agents and controls in a single sample. The latest evolution of the biodetector, APDS-II, uses bead-capture immunoassays and a compact flow cytometer for the simultaneous identification of multiple biological simulants. The present invention is not limited by the same requirements as the APDS system and can more quickly, cheaply and accurately provide the same detection.

In addition, the present invention has many other applications in medicine, medical examination, diagnosis, prognosis, monitoring and/or treatment selection; and in biomedical research. In some embodiments, the invention can be used for detecting controlled drugs and substances, therapeutic dosage monitoring, health status, donor matching for transplantation purposes, pregnancy (e.g., through detection of Human Chorionic Gondaotropin or alpha-fetoprotein), and detection of disease, e.g., endotoxins, cancer antigens, pathogens, and the like.

In some embodiments, the present invention may be adapted by those of skill in the.art to detect chemical and biological compounds and therapeutic drugs which may include, but are not limited to, anti-autoimmune deficiency syndrome substances, anti-cancer substances, antibiotics, anti-viral substances, enzymes, enzyme substrates, enzyme inhibitors, neurotoxins, opioids, hypnotics, antihistamines, tranquilizers, anti-convulsants, muscle relaxants and anti-Parkinson substances, anti-spasmodic and muscle contractants, miotics and anti-cholinergics, immunosuppressants (e.g., cyclosporine) anti-glaucoma solutes, anti-parasite and/or anti-protozoal solutes, anti-hypertensives, analgesics, anti-pyretics and anti-inflammatory agents (such as Non-Steroidal Antiinflammatory Drugs), local anesthetics, ophthalmics, prostaglandins, anti-depressants, anti-psychotic substances, anti-emetics, imaging agents, specific targeting agents, neurotransmitters, proteins and cell response modifiers. Proteins are also of interest in a wide variety of therapeutics and diagnostics, such as detecting cell populations, blood type, pathogens, immune responses to pathogens, immune complexes, saccharides, lectins, naturally occurring receptors, and the like.

In some embodiments, panels of markers for clinical diagnostics, e.g., of infectious disease or of inflammation, are used. Samples may be labeled, for example, to detect, in a single sample, antigens or antibodies associated with any of a number of infectious agents including, without limitation, bacteria, viruses, fungi, mycoplasma, rickettsia, chlamydia, prions, and protozoa; to assay for autoantibodies associated with autoimmune disease, to assay for agents of sexually transmitted disease, or to assay for analytes associated with pulmonary disorders, gastrointestinal disorders, cardiovascular disorders, neurological disorders, musculoskeletal disorders, dermatological disorders, and the like. Panels for clinical diagnostics may include other markers for the presence of conditions associated with a particular disease or pathological state, e.g., markers for inflammation.

For example, for the diagnosis of sepsis, various combinations of the following diagnostic markers may be used: inflammation biomarker TREM-1; inflammation biomarker IL-6 and IL-8; inflammation biomarker IL-10 and IL-12, and optionally IL-18; a fungal infection biomarker; one or more pathogen markers for E. coli, e.g., for multiple specific strains; one or more pathogen markers for Staphylococcus aureous, e.g., for multiple specific strains; one or more pathogen markers for Candida albicans, e.g., for multiple specific strains; one or more pathogen markers for Enterobacter, e.g., for multiple specific strains; as well as other clinical markers and, optionally, negative controls.

In some embodiments, clinical diagnosis may be based on only one marker, e.g., on TREM-1 for determination of the presence or absence of sepsis, or, for lung samples, the presence or absence of pneumonia (e.g., with ventilator patients). The diagnosis may be performed using a plasma, serum or BAL sample. Diagnosis may be based on comparison of the value obtained from the analyzed sample to values for normal and abnormal (e.g., diseased) populations.

In some embodiments, a panel of markers for diagnosis for community-acquired pneumonia may be used which is combinations of any or all of: inflammation biomarker TREM-1; inflammation biomarker IL-6 and IL-8; inflammation biomarker IL-10 and IL-12, and optionally IL-18; viral infection biomarker SAA; one or more pathogen markers for Streptococcus pneumoniae, e.g., for multiple specific strains; one or more pathogen markers for Respiratory Syncytial Virus, e.g., for multiple specific strains; one or more pathogen markers for Haemophilus, e.g., for multiple specific strains; one or more pathogen markers for Mycoplasma, e.g., for multiple specific strains; as well as other clinical markers and, optionally, negative controls. Panels for, e.g., bacterial pathogens will be apparent to those of skill in the art; see, e.g., Dunbar et al. 2003. J Microbiol Methods 53:245-52.

Detection and diagnosis of infectious diseases often requires testing for multiple antibodies; accordingly, specific antibodies may also be assessed using panels for the detection of combinations of, e.g., Adenovirus, Bordetella pertussis, Campylobacterjejuni, Chlamydia pneumoniae, Chlamydia trachomatis, Cholera Toxin, Cholera Toxin b, Clostridium piliforme (Tyzzer's), Cytomegalovirus, Diphtheria Toxin, Ectromelia virus, EDIM (Epidemic diarrhea of infant mice), Encephalitozoon cuniculi, Epstein-Barr EA, Epstein-Barr NA, Epstein-Barr VCA, HBV Core, HBV Envelope, HBV Surface (Ad), HBV Surface (Ay), HCV Core, HCV NS3, HCV NS4, HCV NS5, Helicobacter pylori, Hepatitis A, Hepatitis D, HEV orf2 3KD, HEV orf2 6KD, HEV orf3 3KD, HIV-1 gp120, HIV-1 gp41, HIV-1 p24, HPV, HSV-1 gD, HSV-1/2, HSV-2 gG, HTLV-1/2, Influenza A, Influenza A H3N2, Influenza B, Leishmania donovani, Lyme disease, Lymphocytic choriomeningitis virus, M. pneumoniae, M. tuberculosis, Minute virus, Mumps, Mycoplasma pulmonis, Parainfluenza 1, Parainfluenza 2, Parainfluenza 3, Parvovirus, Pneumonia virus of mice, Polio Virus, Polyoma virus, Reovirus-3, RSV, Rubella, Rubeola, Sendai virus, T. cruzi, T. pallidum 15kd, T. pallidum p47, Tetanus Toxin, Theiler's mouse encephalomyelitis virus, Toxoplasma, and Varicella zoster.

Isotyping panels are useful for detection, characterization, and the like of antibody immunodeficiency disorders, such as multiple myeloma, HIV infection, solid organ tumors, or chronic liver disease. Such panels are also useful for researchers seeking to measure overall levels of certain isotypes in particular diseases or disease, such as various IgG deficiencies related to responder/nonresponder status, increased or unusual allergies, autoimmune diseases, GI disorders, malignancies, chest symptoms, or recurrent bacterial infections. Panels may include combinations of, for example, IgA, IgE, IgGI, IgG2alpha, IgG2beta, IgG3, IgM, and light chain (kappa or gamma).

To detect phospho-transferase activity of multiple different protein kinases, useful to clinicians and researchers, a panel of substrate proteins may be mixed with ATP, followed by contact with, e.g., different color-coded antibodies, followed by, e.g., a biotinylated reporter antibody and a streptavidin-phycoerythrin conjugate. Each reaction may then be detected by its unique label. Panels may include combinations of, e.g., Akt, Akt/PKB (total), Akt/PKBpS473, ATF2 (Thr71), Erk-2, Erk1 (Thr202/Tyr204), Erk1/Erk2 (Thr202/Tyr204), Erk2 (Thr202/Tyr204), GSK-3beta, IkappaB-alpha pS32, IkappaB-alpha Total, JNK (pTpY183/185), JNK Total, JNKp (Thr183/Y182), MAPKAP K2, p38 (total), p38 MAPK pT180/pY182, p53 (total), p53 pS15, PKB-alpha, PKC, SAPK1, SAPK1a/JNK2, SAPK4, STAT1 pY701, STAT1 Total, STAT3 (Tyr705), and ZAP-70. The system can detect modified proteins, e.g., proteins phosphorylated by modification with specific antibodies. The system can detect one or more modifications of one or more types of individual molecules.

To detect normal and disease states involving tissue remodeling, such as cancer, panels of the Matrix Metalloproteinase (MMP) family of enzymes are useful, and may include MMP-1, MMP-12, MMP-13, MMP-2, MMP-3, MMP-7, MMP-8, and MMP-9.

Other panels include panels of cancer biomarkers, e.g., combinations of alpha-fetoprotein, PSA, cancer antigen 125, and carcinoembryonic antigen; cardiac markers, e.g., combinations of creatine kinase-MB, endothelin 1, PAP, SGOT, and TIMP-1; and markers for Alzheimer's disease.

Panels of allergens, e.g., multi-analyte allergy-testing applications, may use, e.g. different allergens, which serve as targets for allergen-specific antibodies; a second label molecule completes the reaction, using anti-human-IgE. Exemplary allergens for such panels include Altemaria (Mold), Bermuda Grass, Cat Dander, Egg White, Milk, Mite Ptemoyssinus, Mountain Cedar, Short Ragweed, Timothy Grass, and Wheat (food). Similar procedures may be used to detect, e.g., autoimmune antibodies, using antigens such as ASCA, beta-2 Microglobulin, Centromere B, Chromatin, ENA Profile 4 (SSA, SSB, Sm, RNP), ENA Profile 5 (SSA, SSB, Sm, RNP, Scl-70), ENA Profile 6 (SSA, SSB, Sm, RNP, Scl-70, Jo-1), Histone, Histone H1, Histone H2A, Histone H2B, Histone H3, Histone H4, HSP-27 pS82, HSP-27 Total, HSP-32, HSP-65, HSP-71, HSP-90 a, HSP-90 b, Jo-1, PCNA, PR3, PR3 (cANCA), Ribosomal P, RNP, RNP-A, RNP-C, SCF, Scl-70, Serum Amyloid P, SLE Profile 8 (SSA, SSB, Sm, RNP, Scl-70, Jo-1, Ribosome-P, chromatin), Sm, Smith, SSA, SSB, Streptolysin 0, and TPO.

Still other panels may be used to assay for angiogenesis (e.g., human angiogenesis), and may include, by way of example, combinations of IL-8, bFGF, VEGF, angiogenin, and TNF. Other panels may be used to assay for cell activation (e.g., human cell activation), and may include, by way of example, combinations of IL-8, βFGF, VEGF, angiogenin, and TNF; panels for B cell activation (e.g., human B cell activation), may include, by way of example, combinations of CD79b(Igβ), BLNK, Btk, Syk, and PLCγ, panels for T cell activation (e.g., human T cell activation), may include, by way of example, combinations of TCRz, SLP-76, ZAP-70, Pyk2, Itk, and PLCγ.

Panels for markers of inflammation, e.g., human inflammation, may include, e.g., combinations of Il-8, IL-1β IL6, IL10, TNF, and IL-12p70, as well as other cytokines or biomarkers that will be apparent to those of skill in the art. Panels for chemokines (e.g., human chemokines), may include, by way of example, combinations of IL-8, RANTES, KC (mouse), monokine-induced by interferon-γ, monocyte-chemoattractant protein-1, macrophage inflammatory protein 1-α, macrophage inflammatory protein 1-β, and interferon-γ-induced protein 10. Panels for apoptosis (e.g., human apoptosis), may include, by way of example, combinations of cleaved PARP, Bcl-2, and active caspase-3 protein. Panels for human anaphylotoxins may include, by way of example, combinations of anaphylotoxins C4a, 3a, and 5a. Panels for allergy mediators (e.g., human allergy mediators), may include, by way of example, combinations of IL-3, IL-4, IL-5, IL-7, IL-9 (mouse), IL-10, IL-13 (mouse), eotaxin (CCL11) granulocyte colony stimulating factor, and granulocyte macrophage colony-stimulating factor.

For both research and diagnostics, cytokines are useful as markers of a number of conditions, diseases, pathologies, and the like, and may be included in several different panels. There are currently over 100 cytokines/chemokines whose coordinate or discordant regulation is of clinical interest. In order to correlate a specific disease process with changes in cytokine levels, the ideal approach requires analyzing each sample for multiple cytokines. Exemplary cytokines that are presently used in marker panels and that may be used in panels used in methods and compositions of the invention include, but are not limited to, BDNF, CREB pS133, CREB Total, DR-5, EGF,ENA-78, Eotaxin, Fatty Acid Binding Protein, FGF-basic, G-CSF, GCP-2,GM-CSF, GRO-KC, HGF, ICAM-1, IFN-alpha, IFN-gamma, IL-10, IL-11, IL-12, IL-12 p40, IL-12 p40/p70, IL-12 p70, IL-13, IL-15, IL-16, IL-17, IL-18, IL-1alpha, IL-1beta, IL-1ra, IL-1ra/IL-IF3, IL-2, IL-3, IL-4, IL-5, IL-6, IL-7, IL-8, IL-9, IP-10, JE/MCP-1, KC, KC/GROa, LIF, Lymphotacin, M-CSF, MCP-1, MCP-1(MCAF), MCP-3, MCP-5, MDC, MIG, MIP-1 alpha, MIP-1 beta, MIP-1 gamma, MIP-2, MIP-3 beta, OSM, PDGF-BB, RANTES, Rb (pT821), Rb (total), Rb pSpT249/252, Tau (pS214), Tau (pS396), Tau (total), Tissue Factor, TNF-alpha, TNF-beta, TNF-RI, TNF-RII, VCAM-1, VEGF.

Panels may also be established for endocrine markers, e.g., for diabetes or thyroid markers, useful in the clinical laboratory or for the life-science researcher. Exemplary endocrine markers include Adiponectin, Amylin, C-Peptide, Calcitonin, CRF, FGF-9, GLP-1, Glucagon, Growth Hormone, Insulin, Leptin, Lipoprotein (a), Resistin, T3, T4, TBG, Thyroglobulin, and TSH. Metabolic markers are also useful for research or clinical applications, and may include Apolipoprotein A-1, Apolipoprotein A-I, Apolipoprotein A-II, Apolipoprotein B, Apolipoprotein C-II, Apolipoprotein C-III, Apolipoprotein E, beta-2 Glycoprotein, Collagen Type 1, Collagen Type 2, Collagen Type 4, Collagen Type 6, Glutathione S-Transferase, Pancreatic Islet Cells, and tTG (Celiac Disease).

Clinical laboratories and researchers often require simultaneous interrogation of multiple nucleic-acid sequences, e.g., for tissue typing by detecting multiple alleles of interest; suitable panels may include combinations of HLA Class I and II, HLA Class I Single Antigen Antibody, Group 1, HLA Class I Single Antigen Antibody, Group 2, PRA Class I, PRA Class I and II, PRA Class II, SSO Class I HLA-A, SSO Class I HLA-B, SSO Class I HLA-C, SSO Class II DP, SSO Class II DQB1, SSO Class II DRB1, and SSO Class II DRB3,4,5.

A pregnancy panel may comprise, e.g., tests for human chorionic gonadotropin, hepatitis B surface antigen, rubella virus, alpha fetoprotein, 3′ estradiol, and other substances of interest, in a pregnant individual.

It will be appreciated that the sensitivity of the analyzers of the invention allow the design and implementation of markers and panels of markers not hitherto possible, in order to determine, not only simple yes/no answers as to the presence of abnormal levels of markers for, e.g., tumors or genetic abnormalities, but much more refined analysis, such as earlier determination of the onset of a condition, and more precise comparison between normal ranges of markers and the levels found in an individual. Present assay methods often allow the detection of a marker only when the underlying pathological condition to which it corresponds has reached a stage where treatment is unlikely to be effective or only marginally effective. For example, present levels of detection for many cancers allow detection only at levels where the cancer is far advanced. The methods of the invention allow not only earlier detection, but also establishment of baseline levels for normal individuals for those markers that are present in normal individuals but for which abnormally high or low levels indicate the presence of pathology

Accordingly, the present invention encompasses methods of early detection of disease or pathology, based on the detection and/or quantitation of one or more biomarkers. Typically, the concentration of a biomarker in a sample, e.g., a blood, plasma, or serum sample, from an individual, e.g., a human, is compared with values that are considered normal or abnormal. The analyzers and analyzer systems of the invention may be used to determine levels of biomarkers for both normal and diseased populations that are far lower than those presently used in detection and diagnosis, e.g., levels that are 0.1, 0.01, 0.001, or 0.0001× the levels presently quantifiable. Thus, a database may be created for normal and abnormal levels for a given condition, and individuals may be screened and the condition detected much earlier than has heretofore been possible. Alternatively, databases may already exist for normal and abnormal values but present methods may not be practical for screening individuals on a routine basis to determine with sufficient sensitivity whether the value of the individual for the marker is within the normal range. For example, most present methods for the determination of IL-6 concentration in a sample are capable of detecting IL-6 only down to a concentration of about 5 pg/ml; the normal range of IL-6 values is about 1 to about 10 pg/ml; hence, present methods are able to detect IL-6 only in the upper part of normal ranges. In contrast, the analyzers and analyzer systems of the invention allow the detection of IL-6 down to a concentration below about 0.1 pg/ml, or less than one-tenth of normal range values. Thus, the analyzers and analyzer systems of the invention allow a far broader and more nuanced database to be produced for a biomarker, e.g., for IL-6, and also allow screening for that biomarker both within and outside of the normal range, allowing earlier detection

Such early detection methods of the invention may be used for the detection of any disease or condition for which one or more biomarkers exist or may be found that correlate with onset or progression of the condition, and for which a database of values may be obtained

As one example, diagnosis of cancers often depends on the use of crude measurements of tumor growth, such as visualization of the tumor itself, that are either inaccurate or that must reach high levels before they become detectable, e.g., in a practical clinical setting by present methods. At the point of detection, the tumor has often grown to sufficient size that intervention is unlikely to occur before metastasis. For example, detection of lung cancer by X-ray requires a tumor of >1 cm in diameter, and by CT scan of >2-3 mm. Alternatively, a biomarker of tumor growth may be used, but, again, often the tumor is well-advanced by the time the biomarker is detectable at levels accessible to current clinical technology. Furthermore, after intervention (e.g., surgery, chemotherapy, or radiation to shrink or remove the tumor or tumors), it is often not possible to measure the tumor marker with sufficient sensitivity to determine if there has been a recurrence of the cancer until residual disease has progressed to the point where further intervention is unlikely to be successful. Using the analyzers, systems, and methods of the present invention, it is possible to both detect onset of tumor growth and return of tumor growth at a point where intervention is more likely to be successful, e.g., due to lower probability of metastasis.

Hence, the present invention provides 1) methods of screening for biomarkers that heretofore have been present at levels too low to be useful for diagnosis or monitoring of disease; 2) methods of screening for onset of disease based on the detection of biomarkers, either discovered in 1) or presently known, at levels far lower than is now possible; and 3) methods for monitoring the course of treatment or the usefulness of experimental treatments, with far greater ability to detect effects, including recurrence of disease, than is presently possible

These include a method for testing an individual for the presence, absence, likelihood of developing, or degree of progression of a condition. The condition may be pathological or non-pathological (e.g., aging, pregnancy). Exemplary pathological conditions include general pathological conditions, such as inflammation, which is linked to a number of specific pathological conditions such as diabetes, heart disease, arthritis, cancer, and the like. Pathological conditions also include more specific conditions, including, but not limited to, cancers, inflammatory conditions and/or autoimmune diseases, cardiovascular disease, gastrointestinal disease, skin disease, neurological disorders, genetic disorders, infectious diseases, aging, allergies, and the like. Cancers include, but are not limited to, cancer of the lung, stomach, pancreas, esophagus, ovary, breast, prostate, bladder, colon, and rectum. The method includes analyzing a sample from an individual for one or more markers of the condition using an analyzer or analyzer system of the invention, where the analyzer or analyzer system is capable of detecting the marker or markers at a level of less than 1 nanomolar, or 1 picomolar, or 1 femtomolar, or 1 attomolar, or 1 zeptomolar. In some embodiments, the analyzer or analyzer system is capable of detecting a change in concentration of the marker or markers from one sample to another sample of less than about 0.1, 1, 2, 5, 10, 20, 30, 40, 50, 60, or 80% when the biomarker is present at a concentration of less than 1 nanomolar, or 1 picomolar, or 1 femtomolar, or 1 attomolar, or 1 zeptomolar, and when the size of the sample is less than about 100, 50, 40, 30, 20, 10, 5, 2, 1, 0.1, 0.01, 0.001, or 0.0001 ul. In some embodiments, the analyzer or analyzer system is capable of detecting a change in concentration of the analyte from a first sample to a second sample of less than about 20%, when the analyte is present at a concentration of less than about 1 picomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 100 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 50 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 5 femtomolar, and when the size of each of the samples is less than about 50 ul. In some embodiments, the analyzer or analyzer system is capable of detecting a change in concentration of the analyte from a first sample to a second sample of less than about 20%, when the analyte is present at a concentration of less than about 5 femtomolar, and when the size of each of the samples is less than about 5 ul. In some embodiments, the analyzer or analyzer system is capable of detecting a change in concentration of the analyte from a first sample to a second sample of less than about 20%, when the analyte is present at a concentration of less than about 1 femtomolar, and when the size of each of the samples is less than about 5 ul. The method can further include comparing the value obtained in the analysis with known values for the biomarker to determine presence, absence, or degree of progress of the condition; further, the method can include informing the individual of the results of the comparison, or determining a course of treatment, prognosis, or diagnosis based on said comparison. In some embodiments, the method includes analyzing multiple samples from an individual, often taken over a course of time, and determining the degree of change and/or rate of change of the concentration of the marker or markers for the particular condition being tested, and comparing the degree and/or rate of change with normal and/or abnormal values. It will be appreciated that combinations of absolute values and rates of change, etc., may also be used in increasing levels of sophistication in determining the presence, absence, or progress of a condition.

In one example, the invention provides a method for screening for the presence, absence, or progress of lung cancer in an individual. In some embodiments, the individual may be a person at high risk for lung cancer; such individuals include individuals exposed to lung carcinogens through, e.g., smoking or through occupational exposure such as exposure to asbestos, as well as individuals over about 50, 55, 60, 65, 70, 75, or 80 years of age, or individuals who have undergone treatment for pre-existing lung cancer or other cancers. The individual can be asymptomatic. The invention includes analyzing a sputum, BAL, blood, serum, or plasma sample from the individual for one or more markers of lung cancer and/or one or more particular types of lung cancer, e.g., small cell carcinoma, using an analyzer capable of detecting the marker or markers at a level of 1 nanomolar, or 1 picomolar, or 1 femtomolar, or 1 attomolar, or 1 zeptomolar. In some embodiments, the detection level is less than 1 picomolar. In some embodiments, the analyzer or analyzer system is capable of detecting a change in concentration of the marker or markers from one sample to another sample of less than about 0.1, 1, 2, 5, 10, 20, 30, 40, 50, 60, or 80% when the biomarker is present at a concentration of less than 1 nanomolar, or 1 picomolar, or 1 femtomolar, or 1 attomolar, or 1 zeptomolar, and when the size of the sample is less than about 100, 50, 40, 30, 20, 10, 5, 2, 1, 0.1, 0.01, 0.001, or 0.0001 ul. In some embodiments, the analyzer or analyzer system is capable of detecting a change in concentration of less than 20% in a set of samples of less than 5 ul when the biomarker is present at a concentration of less than 1 picomolar. The method can further include comparing the value obtained in the analysis with known values for the biomarker to determine presence, absence, or degree of progression of lung cancer in the individual; further, the method can include informing the individual of the results of the comparison, or determining a course of treatment, prognosis, or diagnosis based on said comparison. In some embodiments, the method encompasses comparing values for levels of the biomarker(s) obtained from the same individual over time to one another and determining a diagnosis, prognosis, degree of likelihood, or degree of progress for lung cancer, as described above.

In addition, the methods of the invention allow the discovery and use of panels of biomarkers with increased sensitivity to determine, e.g., results of treatment and/or outcome of testing of treatments. For example, in cancer treatment involving methods to reduce or eliminate cancerous tissue, it is useful to know if and when the cancer is returning, and at what rate. The sensitivity of the present methods allows such information to be available at a much earlier stage of return and at a much higher level of precision, thus allowing action to be taken at an earlier stage in the return of the disease. The same is true, of course, for screening of the onset of disease in previously normal individuals.

Furthermore, it will be appreciated that the sensitivity and multiplexing of the analyzers and methods of the invention allow the use of the methods of the invention for a variety of types of clinical, research, as well as agricultural and industrial applications. Thus, panels of biomarkers may be designed for repetitive assays such as are used in screening and other research applications. Because the sensitivity of analysis is greater than heretofore used in biomedical research on a large scale, it is possible to detect changes in markers at much lower levels than heretofore has been possible, as well as to discover and use new biomarkers. In some embodiments new biomarkers, not previously used, may be used in biomarker panels, or previously used biomarkers used at less sensitive levels, may be used in panels of the invention.

Accordingly, in some embodiments, the methods of the invention include analyzing a sample from an individual in a single particle detector with two interrogation spaces, where at least 1, 2, 3, 4, 5, 6, 7, 8, 9, 10, 15, 20, 30, 40, 50, 100, or more than 100 types of particles can be detected, if present, in a single sample with a sensitivity of less than 1 nM, 1 pM, 100 fM, 10 fM, 5 fM, 4 fM, 3 fM, 2 fM, 1 fM, 0.5 fM, 0.1 fM or, 0.01 fM, 0.001 fM, 0.0001 fM, 0.00001 fM, or 0.000001 fM. Each individual type of particle may have a different level of detection.

Because the methods of the invention provide increased sensitivity and the ability to multiplex samples, the size of the sample required in the methods can be correspondingly reduced. In some embodiments of the invention wherein the sample is a biological fluid, e.g., a body fluid (for example, serum), the sample size can be less than 1000, 500, 200, 100, 75, 50, 40, 30, 20, 10, 5, 4, 3, 2, 1, 0.1, 0.01, 0.001, or 0.0001 ul. The number of different types of particles that may be analyzed on such a sample may be 1, or more than 1, 2, 3, 4, 5, 6, 7, 8, 9, 10, 15, 20, 30, 40, 50, 100, or more than 100. In some embodiments, the sample size is about 1 ul to about 500 ul, or about 10 ul to about 200 ul, or about 10 ul to about 100 ul, or about 10 ul to about 50 ul, or about 50 ul, and the number of particle types analyzed is about 1 to about 50, or about 1 to about 20, or about 1 to about 10.

In some embodiments, the analysis of a sample occurs within a certain time period. In some cases, the analysis is performed within about one day, or within about 12, 8, 4, 2, 1, 0.5, 0.4, 0.3, 0.2, 0.1, 0.05, 0.01, or less than 0.01 hour. In embodiments, the invention provides methods of analyzing a plurality of samples using a single particle detector with two interrogation spaces, wherein on average each sample is analyzed in less than 1 hour, or less than 0.5 hour, or less than 0.2 hour, or less than 0.1 hour, or less than 5, 4, 3, 2, 1, 0.5 or 0.1 minute. In one embodiment, the invention provides a method for analyzing clinical samples using a single particle detector with two interrogation spaces, wherein on average each sample is analyzed in less than 1, or less than 0.5, or less than 0.1 hour.

In one embodiment, the invention provides a method of determining whether or not an individual is suffering from a disease, comprising analyzing a sample from the individual for the presence, absence, or concentration of biomarkers using a single particle detector with two interrogation spaces, wherein the analysis of the sample is performed in less than 2 hours, or 1 hour, or 0.5 hour, or 0.25 hour, 0.1, or 0.01 hour. The method may also include obtaining the sample from the individual and/or reporting the results of the analysis to the individual. In one embodiment, the invention provides methods comprising reporting to an individual from whom a sample was taken or their representative, the results of an analysis comprising analyzing a sample from the individual for the presence, absence, or concentration of TREM-1 using single particle detector with two interrogation spaces, wherein the analysis of the sample is performed in less than 1 hour.

In some embodiments, the detection of the presence, absence, and/or concentration of the particle(s) is reported to the individual from whom the sample was taken, or to a health professional caring for the individual from whom the sample was taken. In some embodiments, a diagnosis, prognosis, monitoring, and/or suggested course of treatment, based on the presence, absence, and/or concentration of the particle(s) is made. In some embodiments, the diagnosis, prognosis, monitoring and/or suggested course of treatment is reported to the individual from whom the sample was taken, their representative or to a health professional caring for the individual from whom the sample was taken.

It will be appreciated that the methods of the invention also provide the ability to provide individuals, such as researchers or health professionals, with information with which to evaluate research or clinical or pre-clinical trials. For example, the availability of genetic information and association of disease with mutation(s) of critical genes has generated a rich field of research and clinical analysis. Both genetic information (i.e., analysis of nucleic acids to determine genetic variability) and proteomic information (i.e., analysis of actual proteins to determine expression of genetic variability) are useful in both research and clinical settings. In general, methods of research or diagnosis based on information about mutation of critical genes have required the use of the polymerase chain reaction (PCR) and its variants. The sensitivity of the present methods allow detection of mutational events, either from nucleic acid, or protein, or both, without the necessity of amplification of the nucleic acid. Furthermore, changes in the presence, absence, and/or concentrations of a number of proteins, whose expression is associated with a particular genetic configuration and/or pathological condition may be readily detected by the methods of the invention, allowing rapid and sensitive screening of, e.g., the effects of agents being tested for an effect on a pathological condition. A number of different markers, e.g. proteins, may be simultaneously detected, and/or quantitated in a single sample.

Additional industrial and environmental applications of the present invention include manufacturing process control, environmental monitoring and food safety. For example, samples from an environmental source such as soil, water, or air; or from an industrial source such as a waste stream, a water source, a supply line, or a production lot can be analyzed for contamination. Examples of likely contaminants include pesticides, petroleum products, industrial fallout, and organisms. Many of the same contaminants are a concern in the food supply, but especially organisms such as fungi in grain and bacteria in meat, game, produce, or dairy products. Industrial applications include quality control of fermentation media, such as from a biological reactor or food fermentation process such as brewing.

In a further aspect, the invention provides business methods. In one embodiment, the invention provides a method of doing business comprising use by an entity of a detector with two interrogation spaces that is capable of detecting single particles (e.g., single molecules) to obtain a result for an assay of a sample, reporting said result, and payment to the entity for the reporting of the result. In some embodiments, the detector may be any of the embodiments described herein. In some embodiments, the entity is a Clinical Laboratory Improvement Amendments (CLIA) laboratory. In some embodiments, the entity is a laboratory that is not a CLIA laboratory. The sample may be any type of sample capable of being analyzed by the single particle detector. In some embodiments, the sample is from an individual. The individual may be any type of individual as described herein. In some embodiments, the individual is a patient (e.g., animal, e.g., human) for which screening, diagnosis, prognosis, monitoring and/or determination of method of treatment is desired. In some embodiments, the individual is an individual (e.g. animal, e.g. human) who is participating in a clinical trial or in pre-clinical trial research. In some embodiments, the sample is from an individual who is part of a research project, e.g., biomedical research, agricultural research, industrial research, educational research, bioterrorism research, and the like. In some embodiments, payment may be by the individual receiving the report of the result, e.g., a health care professional and/or the individual from whom the sample was taken, to the entity performing the analysis, e.g., a CLIA laboratory, or it may be by the individual from whom the sample was taken to the individual receiving the report from the entity performing the analysis, or to the entity itself, or both, or some combination thereof. In another embodiment, the invention provides a method of doing business, comprising use of a detector with two interrogation spaces that is capable of detecting single particles by a health-care provider to obtain a result for an assay of a sample from an individual, reporting said result to the individual or their representative; and payment by the individual for said reporting of the result.

### EXAMPLES

The following examples are offered by way of illustration and not by way of limiting the remaining disclosure. A fragment of DNA, particles, proteins, a virus, and an organelle bound to a nucleic acid were pumped or subjected to electrophoresis.

Data was analyzed as follows: Adjacent bins containing photons were grouped into photon bursts derived from particles using the analyzer software. For experiments utilizing electrophoresis, particle-derived photon bursts were then cross-correlated to determine their electrophoretic velocities (time offset for detection at the two detectors).

### Example 1

### Detection of a DNA Fragment—Electrophoretic Velocity and Dilution Curve

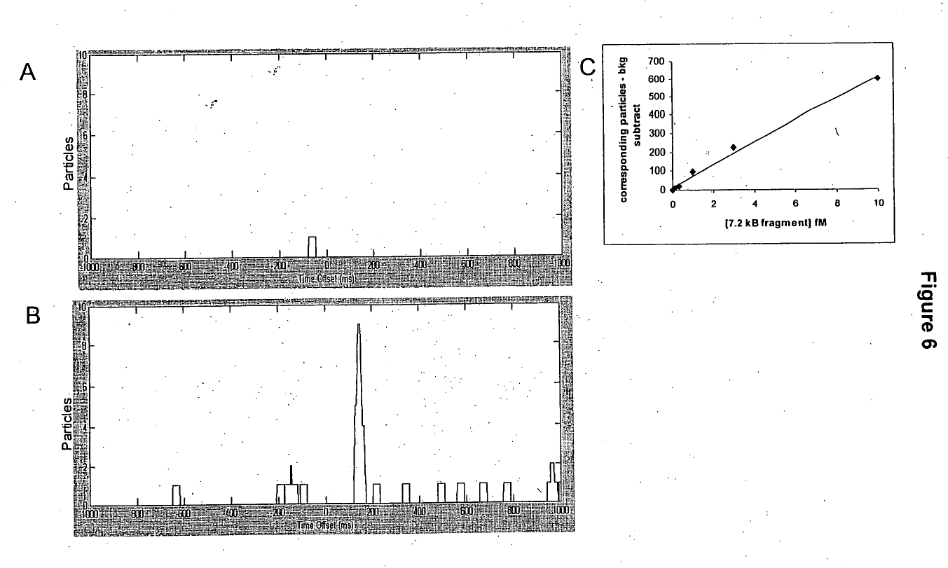

A 7.2 kb fragment of DNA labeled with A647 was used to demonstrate electrophoresis of nucleic acid. M13mp18 RFI DNA (New England Biolabs, Beverly, Mass.) was digested at a single restriction site by SmaI. The resulting 7.2 kb fragment was labeled with AlexaFluor647 using a ULYSIS® nucleic acid labeling kit (Molecular Probes, Inc., Eugene, Oreg.) according to the manufacturer's instructions. The concentration of Alexa Fluor labeled DNA was determined from its absorbance at 260 nm. The concentration of Alexa Fluor was determined from its absorbance at 650 nm. The degree of labeling was 190 dyes per DNA particle. Serial dilutions were made from the stock solution to create a range of concentrations between 0.03 and 100 fM. Each sample was loaded into the analyzer described in the present invention and subjected to electrophoresis for 4 min. Examples of the histogram plots of the particle cross-correlations of samples with 0 and 0.1 fM DNA are shown in FIG. 6. At 0.1 fM, a peak of 9 particles was detected at 142 ms, while a background sample had 1 particle at −78 ms. A linear relationship between number of particles detected and sample concentration up to 100 fM was demonstrated.

### Example 2

### Sandwich Assays for Biomarkers

Recent reports have established TREM-1 as a biomarker of bacterial or fungal infections (see, e.g., Bouchon et al. (2000) J. Immunol. 164:4991-5; Colonna (2003) Nat. Rev. Immunol. 3:445-53; Gibot et al. (2004) N. Engl. J. Med. 350:451-8; Gibot et al. (2004) Ann. Intern. Med. 141:9-15. Assays for TREM-1 have been developed using a sandwich assay format (Sandwich Assay for Detection of Individual Molecules, U.S. Provisional Patent Application No. 60/624,785). Assay reagents for TREM-1 detection are available commercially (R&D Systems, Minneapolis, Minn.). The assay was done in a 96 well plate. A monoclonal antibody was used as the capture reagent, and either another monoclonal or a polyclonal antibody was used for detection. The detection antibody was labeled with AlexaFluorA647®.

The assay protocol was as follows:
1. Coat plates with the capture antibody, washed 5×,
2. Block in 1% BSA, 5% sucrose in PBS,
3. Add the target diluted in serum, incubate, wash 5×,
4. Add the detection antibody, incubate, wash 5×
5. Add 0.1 M glycine pH 2.8 to release the bound assay components from the plate.
6. Transfer samples from the processing plate to the detection plate, bring the pH of the sample to neutral and run on the single particle analyzer system.

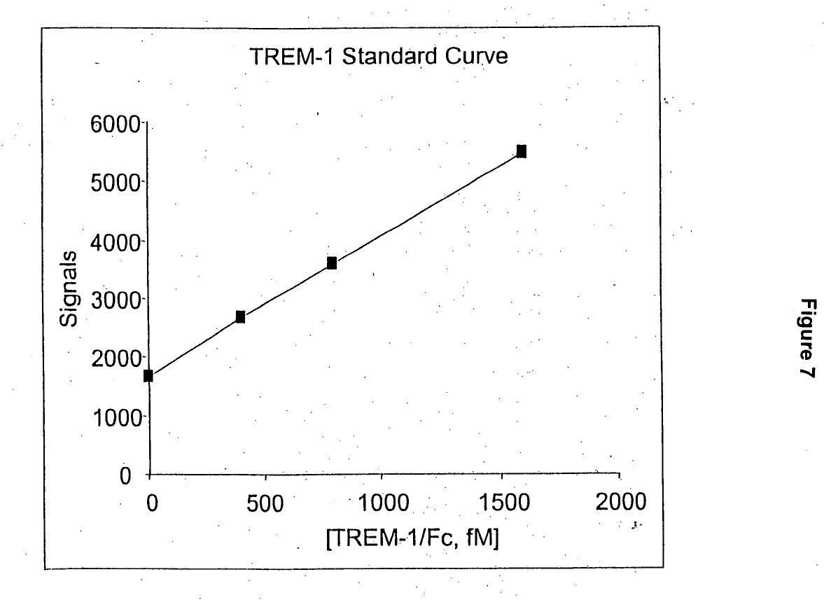

FIG. 7 shows a standard curve of TREM-I generated using the assay. The assay was linear in the measured range of 100-1500 femtomolar. An ELISA assay from R&D Systems has recently been introduced. The standard curve reported for their ELISA assay is between 60-4000 pg/ml. This Example suggests we can routinely measure 100 fM (4.7 pg/ml) in a standard curve, allowing for about 10× more sensitive measurements.

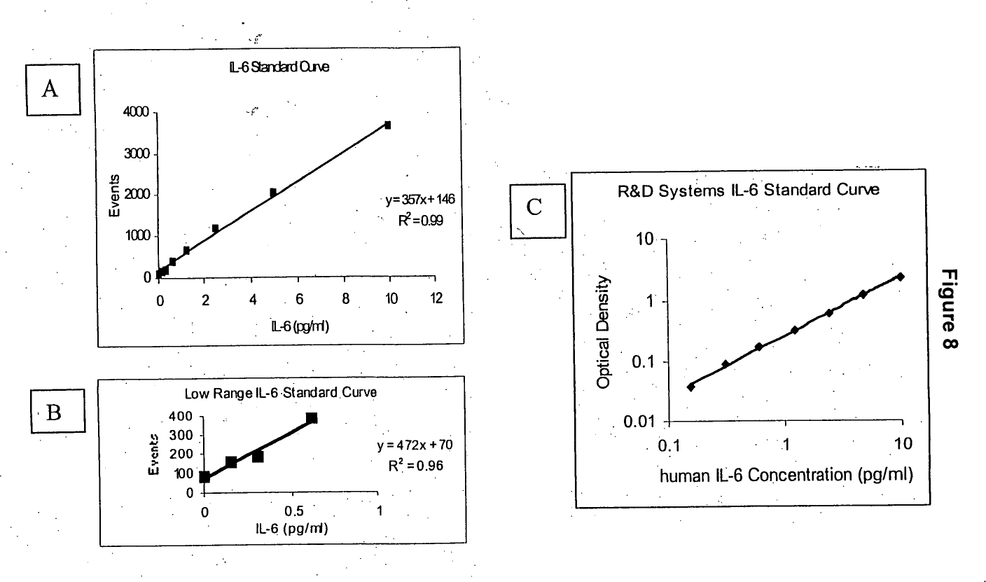

A sandwich assay configured for detection of IL-6 has also been developed using commercially available reagents (R&D Systems). The protocol was essentially as described above for TREM-1 except that the target diluent and capture antibody pair were as described by R&D Systems. The detection antibody was an R&D Systems' antibody labeled with AlexaFluor® 647. The assay allowed for detection of IL-6 at less than 0.5 pg/ml (FIG. 8A and B). The limit of detection was calculated to be 0.06 pg/ml. This level of sensitivity is excellent for detection of even normal levels of IL-6 which range between 0.5 and 10 pg/ml. Compared to other commercially available multiplexed assays that include IL-6, this system provides a significant improvement in the level of detection. Compared to the R&D Systems assay, the limit of detection is about the same (FIG. 8C), but this system offers the advantage of multiplexing and is not dependent on amplification steps, two of which are needed for the R&D Systems' assay. The single particle analyzer system data differs from ELISA data in that quantification is accomplished by counting individual molecules in low concentration solutions, rather than making ensemble measurements of molecules. The former is more precise than the latter.

### Example 3

### Bead-Based Assay

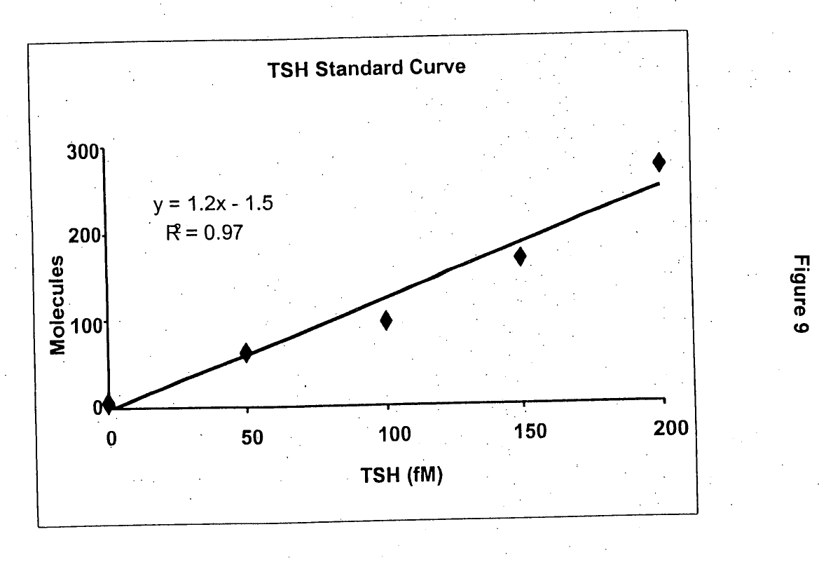

The two assays described above use the same microtiter plate format where the plastic surface is used to immobilize target molecules. The single particle analyzer system also is compatible with assays done in solution using microspheres or beads to achieve separation of bound from unbound entities. FIG. 9 shows the results of a bead-based assay to detect Thyroid Stimulating Hormone (TSH). The data illustrate that the sandwich assay can be directly transferred to a bead-based format and used with the system. Super-paramagnetic streptavidin microbeads (Miltenyi Biotec, Auburn, Calif.) were coated with biotinylated anti-TSH capture antibody. Dilutions of 0-200 fM TSH were captured by incubation at 4° C. with excess microbeads in phosphate buffered saline. The microbeads, with captured TSH, were collected and washed on high gradient magnetic separation columns (Miltenyi Biotec). The beads were removed from the columns and incubated with anti-TSH detection antibody labeled with AlexaFluor® 647 (Molecular Probes, Eugene, Oreg.) for two hours at 37° C. The beads, with detection antibody bound to the captured TSH, were collected, washed with phosphate buffered saline, and removed from the column. The beads were run on the particle analysis system producing a linear response over the measured range of 50-200 femtomolar TSH (FIG. 9).

### Example 4

### Detection of a Target Protein in Human Serum

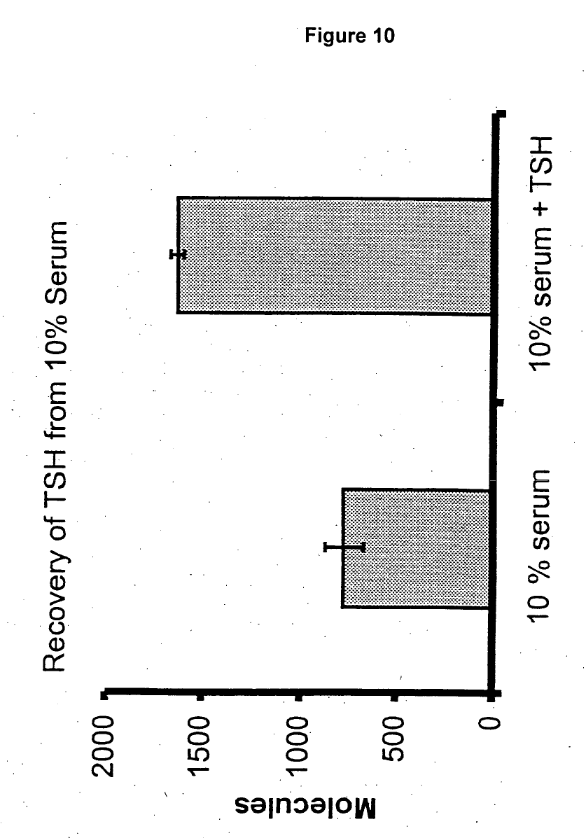

A sandwich assay similar to those described above was developed for detecting targets within serum. For this assay, known quantities of TSH were added to samples that contained 10% human serum. Labeled antibodies specific for TSH were added, unbound label removed, and the samples were run on the single particle analyzer system. The results, shown in FIG. 10, demonstrate that all the added TSH was recovered in the assay.

### Example 5

### Detection of Sub-fM Concentrations of a Nucleic Acid Polymer

3DNA™ dendrimers are particles made up of many branched, interconnected nucleic acid particles. A 4-layer dendrimer labeled with A647 obtained from Genisphere Inc. (Hatfield, Pa.) was used to demonstrate electrophoresis of a particle. The manufacturer specifies that the dendrimer contains approximately 37,000 deoxynucleotides labeled with approximately 375 dyes per dendrimer at a concentration of 20 ng/μl. These manufacturer specifications were used to calculate the molarity of the sample. Serial dilutions were made from the stock solution to create a range of concentrations between 0.01 and 33 fM. Each sample was loaded into the analyzer described in the present invention and subjected to electrophoresis for 4 min.

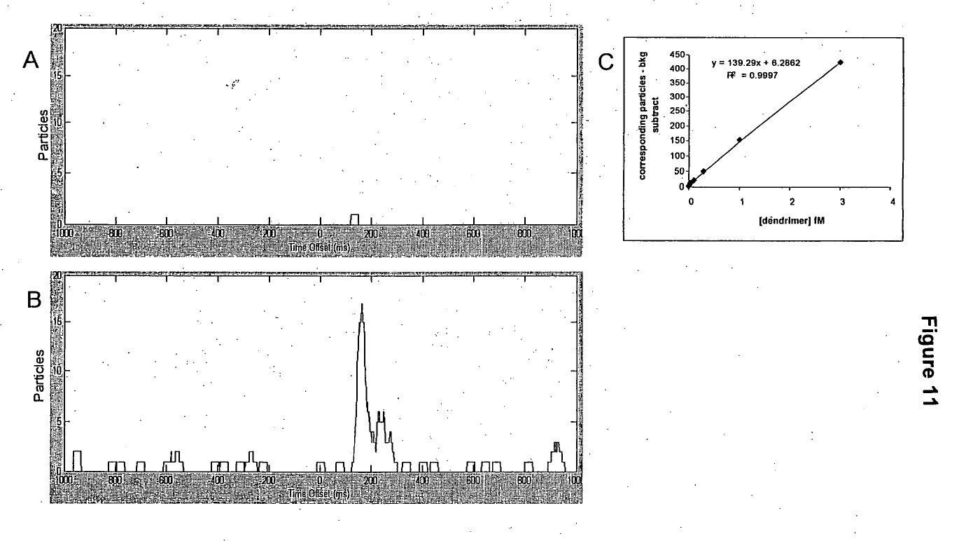

Examples of the histogram plots of the particle cross-correlations are shown in FIG. 11 for samples with 0 and 0.03 fM of dendrimer. At 0.03 fM, a total of 17.6 particles were detected in peaks at 163 and 227 ms, while a background sample had 1 particle at 119 ms. A linear relationship between number of particles detected and sample concentration up to 33 fM was demonstrated.

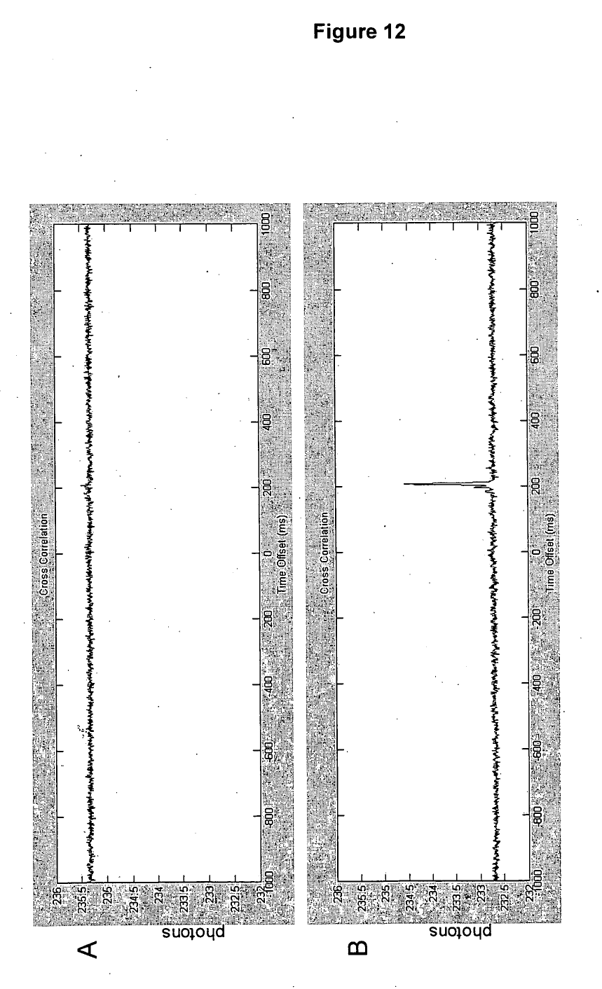

Examples of results of cross-correlation of adjacent photon bursts are shown in FIG. 12 for samples of 0 and 0.03 fM. The latter showed a peak of photons was detected at 206 ms while a background sample had 0 photons detected.

### Example 6

### Detection of BSA—SDS Electrophoresis and Dilution Curve

Bovine serum albumin (BSA) labeled with A647 was used to demonstrate electrophoresis of a protein. BSA was covalently labeled with the succinimidyl ester of A647 carboxylic acid (Molecular Probes, Inc., Eugene, Oreg.) according to the manufacturer's instructions. Unconjugated Alexa Fluor was separated from the protein by ultrafiltration on a Microcon YM-30 membrane (Millipore Corporation, Bedford, Mass.). The concentration of A647 labeled BSA was determined from its absorbance at 280 nm, corrected for the contribution of Alexa Fluor at 280 nm. The concentration of Alexa Fluor was determined from its absorbance at 650 nm. The degree of labeling was 1.9 Alexa Fluors per protein particle. Serial dilutions were made from the stock solution to create a range of concentrations between 0.03 and 30 fM. Each sample was loaded into the analyzer described in the present invention and subjected to electrophoresis for 4 min.

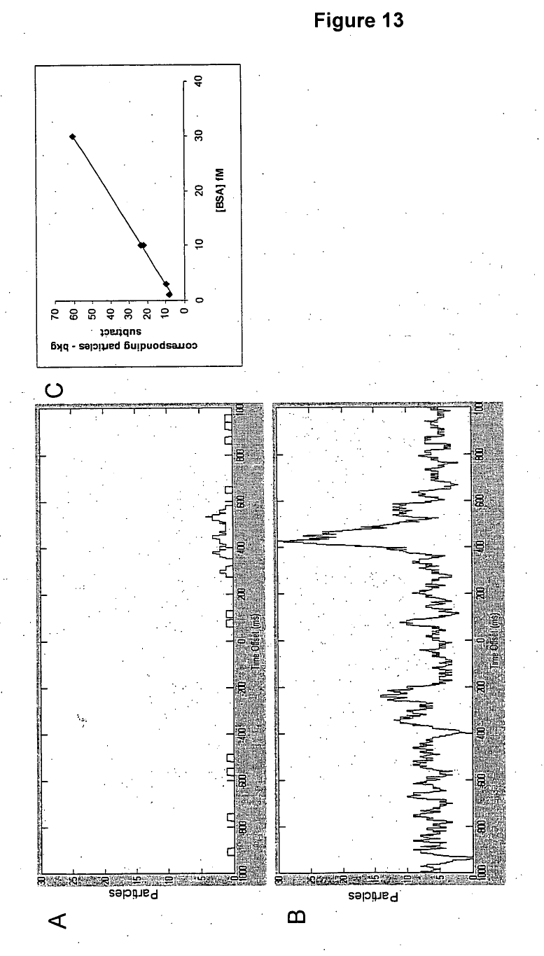

Examples of the histogram plots of the particle cross-correlations are shown in FIG. 13 of samples with 0 and 10 fM protein. At 10 fm, a peak of 30 particles was detected at 427 ms, while a background sample had 4 particles between 250 and 600 ms. A linear relationship between number of particles detected and sample concentration up to 30 fM was demonstrated.

### Example 7

### Detection of a Virus—Electrophoretic Mobility

M13K07 was bound to A647 Zenon labeled anti-GP8 antibody to demonstrate detection of a virus. Anti-GP8 antibody was labeled with a Zenon™ IgG labeling kit (Molecular Probes, Inc., Eugene, Oreg.) at room temperature for 5 minutes. 3.7 pM of M13K07 (New England Biolabs, Beverly, Mass.) was incubated with 110 pM of labeled anti-GP8 antibody in 1×PBS at 4° C. overnight. The labeled phage were purified away from free antibody by applying the reaction to a S-400HR spin column two times. The eluates from the S-400 columns were diluted, loaded into the analyzer described in the present invention and subjected to electrophoresis for 4 min.

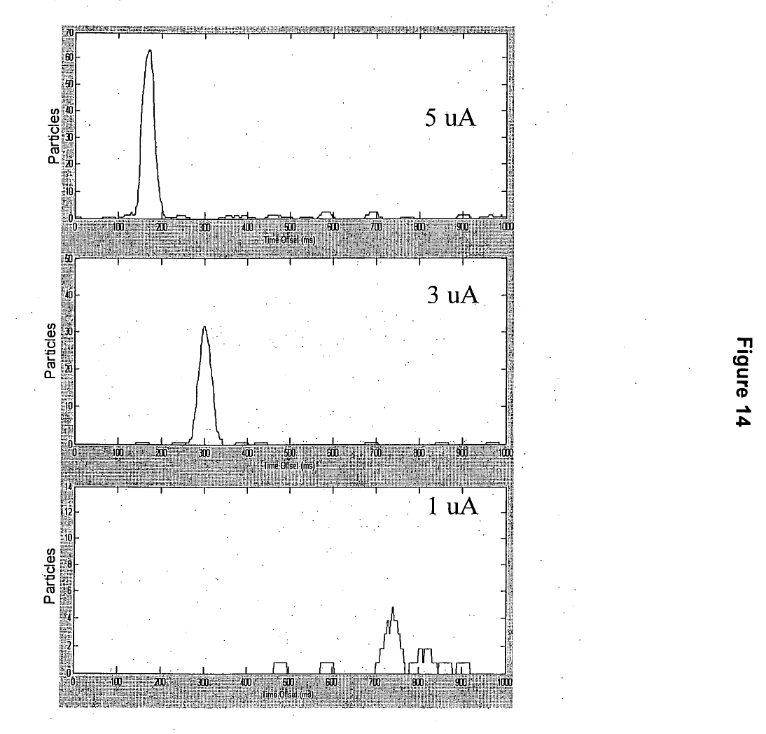

Examples of the histogram plots of the particle cross-correlations are shown in FIG. 14. The mobility of virus particles increased as a function of current. Also, although the concentration of virus was the same for each condition, the number of particles detected in 4 min. was lowest in the slowest moving sample (1 μA) and increased at higher velocities as expected.

### Example 8

### Detection of Bacteria and Viruses

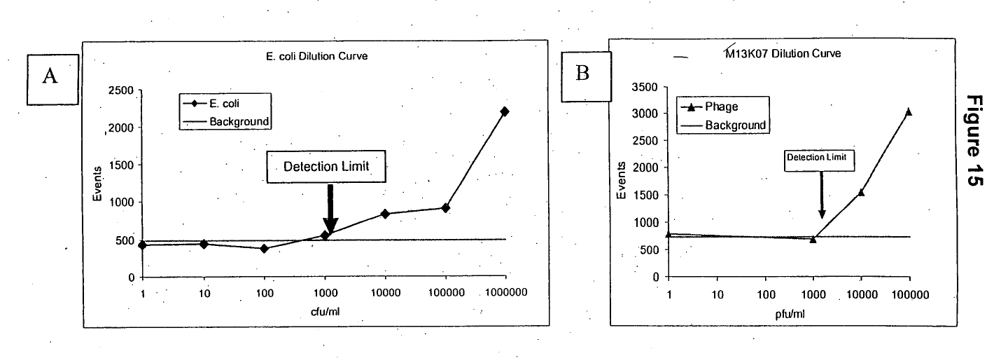

Assays have been developed to measure whole organisms, such as viruses or bacteria using an immunoassay. FIG. 15 shows the results of assays used to detect microorganisms. A bead-based assay was used to detect E. coli K12 JM109. Cells were incubated with antibody (rabbit polyclonal) conjugated to AlexaFluor® 647 for 1 hr at room temperature. The bacterial suspension was centrifuged through 0.2 micron filters to separate unbound antibody from antibody bound to cells. The cells were washed 8 times, resuspended in release buffer (0.1 M glycine pH 2.8) and incubated for 10 min. The release solution was centrifuged through the filter, neutralized and run on the particle analysis system. For viral detection an assay was used where M13 phage particles from diluted stock solutions (New England Biolabs, Beverly, Mass.) were passively bound to wells of a microtiter plate by incubating at room temperature. Wells were aspirated and blocked for 30 min. Anti-M13 antibody was labeled with Zenon (Molecular Probes) and added to the wells at 1000 ng/ml. The plate was incubated for 1 hr, washed, and the bound material released with 0.1 M glycine pH 2.8, neutralized and run on the single particle analyzer system. Neither of the assays used to generate the data in FIG. 15 were optimized to reduce background, maximize detection or minimize assay time. Optimization should enable lower detection limits and results obtained in 2 hrs.

The rationale for choosing E. coli as a model is the availability of antibodies and assays for its detection. E. coli is a well-studied, diverse organism whose strains are distinguished primarily on the basis of serotypes. This thorough characterization is reflected in the large number of antibodies that have been developed to distinguish the many serotypes, now numbering over 700 (www.textbookofbacteriology.net). This is both an advantage and disadvantage for assay development. The advantage is that there are many candidate antibodies to select from, and the probability of finding high quality ones is great. The disadvantage is that specificity issues will need to be addressed very carefully. Ideally one can select an antibody pair that detects only those serotypes of interest and none of the others. In reality, the capture and/or detection antibodies may need to consist of a pool of antibodies that react specifically with the strains of interest and have little cross-reactivity with other strains. Of special concern are non-pathogenic strains that are omnipresent and common contaminants of clinical samples. Selecting the best antibodies likely will require a lengthy but routine screening process. The high speed of the analyzers and analyzer systems of the invention dramatically facilitate the completion of this screening process. If a pool of antibodies is used, the concentration of each antibody will be balanced to provide uniform detection of each relevant strain. In addition to testing for cross-reactivity with non-pathogenic E. coli strains, cross-reactivity is investigated for other pathogens such as Staphylococcus, Enterobacter, Candida, and Pseudomonas strains. Assays that specifically detect these other pathogens are developed. At that time and certainly before clinical trials are performed, extensive cross-reactivity testing is performed to ensure that each assay specifically detects and distinguishes its target pathogen.

It is anticipated that the concentration of bacteria in blood samples will be low, even in samples from patients with active sepsis. Even though the assay has “built in” amplification because each bacterium contains many binding sites for its specific antibody, an additional amplification step may be needed. It has been demonstrated that an additional signal amplification step is possible in these immunoassays and is compatible with detection by the analyzers of the invention. The amplification is achieved through the enzymatic activity of alkaline phosphatase conjugated to the detection antibody. For example, alkaline phosphatase conjugated to streptavidin (Roche, Basel, Switzerland) is bound to immobilized biotin. After washing to remove unbound enzyme, non-fluorescent alkaline phosphatase substrate is added and incubated with the sample for several minutes. The individual molecules of fluorescent product generated by the antibody-enzyme conjugates are then counted in the analyzer instrument.

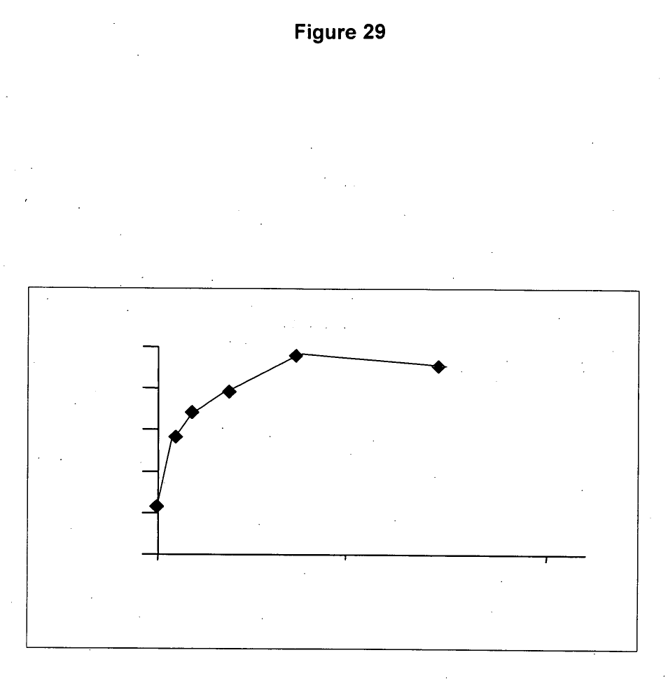

In a model experiment of this type, alkaline phosphatase was diluted to known concentrations between 0-150 molecules/200 ul and then was reacted with a substrate (9H-(1,3-dicloro-9,9-dimethylacridin-2-one-7-yl) phosphate, diammonium salt [DDAO-phosphate, Molecular Probe]) that was cleaved to a fluorescent product. The reaction was incubated at 37° C. for 60 min. The reaction was stopped and run on a two-interrogation space analyzer as described herein. FIG. 29 shows the number of fluorescent product molecules counted at each concentration of the enzyme. Fewer than 10 molecules of enzyme were detected from a 200 ul sample. This basic methodology is employed in cases where direct bacterial or viral detection is not sensitive enough for relevant clinical measurement or where we wish to extend the assay sensitivity into previously uncharacterized regimes.

This enzyme amplification of signal can be used to detect individual bacteria as described above, or can be used to detect any analyte to which the enzyme-ligand conjugate can be bound and where unbound enzyme-ligand is removed or inactivated. For detecting E. coli in blood, reagents and conditions are defined where the E. coli in blood samples behaves the same as bacteria grown in culture, so that accurate measurements of concentrations can be determined from a standard curve. The assay can reveal the presence of higher numbers of target organisms than are indicated by culture, since the assay will detect both viable and non-viable organisms. The presence of therapeutic antibiotics in a patient sample is not expected to affect bacterial detection using the system. Blood contains many molecules that can interfere with the binding of assay antibodies to bacterial targets. It is important to define conditions that maximize the desired binding reactions and minimize all others.

### Example 9

### Labeling With a Mass Tag Shifts the Electrophoretic Velocity of a Protein Complex

Streptavidin labeled PBXL-3 (PBXL-3/SA) (Martek Biosciences Corp., Columbia, Md.) was combined with a biotin-labeled 1 kb PCR fragment (b-NA) to demonstrate detection of binding interactions. Equimolar concentrations of PBXL-3/SA and b-NA (800 pM) were incubated at room temperature for at least 1 hr in 10 mM Tris, 0.5 mM EDTA pH 8.1 with 0.1% casein hydrolysate as a carrier. Control incubations of PBXL-3/SA alone and PBXL-3/SA with the same 1 kb fragment without biotin (NA) also were performed. Following the incubation, samples were diluted 10,000× to final concentration of 8 fM in 2 mM Tris, 0.1 mM EDTA pH 8.1. Samples were loaded into the analyzer described in the present invention and subjected to electrophoresis for 4 min.

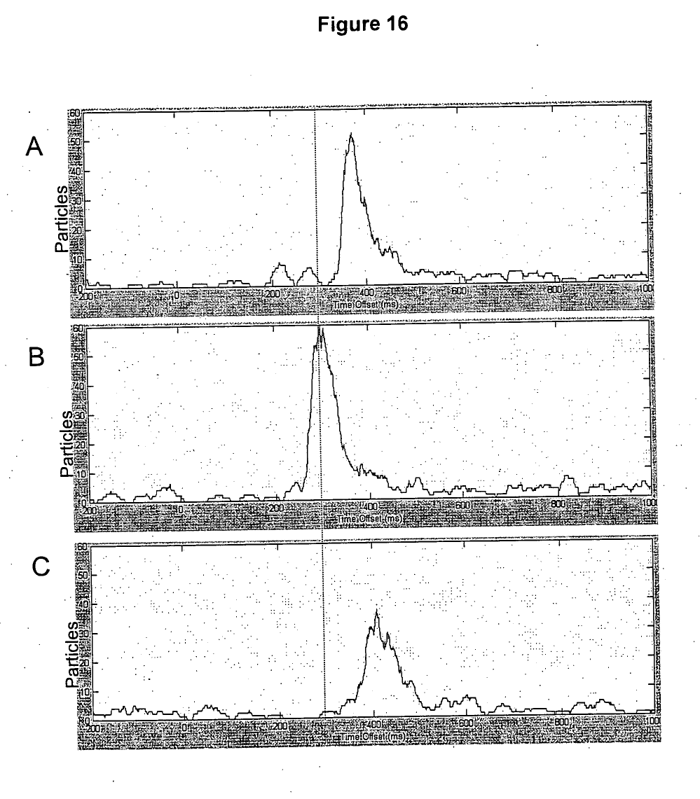

Examples of the histogram plots of the particle cross-cofrelations are shown in FIG. 16. In the absence of nucleic acid, the organelle (PBXL-3/SA) migrated as a peak at 368 (Panel A). Bound to the nucleic acid, it migrated faster, as seen by the shift of the peak to 294 ms (Panel B). The shift only occurred when the nucleic acid was bound to the organelle, since its presence (without the biotin tag) in the reaction resulted in the organelle migrating as a peak at 409 ms (Panel C).

### Example 10

### Discrimination of Two Particles by Mobility—Electrophoresis Without Sieving

M13K07 was bound to A647 Zenon labeled anti-GP8 antibody to demonstrate discrimination of a virus and nucleic acid. Anti-GP8 antibody was labeled with 3 fold excess Zenon A647 at room temperature for 5 minutes. 3.7 pM of M13K07 (based on plaque forming units reported by New England Biolabs) was incubated with 110 pM of labeled anti-GP8 antibody in 1×PBS at room temperature for 1 hour. The reaction was stored at 4° C. overnight. The labeled phage were purified away from free antibody by applying the reaction to a S-400HR spin column two times. The eluted samples were diluted 10,000 fold, loaded into the analyzer described in the present invention and subjected to electrophoresis for 4 min. The nucleic acid sample was a 1 kb PCR fragment derived from M13K07 and labeled with A647. All samples were run at a total concentration of 8 fM.

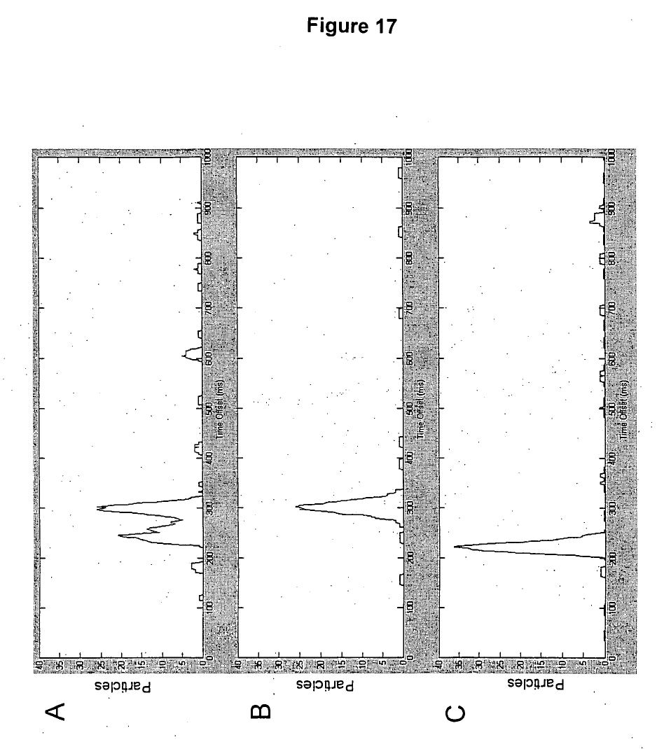

Examples of the histogram plots of the particle cross-correlations are shown in FIG. 17. When both the PCR nucleic acid fragment and the virus/antibody combination are present, two peaks are resolved at 245 and 296 ms (Panel A). The labeled nucleic acid alone migrated as a peak at 302 ms (Panel B). Virus bound to the antibody alone migrated as a peak at 222 ms (Panel C).

### Example 11

### Discrimination of Two Particles by Mobility—Using SDS Electrophoresis with Linear Polyacrylamide

Samples of A647-labeled IgG and 1.1 kb PCR product were prepared in 18 mM tris, 18 mM glycine, pH 8.6 with 0.2% linear polyacrylamide (LPA, 5,000,000-6,000,000 MW), 0.01% sodium dodecyl sulfate and 1 μg/ml each bovine serum albumin, Ficoll®, and polyvinylpyrrolidone. Samples were pumped into the analyzer capillary, the pump was stopped, and an electric field was applied (300 V/cm). Cross-correlation of the particles was determined as a function of time offset. One minute data sets were collected and analyzed.

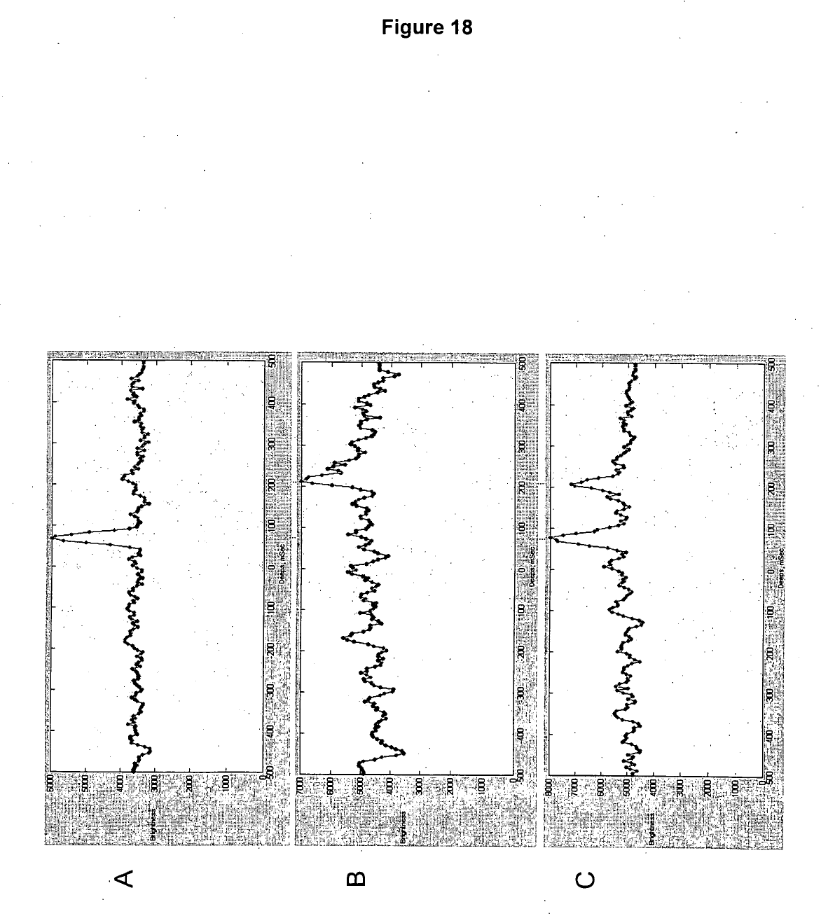

Examples of the histogram plots of the particle cross-correlations are shown in FIG. 18. Panel A shows a sample containing only IgG at a concentration of 26 fM and labeled with A647 showed a peak of cross-correlated events at 75 ms, the time needed for IgG to transit between the two interrogation spaces. Panel B shows a sample containing only the PCR product at a concentration of 10 fM and labeled with A647 showed a peak of cross-correlated events at 220 ms, the time needed for the PCR product to transit between the two interrogation spaces. Panel C shows a sample containing both IgG and PCR product at 13 fM and 5 fM, respectively, and both labeled with A647 showed two peaks of cross-correlated events, one at 75 ms and another at 215 ms, demonstrating that the assay was able to discriminate between these two molecules based on their different transit times in the analyzer under the assay conditions described.

### Example 12

### Indirect Detection of Particles—Detection of Labels Released from the Target Particle

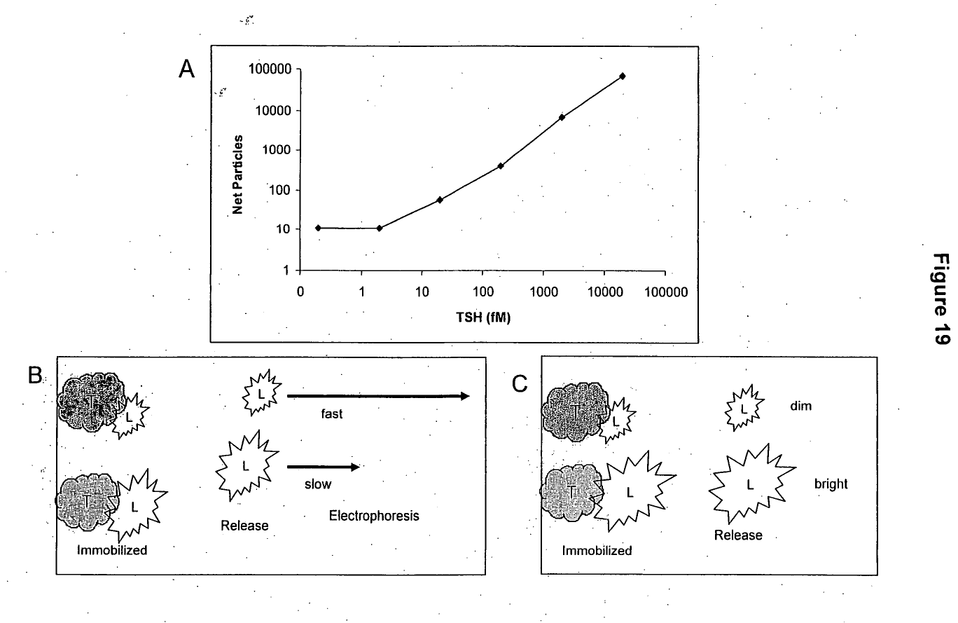

Biotinylated anti-thyroid stimulating hormone (TSH) antibody was immobilized on a streptavidin-coated 96 well plate, and the excess unbound antibody was washed away. TSH antigen and A647 labeled anti-TSH antibody were added to the wells in phosphate buffered saline with 1% bovine serum albumin and 0.1% Tween®20. The plate was incubated with agitation. The liquid was removed by aspiration, and the wells were washed three times. The A647 labeled antibody was dissociated from the TSH sandwich by incubation with 0.1 M glycine-HCl, pH 2.8. The free A647 labeled antibody was collected, diluted and analyzed by SMD. The linear relationship between released label and the original target particle concentration is seen in FIG. 19A.

It will be appreciated by one skilled in the art that similar methods are available for labeling and release of labels from nucleic acids. Matray et al. teaches methods for labeling and releasing labels from both proteins and nucleic acids (Matray, 2004). One skilled in the art will also recognize that separation and discrimination of a mixture of labels released from the target proteins and nucleic acids is essentially the same as for the original targets. FIGS. 19B and C shows two possible ways to distinguish two released labels using the analyzer

### Example 13

### Discrimination of Two Particles by Intensity

An intrinsically fluorescent protein complex, PBXL-3, emits many photons per unit time relative to a nucleic acid, linearized pUC19 labeled with Alexa Fluor® 647. The pUC19 DNA was labeled with Alexa Fluor® 647 following the protocol of the ULYSIS® nucleic acid labeling kit (Molecular Probes, Inc., Eugene, Oreg.). Phosphate Buffered Saline (PBS) (10 mM sodium phosphate, 150 mM NaCl, pH 7.2) was supplemented with 0.01% casein hydrolysate (Sigma-Aldrich Corp., St. Louis, Mo.) and used to make dilution series (2.5, 5, 7.5, 10 and 20 fM) of protein alone, nucleic acid alone or mixtures of both. Samples were moved through the analyzer by pumping at 1 μL/min for 4 min.

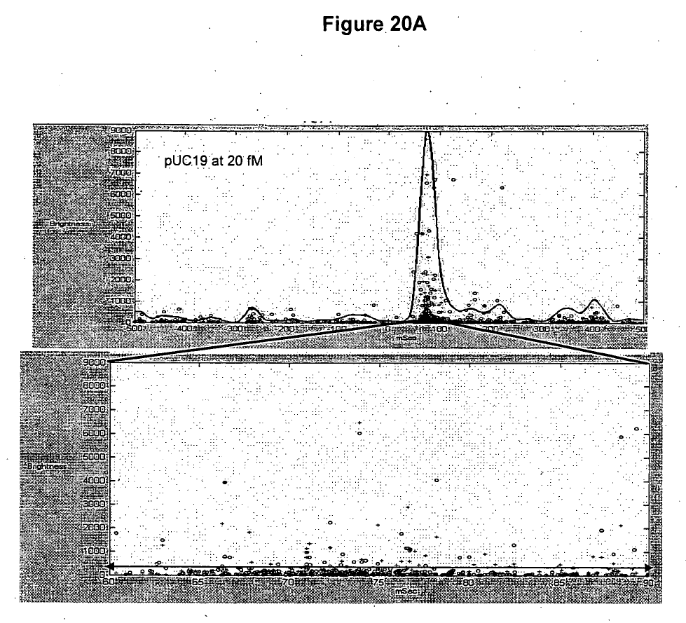

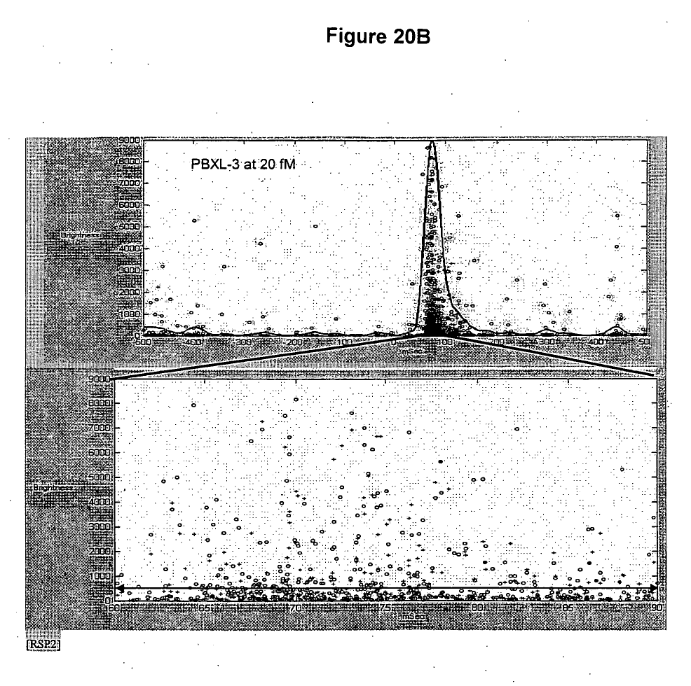

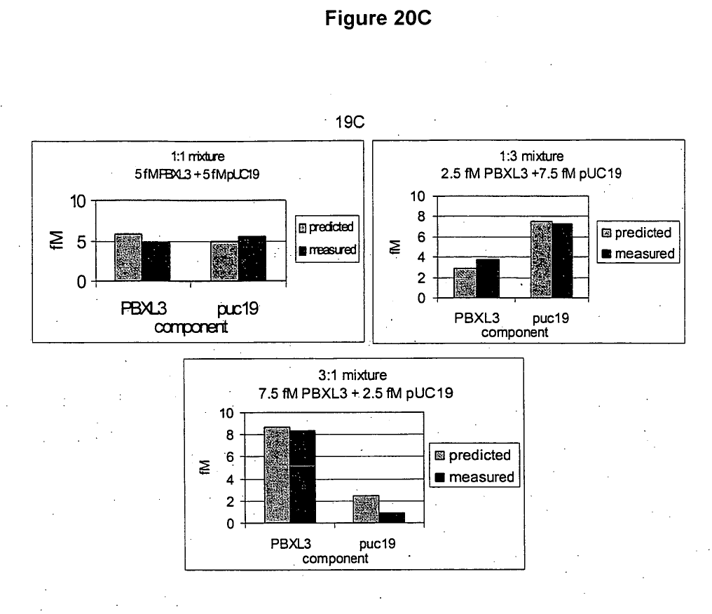

Data was analyzed by cross-correlation of detected signals that were greater than four standard deviations above the average background. FIGS. 20A and B shows plots of cross-correlated signals for the protein complex and nucleic acid alone. The range of elapsed time was restricted to show only the events within the peaks themselves (see FIGS. 20A and B) and to emphasize the different characteristic fluorescent intensities of the protein complex and the nucleic acid. A brightness level of 500 photons was chosen as the cut-off point to separate a window of bright intensity for the protein complex and a window of low intensity for the nucleic acid. Using this approach to discriminate between the two molecular species, the number of detected events was measured for both the protein complex and nucleic acid at series of concentrations. Standard curves were plotted for the protein and nucleic acid using both brightness windows, and the slopes of the curves were determined.

In three different mixtures, the protein complex and nucleic acid were discriminated based on their fluorescence intensity. The number of molecules detected in the mixtures of PBXL-3 and pUC 19 were used to calculate the concentrations of each component based on the slopes of the standard curves. Comparing the measured concentrations for the protein and nucleic acid to the predicted values demonstrates that the concentration of sample components can be determined by comparing the number of molecules detected in the sample relative to a standard curve (FIG. 20C). Furthermore, the concentrations determined by molecule counting agree very well with the concentrations determined by macro-scale spectroscopy of the undiluted stock solutions used to prepare the samples.

### Example 14

### Bioassays for Measuring Properties of Single Particles

Commonly used assays for biological particles include sandwich ELISA assays which can detect the simultaneous presence of two epitopes that bind to capture and detection .antibodies, but they typically are limited to two epitopes, lack sensitivity (typically pM or greater), and fail to detect particles with only a single epitope. Fluorescence resonance energy transfer (FRET) methods, which are often used in competition assays, also detect simultaneous presence of two epitopes, and also lack sensitivity. Mass spectrometry often requires that large particles be cleaved into fragments with sufficient volatility for analysis, again averaging the modifications over the entire sample population.

The SMD analyzer of the invention provides key advantages that can be used in biological assays: high sensitivity, the ability to measure particles or molecular complexes singly, rather than in bulk, discrimination of particles based on electrophoretic velocity and the ability to monitor multiple wavelengths within a single assay. These advantages are accomplished through the unique fimctional capacity of the analyzer to detect multiple electromagnetic characteristics of target particles and determine their electrophoretic velocities.

14A. Sandwich Assays

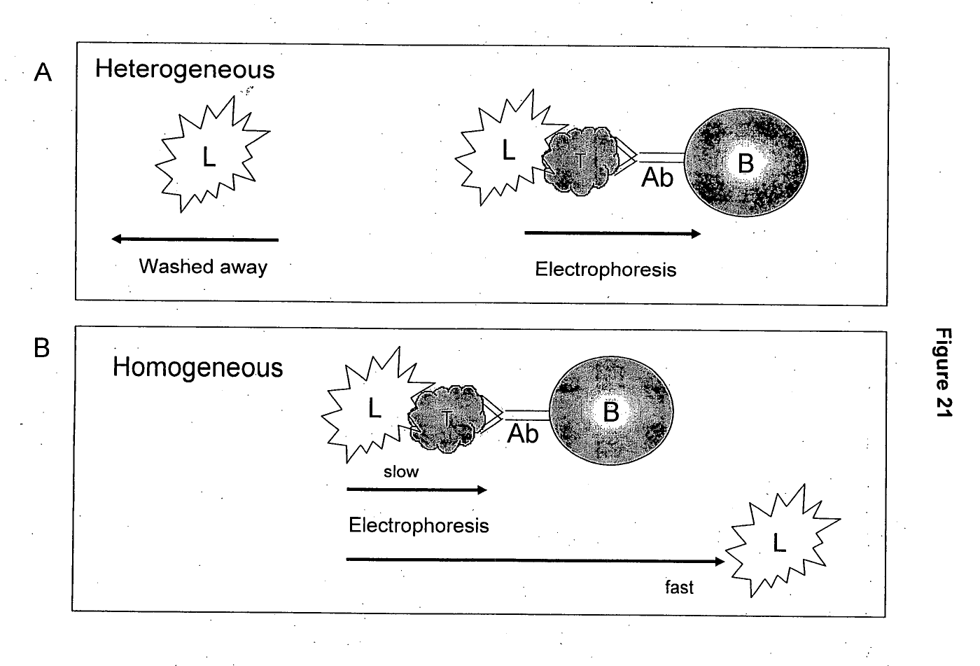

In a heterogeneous assay format (FIG. 21A), a test solution containing a target particle is reacted with a bead coated with an antibody specific for the target particle. The target is captured on the bead and unbound material is washed away. The bead-target complex is then incubated with a fluorescent tag which binds specifically to the target to generate a labeled sandwich. The analyzer of the invention is used to detect the labeled sandwich and determine its electrophoretic velocity. In a homogeneous assay format (FIG. 21B), the test solution with the bead-target-tag complex is formed in the same way, but unbound material is not removed. The different electrophoretic velocities of the target sandwich and the tag alone are used to distinguish them.

14B. Two-Color Discrimination

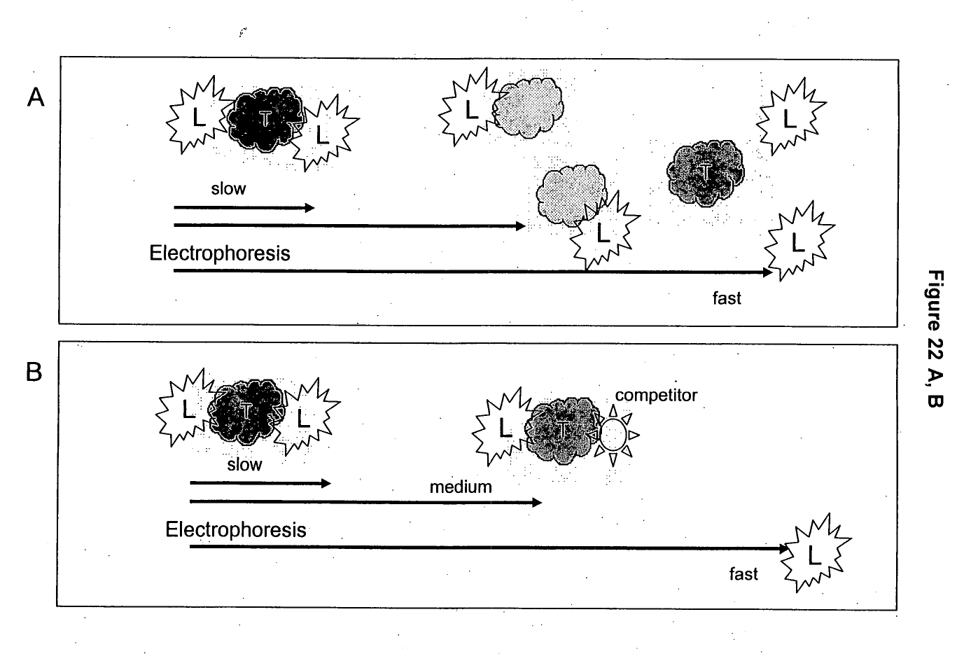

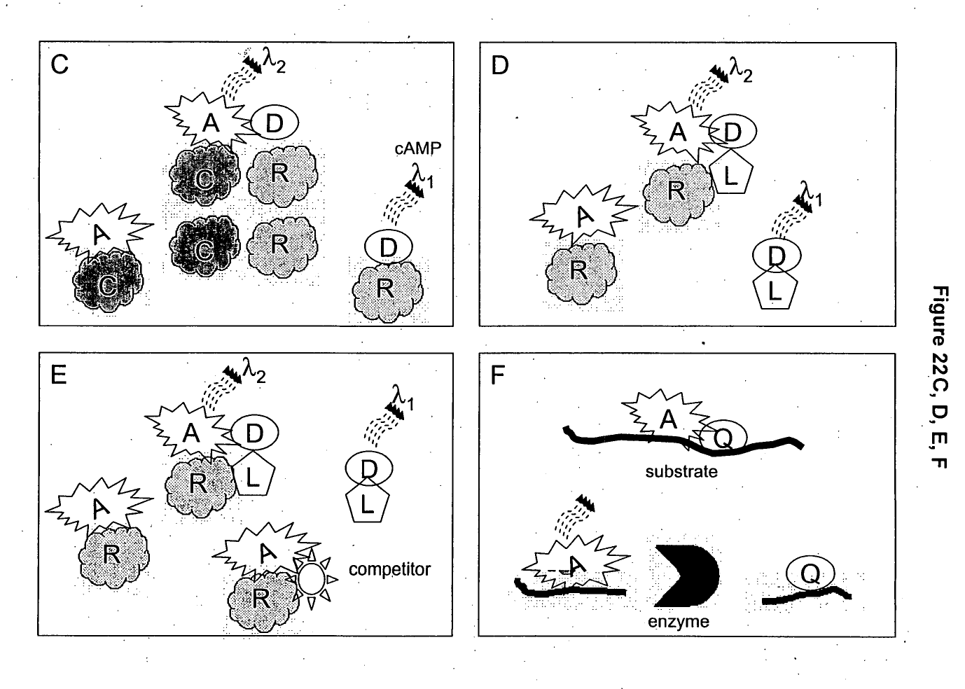

A second application makes use of coincident detection of two labels on a single target particle in a homogeneous assay format. In this approach, unbound labels are not separated from those bound to target. The sample can be subjected to electrophoresis in the analyzer of the invention, which has a detector for the first emission wavelength at the first interrogation space, and a detector for the second emission wavelength at the second interrogation space. Particles are detected in both interrogation spaces, but only particles that have the spectral fingerprint of both labels are counted. The different electrophoretic velocities are used to discriminate between unbound and bound label. An example of a two-color assay is shown in FIG. 22A.

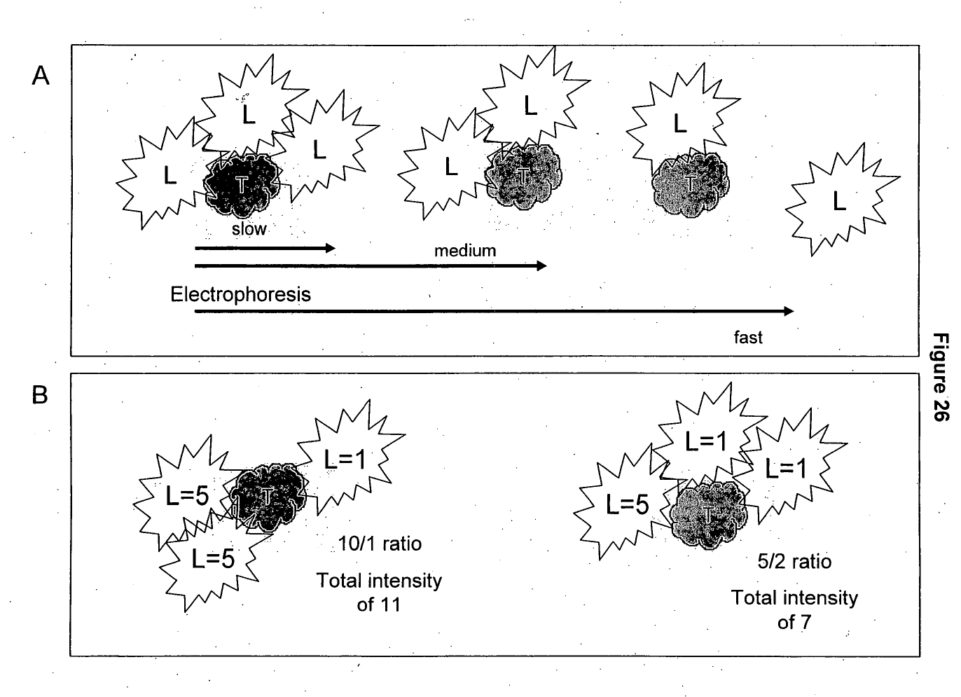

A homogeneous sandwich assay can be used to determine the post-translational modification patterns of single protein particles. A protein particle with multiple potential sites for modification is reacted with specific labels for each modification. Each specific label has a unique fluorescence spectrum. The reaction mixture is moved by, e.g., electrophoresis past the multiple detectors at each of the interrogation spaces and the spectral fingerprint (ratios of photons in channels of differing wavelengths) of the protein-label complex is recorded (see FIG. 26B). In addition, the electrophoretic velocity of the various labeled components can be determined. This reduces the background due to accidental coincidence of target particles and the unbound labels in a single channel. The spectral fingerprint from the multiple detectors identifies the pairs of labels that are bound to the same particle, and therefore which corresponding post-translational modifications occur on the single particles.

This approach, because it obtains data for single particles, provides more information than measurements of the average level of modification for a population of proteins. An average measurement can not distinguish between singly and multiply modified proteins. For example, a mixture of one protein with modification 1 and one protein with modification 2 would be indistinguishable from the combination of an unmodified protein and one with both modifications by methods that obtain the average modification level. The analyzer of the invention can clearly distinguish these particles.

Examples of modifications which could be analyzed in this way include comparison of glycosylation patterns of recombinant and native proteins, determination of phosphorylation levels at multiple sites of single proteins, simultaneous detection of precursors and products in proteolytic maturation and degradation of proteins, comparison of variant proteins created through different combinations of their structural components, and combinations of modifications such as correlation of variant proteins with phosphorylation state.

14C. Binding Agonist/Antagonist Assays

A third application makes use of detection of two labeled particles in an assay for substances that affect the binding of the labels. Each particle is labeled with a spectrally unique combination of labels. The fraction of bound and unbound labels in the presence of agonists or antagonists that compete for binding is determined by counting particles with spectral fingerprints of either or both labels. An example of this assay is shown in FIG. 22B. Applications for this assay include screening drug compounds for their effects on binding of catalytic and regulatory enzyme subunits, nucleic acids with their transcription factors, receptors with ligands, and enzymes with their substrates.

14D. Competitions Assays Using FRET

1. cAMP Assay Cyclic AMP (cAMP) Dependent Kinase

A exists as an inactive tetramer (C2R2) of catalytic (C) and regulatory (R) subunits in the absence of cAMP. When cAMP binds, the tetramer dissociates, releasing active catalytic subunits. In the assay for cAMP, the catalytic and regulatory subunits can be labeled with a pair of FRET fluorophores. For example, the regulatory subunits can be labeled with a donor fluorophore and the catalytic subunits can be labeled with an acceptor fluorophore. In the absence of cAMP the donors and acceptors are in close proximity, energy is transferred from the donor to the acceptor, and photons are emitted from the acceptor. When cAMP is present donors and acceptors are not in close proximity, and no photons are emitted from the acceptor. The analyzer of the invention provides sensitivity of detection at the single particle level to this technique which is usually used for bulk measurements. An example of a two color assay is shown in FIG. 22C.

2. Competitive Ligand Binding Assay

A receptor (R) and ligand (L) can be labeled with donor and acceptor fluorophores. When the ligand is bound to the receptor, donor and acceptor are in close proximity and photons are emitted from the acceptor. In the presence of unlabeled ligand (from a sample to be analyzed, for example) labeled ligand can be displaced from the receptor, the donor and acceptor are no longer in close proximity, and no photons are emitted from the acceptor. A calibration curve can be created, relating known amounts of unlabeled ligand to the number of acceptors emitting photons. Ligand levels in the sample can be estimated-from the calibration curve and the number of sample acceptor particles emitting photons. An example of a simple FRET assay is shown in FIG. 22D.

3. Binding Agonist/Antagonist Assay

As in the competitive ligand binding assay, receptor (R) and ligand (L) can be labeled with donor and acceptor fluorophores. When the ligand is bound to the receptor, donor and acceptor are in close proximity and photons are emitted from the acceptor. Samples of. potential binding agonists or antagonists can be added to the receptor-ligand mixture. Agonists in the sample increase the amount of labeled ligand bound to receptor, and increased numbers of acceptor particles emit photons. Antagonists in the sample reduce the number of ligands emitting photons. This method can be used to screen libraries of compounds for potential therapeutic effects in drug discovery and development. The SMD approach of the invention is especially useful in screening high affinity interactions at low concentrations because of its high sensitivity. An example of a competitive FRET assay is shown in FIG. 22E.

4. Enzyme Rate Assay

Hydrolytic enzyme activities can be assayed using substrates that are labeled with quencher and acceptor particles on opposite sides of the cleavage site. The fluorescence of intact substrate particles (quencher and acceptor in close proximity) changes on hydrolysis (quencher and acceptor not in proximity). For example a peptide substrate, which contains a cleavage site for a protease of interest, can be labeled with a fluorescence quencher on one end and a acceptor on the other end. Intact substrate peptides emit few photons, due to the close proximity of the quencher. Cleaved (product) peptides emit more photons. The rate of proteolysis is measured by the rate of appearance of cleaved peptide particles. An example of a enzyme FRET assay is shown in FIG. 22F. The advantage of the SMD approach of the invention is that the kinetics of enzyme activity can be measured for single particles rather than as an average of the activity of hundreds or thousands of particles s in ensemble measurements.

It will be clear to one skilled in the art that the analyzer of the invention can also be used for similar assays where binding partners are labeled with different color fluorophores.

### Example 15

### Labeling Strategies for Detection of Single Target Particles

One skilled in the art will recognize that many strategies can be used for labeling target particles to enable their detection or discrimination in a mixture of particles. The labels may be attached by any known means, including methods that utilize non-specific or specific interactions of label and target. Labels may provide a detectable signal or affect the mobility of the particle in an electric field. In addition, labeling can be accomplished directly or through binding partners. Following are examples of labeling strategies that can be used in the invention.

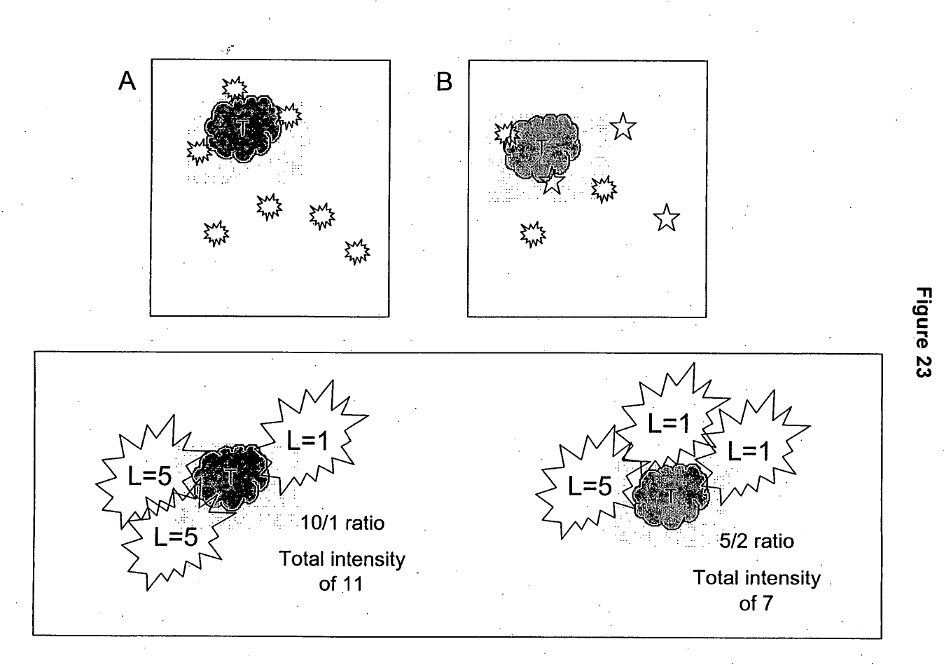

15A. Single Particle Detection (see FIG. 23):

Particles can be labeled with one dye, multiple copies of one dye (FIG. 23A), two dyes or multiple copies of two dyes (FIG. 23B), can be detected and distinguished from unbound label based on distinct emission intensity and/or emission wavelengths.

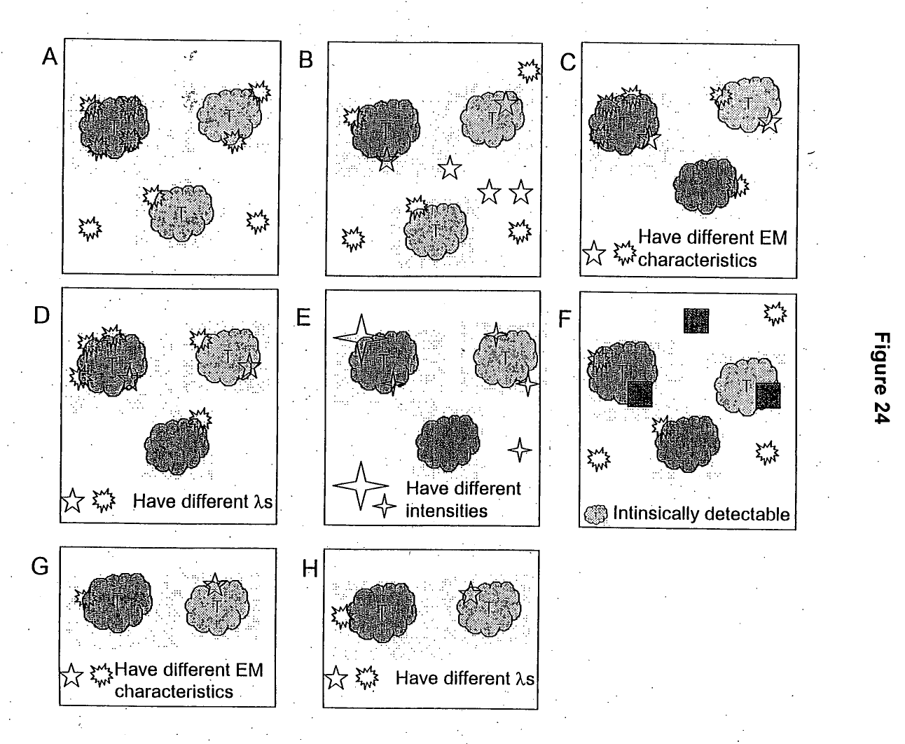

15B. Detection and Discrimination by Electromagnetic Characteristics of More than One Particle (see FIG. 24):

Particles labeled with multiple copies of one dye can be distinguished from particles labeled with a lesser number of copies of the same dye (FIG. 24A) based on their emission intensity. Particles labeled with two dyes can be distinguished from particles labeled with only one dye (FIG. 24B), by emitting at two wavelengths rather than one. Particles labeled with one or multiple copies of two dyes can be distinguished from particles labeled with a lesser number of copies of the two dyes (FIGS. 24C and D) by measuring the distinct ratio of the two dyes. Particles labeled with one each or multiple copies of two dyes having different fluorescent intensities can be distinguished by the difference in total intensity of fluorescence from each particle (FIG. 24E) based on their emission wavelength. Particles labeled with a dye and a label that affects electrophoretic velocity can be distinguished from particles only labeled with a mobility label (FIG. 24F) based on their emission spectrum and/or electrophoretic velocity. Particles labeled with one or multiple copies of one dye can be distinguished from particles labeled with one or multiple copies of a different dye based on the different in electromagnetic characteristics of the two dyes (FIGS. 24G and H)

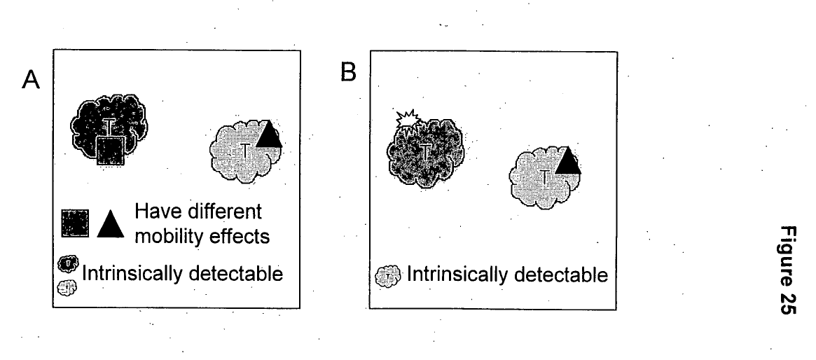

15C. Detection and Discrimination by Electrophoretic Velocity of More than One Particle (see FIG. 25)

Particles labeled with a label that affect electrophoretic velocity can be distinguished from particles labeled with a distinct label that affects electrophoretic velocity (FIG. 25A) based on their different electrophoretic velocities. Particles labeled with a dye can be distinguished from intrinsically detectable particles that are labeled with a label that affects electrophoretic mobility (FIG. 25B) based on their emission spectrum and/or electrophoretic velocity.

### Example 16

### Discrimination of Two Particles by Their Characteristic Intensity of Fluorescence Emission

High sensitivity and the ability to view particles singly can be an advantage in analysis of the level of modification of a single particle. For example, proteins that are destined for degradation can be tagged with multiple ubiquitins. A fluorescent label for ubiquitin can be added to the sample, allowed to bind to the target, and moved past the detectors by electrokinetic force. The electrophoretic velocity distinguishes free from bound label and the number of photons detected for each particle is proportional to the number of ubiquitin tags on the protein. Therefore, this assay provides information on the distribution of the number of ubiquitin tags per single protein particle, not just the average number. Examples of possible experiments are shown in FIGS. 26A and B.

### Example 17

### Fluorescence Polarization (FP) Assay

A particle can be labeled with a fluorophore. When the labeled particle is excited with polarized light, the emitted light may also be polarized. The degree of polarization of the emitted light is a function of the mobility of the label and the fluorescence lifetime of the fluorophore. When the labeled particle binds to a larger receptor particle its mobility is reduced, and its polarization is increased. Changes in the label-particle-receptor pair can be used as a detection system in a variety of measurements, including of competitive ligand binding, substrate binding, and enzymatic activity,. such as protein kinases.

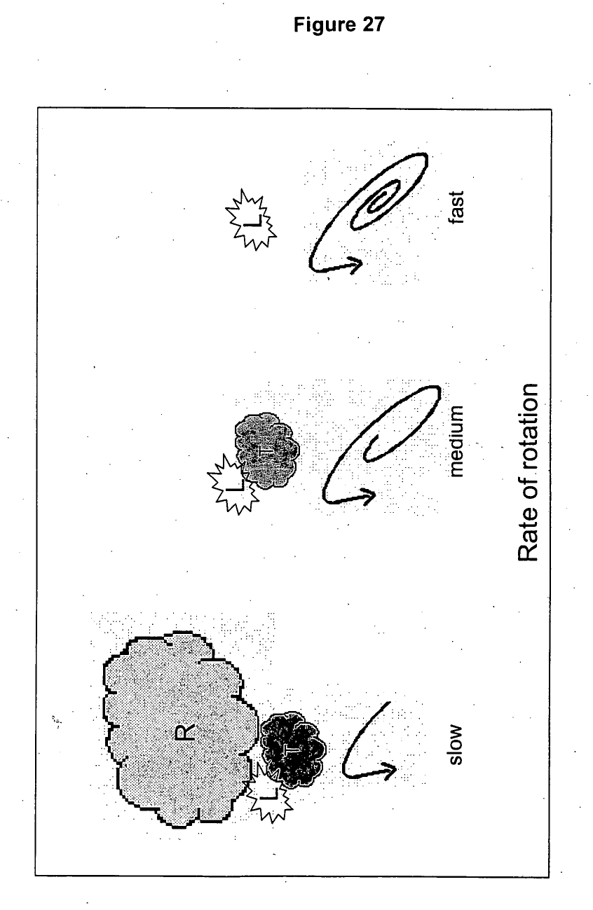

Conventional FP measurements, which detect polarization of all sample particles in aggregate, suffer from limited dynamic ranges. The practical range of polarization values in an assay may typically be between about 10 and about 300 mP (P is a unit of polarization calculated by measuring the fluorescence intensity parallel (F1) and perpendicular (F2) to the excitation plane, wherein P=(F1−F2)/(F1+F2)), and it is difficult to detect changes at either end of the range. The SMD analyzer of the invention counts particles one at a time as having high or low polarization, rather than providing an average polarization. Examples of detection by fluorescence polarization is shown in FIG. 27.

Other Aspects

The detailed description set-forth above is provided to aid those skilled in the art in practicing the present invention. However, the invention described and claimed herein is not to be limited in scope by the specific embodiments and/or aspects herein disclosed because these embodiments and aspects are intended as illustration of several embodiments and aspects of the invention. Any equivalent embodiments and/or aspects are intended to be within the scope of this invention. Indeed, various modifications of the invention in addition to those shown and described herein will become apparent to those skilled in the art from the foregoing descriptions which do not depart from the spirit or scope of the present inventive discovery. Such modifications are also intended to fall within the scope of the appended claims.

When introducing elements of the present invention or the preferred aspect(s) thereof, the articles “a”, “an”, “the” and “said” are intended to mean that there are one or more of the elements. The terms “comprising”, “including” and “having” are intended to be inclusive and mean that there may be additional elements other than the listed elements.

### REFERENCES CITED

All publications, patents, patent applications and other references cited in this application are incorporated herein by reference in their entirety for all purposes to the same extent as if each single publication, patent, patent application or other reference was specifically and singly indicated to be incorporated by reference in its entirety for all purposes. Citation of a reference herein shall not be construed as an admission that such is prior art to the present invention.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A single particle analyzer system comprising
(a) a sampling system capable of automatically sampling a plurality of samples and providing a fluid communication between a sample container and a first interrogation space; and
(b) an analyzer capable of detecting a single particle comprising
(i) an electromagnetic radiation source for emitting electromagnetic radiation;
(ii) said first interrogation space positioned to receive electromagnetic radiation emitted from the electromagnetic radiation source;
(iii) a second interrogation space positioned to receive electromagnetic radiation emitted from the electromagnetic radiation source; wherein the second interrogation space is in fluid communication with the first interrogation space and wherein a motive force exists between the first interrogation space and the second interrogation space such that a particle can be moved between the first interrogation space and the second interrogation space;
(iv) a first electromagnetic radiation detector operably connected to the first interrogation space to measure a first electromagnetic characteristic of the particle;
(v) a second electromagnetic radiation detector operably connected to the second interrogation space to measure at least one of a second electromagnetic characteristic of the particle and the first electromagnetic characteristic of the particle.

2. The analyzer system of claim 1 further comprising a sample recovery system in fluid communication with the second interrogation space that is capable of recovering substantially all of said sample.

3. The analyzer system of claim 2 further comprising a sample preparation system.

4. The analyzer system of claim 3 wherein the sample preparation system performs sample preparation selected from the group consisting of centrifugation, filtration, chromatography; cell lysis, alteration of pH, addition of buffer, addition of reagents, heating or cooling, illumination, addition of label, binding of label, separation of unbound label, and combinations thereof.

5. The analyzer system of claim 1 further comprising a data analysis system that analyzes said first and second electromagnetic characteristics and reports the results of said analysis

6. The analyzer system of claim 1 wherein the electromagnetic radiation source is a continuous wave electromagnetic radiation source

7. The analyzer system of claim 6, wherein the continuous wave electromagnetic radiation source is selected from the group consisting of a light-emitting diode and a continuous wave laser.

8. The analyzer system of claim 1 wherein sample carryover of the sampling system is less than about 0.02%

9. The analyzer system of claim 1 wherein the first and second interrogation spaces each have a volume between about 0.02 pL and about 300 pL.

10. The analyzer system of claim 1, wherein at least one of the first interrogation space and the second interrogation space has a volume between about 0.05 pL and about 50 pL.

11. The analyzer system of claim 1, wherein at least one of the first interrogation space and the second interrogation space has a volume between about 0.1 pL and about 25 pL.

12. The analyzer system of claim 1, wherein the volume of at least one of the first and second interrogation spaces is adjustable.

13. The analyzer system of claim 1 further comprising a third electromagnetic radiation detector operably connected to at least one of the first interrogation space and the second interrogation space to measure at least one of the first electromagnetic characteristic of the particle and the second electromagnetic characteristic of the particle.

14. The analyzer system of claim 1 wherein the motive force comprises pressure.

15. The analyzer system of claim 13 wherein the pressure is provided by a source selected from the group consisting of a pump, a vacuum source, a centrifuge, and a combination thereof.

16. The analyzer system of claim 14, wherein the fluid communication comprises tubing or channels within a microfluidic device, and further wherein the pressure is supplied by a pump or pumps.

17. The analyzer system of claim 5 wherein the analysis comprises determining the presence, absence, and, optionally, concentration of a particle and determining a possible diagnosis, prognosis, state of treatment, or suggested treatment based on said presence, absence, and/or concentration.

18. An analyzer system comprising
(a) a sampling system providing a fluid communication between a sample container and a first interrogation space;
(b) a single particle analyzer comprising said first interrogation space and a second interrogation space, wherein the second interrogation space is in fluid communication with the first interrogation space and wherein a motive force exists between the first interrogation space and the second interrogation space such that a particle can be moved between the first interrogation space and the second interrogation space;
(c) a detector operably connected to said first and/or said second interrogation spaces for detecting a detectable characteristic of the particle, if present;
(d) a sample recovery system whereby the sample can move from the sample container to the interrogation volumes and back to the sample container without contacting other components of the analyzer and with no substantial contact with clean buffer within the analyzer; and
(e) a data analyzer that receives input from the detector, analyzes the presence or absence of the particle, and reports a result based on said presence or absence.

19. The analyzer system of claim 18 further comprising a sample preparation system.

20. A single particle analyzer system comprising
(a) a sampling system capable of automatically sampling a plurality of samples and providing a fluid communication between a sample container and a first interrogation space; and
(b) an analyzer capable of detecting a single molecule comprising
(i) an electromagnetic radiation source for emitting electromagnetic radiation;
(ii) said first interrogation space positioned to receive electromagnetic radiation emitted from the electromagnetic radiation source; and
(iii) a first electromagnetic radiation detector operably connected to the first interrogation space to measure a first electromagnetic characteristic of the particle.

21. An analyzer system comprising an analyzer capable of detecting a difference of less than 20% in concentration of an analyte between a first sample and a second sample, when the first sample and the second sample are introduced into the analyzer, the volume of said first sample and said second sample introduced into the analyzer is less than 5 ul, and wherein the analyte is present at a concentration of less than 50 femtomolar in said first and second samples.

22. A single particle analyzer comprising:
at least one continuous wave electromagnetic radiation source for emitting electromagnetic radiation;
a first interrogation space positioned to receive electromagnetic radiation emitted from the electromagnetic radiation source, the first interrogation space having a volume between about 0.02 pL and about 300 pL;
a second interrogation space positioned to receive electromagnetic radiation emitted from the electromagnetic radiation source, the second interrogation space having a volume between about 0.02 pL and about 300 pL, wherein the second interrogation space is in fluid communication with the first interrogation space and, wherein an electric potential exists between the first interrogation space and the second interrogation space such that a particle can be moved between the first interrogation space and the second interrogation space at least in part using electro-kinetic force;
a first electromagnetic radiation detector operably connected to the first interrogation space to measure a first electromagnetic characteristic of the particle; and
a second electromagnetic radiation detector operably connected to the second interrogation space to measure at least one of a second electromagnetic characteristic of the particle and the first electromagnetic characteristic of the particle.

23. An analyzer according to claim 22 further comprising a third electromagnetic radiation detector operably connected to at least one of the first interrogation space and the second interrogation space to measure at least one of the first electromagnetic characteristic of the particle and the second electromagnetic characteristic of the particle.

24. An analyzer according to claim 22, wherein the continuous wave electromagnetic radiation source is selected from the group consisting of a light-emitting diode and a continuous wave laser.

25. An analyzer according to claim 22, wherein at least one of the first interrogation space and the second interrogation space has a volume between about 0.1 pL and about 25 pL.

26. An analyzer according to claim 22, wherein the volume of at least one of the first and second interrogation spaces is adjustable.

27. An analyzer according to claim 22, wherein at least one of the first interrogation space and the second interrogation space is defined by at least one of a cross sectional area of a beam of electromagnetic radiation received from the electromagnetic radiation source and a range of detection of at least one of the first electromagnetic radiation detector and the second electromagnetic radiation detector.

28. An analyzer according to claim 27, wherein the range of detection is determined by a width of a slit in a spatial filter positioned adjacent to at least one of the first electromagnetic radiation detector and the second electromagnetic radiation detector.

29. An analyzer according to claim 22, wherein at least one of the first and the second interrogation spaces is at least partially defined by a housing comprising a solid material selected from the group consisting of glass, quartz, fused silica, plastic, or any combination thereof.

30. An analyzer according to claim 22, wherein at least one of the first interrogation space and the second interrogation space is at least partially defined by a fluid boundary.

31. An analyzer according to claim 22, wherein at least one of the first electromagnetic radiation detector and the second electromagnetic radiation detector is selected from a group consisting of a CCD camera, a video input module camera, a streak camera, a bolometer, a photodiode, a photodiode array, an avalanche photodiode detector, a photomultiplier detector, and any combination thereof.

32. An analyzer according to claim 22, further comprising at least one of a pump, a vacuum source, and a centrifuge for facilitating movement of the particle between the first interrogation space and the second interrogation space.

33. A method of analysis comprising determining the presence or absence of a particle in a sample obtained from an individual, using a single particle analyzer system comprising
(a) a sampling system capable of automatically sampling a plurality of samples and providing a fluid communication between a sample container and a first interrogation space;
(b) an analyzer capable of detecting a single particle comprising
(i) an electromagnetic radiation source for emitting electromagnetic radiation;
(ii) said first interrogation space positioned to receive electromagnetic radiation emitted from the electromagnetic radiation source;
(iii) a second interrogation space positioned to receive electromagnetic radiation emitted from the electromagnetic radiation source; wherein the second interrogation space is in fluid communication with the first interrogation space and wherein a motive force exists between the first interrogation space and the second interrogation space such that a particle can be moved between the first interrogation space and the second interrogation space;
(iv) a first electromagnetic radiation detector operably connected to the first interrogation space to measure a first electromagnetic characteristic of the particle;
(v) a second electromagnetic radiation detector operably connected to the second interrogation space to measure at least one of a second electromagnetic characteristic of the particle and the first electromagnetic characteristic of the particle.

34. The method of claim 33 wherein the analyzer further comprises a data analysis system that analyzes said first and second electromagnetic characteristics and reports the results of said analysis

35. The method of claim 34 further comprising determining a diagnosis, prognosis, state of treatment and/or method of treatment based on the results of said analysis.

36. The method of claim 33 wherein the analyzer system further comprises a sample recovery system in fluid communication with the second interrogation space that is capable of recovering substantially all of said sample.

37. The method of claim 33 wherein the analyzer system further comprises a sample preparation system.

38. The method of claim 33 wherein the electromagnetic radiation source is a continuous wave electromagnetic radiation source

39. The method of claim 33 wherein the first and second interrogation spaces each have a volume between about 0.02 pL and about 300 pL.

40. The method of claim 33, wherein at least one of the first interrogation space and the second interrogation space has a volume between about 0.05 pL and about 50 pL.

41. The method of claim 33, wherein at least one of the first interrogation space and the second interrogation space has a volume between about 0.1 pL and about 25 pL.

42. The method of claim 33, wherein the volume of at least one of the first and second interrogation spaces is adjustable.

43. The method of claim 33, wherein the motive force comprises pressure.

44. The method of claim 43 wherein the pressure is provided by a source selected from the group consisting of a pump, a vacuum source, a centrifuge, and a combination thereof.

45. The method of claim 33 wherein the individual is an animal or a plant.

46. The method of claim 45 wherein the individual is an animal.

47. The method of claim 46 wherein the individual is a mammal.

48. The method of claim 47 wherein the individual is a human.

49. The method of claim 33 comprising performing an analysis on a plurality of particles in the sample.

50. The method of claim 49 wherein each detected particle of the plurality of particles comprises a label, and wherein each detected particle is distinguished from the others by a characteristic selected from the group consisting of label identity, label intensity, mobility, or a combination thereof.

51. The method of claim 33 wherein the sample is selected from the group consisting of blood, serum, plasma, bronchoalveolar lavage fluid, urine, cerebrospinal fluid, pleural fluid, synovial fluid, peritoneal fluid, amniotic fluid, gastric fluid, lymph fluid, interstitial fluid, tissue homogenate, cell extracts, saliva, sputum, stool, physiological secretions, tears, mucus, sweat, milk, semen, seminal fluid, vaginal secretions, fluid from ulcers and other surface eruptions, blisters, and abscesses, and extracts of tissues including biopsies of normal, malignant, and suspect tissues or any other constituents of the body which may contain the particle.

52. The method of claim 51 wherein the sample is selected from the group consisting of blood, plasma, or serum.

53. The method of claim 52 further comprising labeling the particle in said sample, wherein analyzing said sample comprises detecting the presence or absence of said labeled particle.

54. The method of claim 53 further comprising removing unbound label from said sample.

55. The method of claim 33 further comprising obtaining said sample from said individual.

56. The method of claim 53 wherein the particle is selected from the group consisting of a protein, a nucleic acid, a nanosphere, a microsphere, a dendrimer, a chromosome, a carbohydrate, a virus, a bacterium, a cell, and any combination thereof.

57. The method of claim 53, wherein the particle is selected from the group consisting of a protein, a nucleic acid, a virus, a fungus, a bacterium, and any combination thereof.

58. The method of claim 53, wherein the particle is selected from the group consisting of an amino acid, a nucleotide, a lipid, a sugar, a small particle toxin, a peptide toxin, a venom, a drug, and any combination thereof.

59. The method of claim 52 wherein the sample is a serum sample that has been contacted with a fluorescently-labeled antibody specific for a particle of interest; and wherein said analysis comprises detecting the presence, absence, and/or concentration of the labeled particle.

60. The method of claim 59 further comprising determining a diagnosis, prognosis, state of treatment, and/or method of treatment, based on said presence, absence, and/or concentration of the labeled particle.

61. The method of claim 60 further comprising reporting said diagnosis, prognosis, state of treatment, and/or method of treatment to the individual.

62. The method of claim 60 wherein the biomarker is TREM-1.

63. The method of claim 62 wherein the method is completed in less than one hour

64. The method of claim 60 wherein said determining a diagnosis, prognosis, state of treatment, and/or method of treatment is based on the presence, absence, and/or concentration of a panel of biomarkers.

65. The method of claim 59 wherein the method is performed in less than 2 hours.

66. A method of analysis comprising determining a diagnosis, prognosis, state. of treatment, and/or method of treatment based on the presence, absence, and/or concentration of a particle in a sample obtained from an individual, wherein said presence, absence, and/or concentration is determined using an analyzer system comprising a analyzer capable of detecting a single molecule, wherein said analyzer comprises at least one interrogation space.

67. The method of claim 66 wherein the analyzer comprises at least two interrogation spaces.

68. The method of claim 66 wherein the analyzer system comprises an analyzer capable of detecting a single molecule comprising at least one continuous wave electromagnetic radiation source for emitting radiation, wherein at least one interrogation space is positioned to receive said radiation.

69. A method for screening an individual to determine the presence or absence of a condition, comprising analyzing a sample from the individual for one or more markers of the condition using an analyzer capable of detecting a difference of less than 20% in concentration of the one or more markers between a first sample and a second sample, when the first sample and the second sample are introduced into the analyzer, the volume of said first sample and said second sample introduced into the analyzer is less than 5 ul, and wherein the one or more markers are present at a concentration of less than 50 femtomolar in said first and second samples.

70. The method of claim 69 further comprising comparing the result of said analysis with known values for the marker.

71. The method of claim 69 wherein the individual is a smoker and the cancer is lung cancer.

72. A method for detecting a particle comprising:
moving the particle by electro-kinetic force into a first interrogation space having a volume between about 0.02 pL and about 300 pL, and into a second interrogation space having a volume between about 0.02 pL and about 300 pL;
subjecting the sample to at least one continuous wave electromagnetic radiation source;
measuring within the first interrogation space a first electromagnetic characteristic of the particle as the particle interacts with continuous wave electromagnetic radiation within the first interrogation space; and
measuring within the second interrogation space at least one of the first electromagnetic characteristic and a second electromagnetic characteristic of the particle as the particle interacts with continuous wave electromagnetic radiation within the second interrogation space.

73. A method according to claim 72, wherein the particle is a first particle and the method further comprises:
moving a second particle into at least two of the first interrogation space, the second interrogation space, a third interrogation space, and a fourth interrogation space; and
measuring at least one of a first electromagnetic characteristic of the second particle and a second electromagnetic characteristic of the second particle as the second particle interacts with continuous wave electromagnetic radiation within at least one of the first interrogation space, the second interrogation space, the third interrogation space, and the fourth interrogation space.

74. A computer-readable storage medium containing a set of instructions for a general purpose computer having a user interface comprising a display unit, the set of instructions comprising
(a) logic for inputting values from analysis of a sample with a single particle detector with two interrogation spaces; and
(b) a display routine for displaying the results of the input values with said display unit.

75. The computer-readable storage medium of claim 74 wherein the instructions further comprises a comparison routine for comparing the inputted values with a database; and wherein the display routine further comprises logic for displaying the results of the comparison routine.

76. An electronic signal or carrier wave that is propagated over the Internet between computers comprising a set of instructions for a general purpose computer having a user interface comprising a display unit, the set of instructions comprising a computer-readable storage medium containing a set of instructions for a general purpose computer having a user interface comprising a display unit, the set of instructions comprising
(a) logic for inputting values from analysis of a sample with a single particle detector with two interrogation spaces; and
(b) a display routine for displaying the results of the input values with said display unit.

77. The signal or carrier wave of claim 76 wherein the set of instructions further comprises a comparison routine for comparing the inputted values with a database; and wherein the display routine further comprises logic for displaying the results of the comparison routine.

78. A method of doing business, comprising use by an entity of a detector with two interrogation spaces that is capable of detecting single particles to obtain a result for an assay of a sample, reporting said result, and payment to the entity for the reporting of the result.

79. The method of claim 78 wherein the entity is a Clinical Laboratory Improvement Amendments (CLIA) laboratory.

80. The method of claim 78 wherein the entity is not a CLIA laboratory.
